(19) United States
(12) Patent Application Publication
(10) Pub. No.: US 2023/0409715 A1
(43) Pub. Date: Dec. 21, 2023

(54) METHODS AND SYSTEMS FOR TRUSTED UNKNOWN MALWARE DETECTION AND CLASSIFICATION IN LINUX CLOUD ENVIRONMENTS

(71) Applicant: B. G. NEGEV TECHNOLOGIES AND APPLICATIONS LTD., AT BEN-GURION UNIVERSITY, Beer-sheva (IL)

(72) Inventors: Nir NISSIM, Ashdod (IL); Tomer PANKER, Tel Aviv (IL); Tom LANDMAN, Rehovot (IL)

(21) Appl. No.: 18/035,748

(22) PCT Filed: Nov. 11, 2021
(86) PCT No.: PCT/IL21/51343

§ 371 Date: May 7, 2023

Related U.S. Application Data
(60) Provisional application No. 63/112,171, filed on Nov. 11, 2020.
(60) Provisional application No. 63/133,390, filed on Jan. 3, 2021.

(51) Int. Cl. G06F 21/56; G06F 9/455

(52) U.S. Cl. CPC G06F 21/566; G06F 9/45533

(57) ABSTRACT

A method for detection of unknown malware in Linux cloud environment, the method including: within a hypervisor, acquiring a raw data set comprising one or more volatile memory dumps of a Linux cloud server, wherein the volatile memory dumps are associated with a current state of the virtual machine's volatile memory, extracting one or more features from the raw data set (either by utilizing knowledge based features or by utilizing Deep Learning CNN architectures), and classifying, using at least one classifier, the one or more features, to determine if one or more of the features are associated with a malware, thereby detecting malware in a Linux cloud environment and distinguishing between a benign or malicious state of the server.

### TECHNICAL FIELD

The present disclosure relates generally to framework for unknown malware detection and classification in Linux cloud environments.

### BACKGROUND

Since the beginning of the 21st century, the use of cloud computing has increased rapidly, and it currently plays a significant role among most organizations' information technology (IT) infrastructure. Virtualization technologies, particularly virtual machines (VMs), are widely used and lie at the core of cloud computing. While different operating systems can run on top of VM instances, in public cloud environments the Linux operating system is used 90% of the time. Because of their prevalence, organizational Linux-based virtual servers have become an attractive target for cyber-attacks, mainly launched by sophisticated malware designed at causing harm, sabotaging operations, obtaining data, or gaining financial profit. This has resulted in the need for an advanced and reliable unknown malware detection mechanism for Linux cloud-based environments.

Linux-based clouds are popular cloud environments because Linux is a free, open-source, and high performing OS suitable for multiple computational platforms (PCs, servers, Android, supercomputers, embedded systems, etc.). Many organizations use cloud-computing environments and virtualization technology. Linux-based clouds are the most popular cloud environments among organizations, and thus have become the target of cyber-attacks launched by sophisticated malware. Existing malware detection solutions for Linux-based VMs are installed and operated on the VM itself and are considered untrusted since malware can detect, interfere with, and even evade them. Thus, Linux cloud-based environments remain exposed to various malware-based attacks. Although cloud providers use various security mechanisms and tools, they are targeted by attackers that use sophisticated malware to perform cyber-attacks.

As cloud computing technologies advance, malware also continuously and rapidly evolves and becomes more sophisticated, diverse, and difficult to detect. As a result, most existing detection mechanisms are limited in their ability to detect unknown malware. Antivirus (AV) services cannot detect and generalize well when facing unseen malware, since most AVs are based on static analysis of the malware sample, in which only the inspected file's source code is scanned without being executed. Malware writers often use evasion techniques (e.g., obfuscation, packing, dynamic code load) when writing their malicious program, making it much more difficult for the AV to identify and expose the inspected file's nature and behavior by just using static analysis. Also, the process of signature generation usually involve domain experts, and therefore, it is more expensive and time-consuming. There are also various dynamic analysis tools for malware detection, such as Cuckoo Sandbox, Hybrid Analysis, Valkyrie, etc., all of which are untrusted, as they are usually installed directly on the inspected machine, a practice which allows malware to be aware of the inspection process, interfere with it, and even evade detection. In addition, regardless of the analysis approach, static or dynamic, many existing tools cannot detect fileless malware, such as web browser-based cryptojackers, etc.

Linux malware leaves different malicious behavior traces in the volatile memory. For example, if a simple ransomware is compared with two variations, one for Windows and one for Linux, that uses the same encryption method, the ransomware will yield different processes according to each OS's process structure, load different system libraries, scan different file systems and paths, encrypt files according to different privilege systems, and use different system calls. Thus, one can understand the necessity of a designated trusted method for Linux-based clouds.

There is thus a need in the art for methods for detecting unknown malware in Linux cloud environments, which are robust, safe and easy for implementation under various environments.

### SUMMARY

According to some embodiments there is provided a trusted framework for detecting unknown malware in Linux virtual machines (VM) cloud-environments. According to some embodiments, the framework acquires volatile memory dumps from the inspected VM by querying the hypervisor in a trusted manner and overcoming malware's ability to detect the security mechanism and evade detection. According to some embodiments, using machine-learning algorithms, the framework is configured to leverage informative traces (such as, for example, the 171 proposed features described in greater detail hereinbelow), from different parts of the VM's volatile memory.

According to some embodiments, as detailed hereinbelow, the framework was evaluated in several experiments, on a total of 21,800 volatile memory dumps taken from two widely used virtual servers (10,900 from each server) during the execution of a diverse yet representative collection of benign and malicious Linux applications. Notably, the results show that the disclosed framework can accurately (i.e. with high True positive rate (TPRs) and low false positive rates (FPRs)): (a) detect unknown malware (b) detect new unknown malware from unseen malware categories, which is a critical ability for coping with new malware trends and phenomena, (c) categorize an unknown malware by its attack category, (d) detect unknown malware on an unknown virtual-server, and/or (e) detect fileless malware, a critical capability demonstrating the ability to detect substantially different attack modus operandi. Each possibility is a separate embodiment.

According to some embodiments, there is provided a trusted framework for unknown malware detection in Linux-based cloud environments (also referred to herein as “Deep Hook”). According to some embodiments, Deep-Hook is configured to hook the VM's volatile memory in a trusted manner and acquire the memory dump to discover malware footprints while the VM operates. According to some embodiments, the memory dumps are transformed into visual images which are analyzed using a convolutional neural network (CNN) based classifier, or other suitable classifiers. According to some embodiments, the framework has some key advantages, such as its agility, its ability to eliminate the need for features defined by a cyber domain expert, and most importantly, its ability to analyze the entire memory dump and thus to better utilize the existing indication it conceals, thus allowing the induction of a more accurate detection model.

Accordingly, Deep-Hook was evaluated on widely used Linux virtual servers, four state-of-the-art CNN architectures, eight image resolutions, and a total of 22,400 volatile memory dumps representing the execution of a broad set of benign and malicious Linux applications. Experimental evaluation results disclosed herein demonstrate Deep-Hook's ability to effectively, efficiently, and accurately detect and classify unknown malware (even evasive malware like rootkits), with an AUC and accuracy of up to 99.9%.

According to some embodiments of the present invention there is provided a method for detection of unknown malware in Linux cloud environment, the method including: within a hypervisor, acquiring a raw data set including one or more volatile memory dumps of a Linux cloud server, wherein the volatile memory dumps are associated with a current state of the virtual machine's volatile memory, extracting one or more features from the raw data set (either by utilizing knowledge based features or by utilizing Deep Learning CNN architectures), and classifying, using at least one classifier, the one or more features, to determine if one or more of the features are associated with a malware, thereby detecting malware in a Linux cloud environment and distinguishing between a benign or malicious state of the server.

According to some embodiments of the present invention there is provided a method for detection of malware in Linux cloud environments, including: within a hypervisor, acquiring data from volatile memory dumps of a Linux cloud server, (pre)processing at least a portion of the data, thereby generating a processed data set, extracting one or more features from the processed data set, and classifying, the one or more features to determine if one or more of the features are associated with a malware, thereby detecting malware in a Linux cloud environment.

According to some embodiments, the method further includes (pre)processing at least a portion of the data, thereby generating a processed data set, and wherein the one or more features are extracted from the processed data set.

According to some embodiments, the hypervisor is configured to acquire the volatile memory dumps, thereby evading being detected by the malware.

According to some embodiments, the classifying of the one or more features is based, at least in part, on identified malicious behavioral traces.

According to some embodiments, the processed data includes one or more matrices, and wherein the extracting of the one or more features includes applying the one or more matrices to an algorithm trained using expert knowledge.

According to some embodiments, the processed data set includes one or more image files, and wherein the extracting of the one or more features includes applying the one or more image files to a plurality of neural networks.

According to some embodiments, acquiring data associated with volatile memory dumps includes the entire memory dump. According to some embodiments, acquiring data associated with volatile memory dumps includes a single dump.

According to some embodiments, acquiring data associated with volatile memory dumps includes acquiring data associated with time intervals between memory dumps.

According to some embodiments, the (pre)processing includes removing non-essential data.

According to some embodiments, the classifier is trained using a validation step, thereby ensuring that the malware is inspected as it performs its malicious activity.

According to some embodiments, the malware is a file-less malware, thereby enabling detection of substantially different attack module operandi.

According to some embodiments, the classifying of the one or more features includes classifying known malware and/or unknown malware families into categories.

According to some embodiments, the unknown malware is a malware that the classifier did not encounter during a training process thereof.

According to some embodiments, the categories may include any one or more of virus, worm, Trojan, DDoS-Trojan, ransomware, botnet, Cryptojacker, APT, cryptominers and rootkit. According to some embodiments, the categories include malware families and/or attack type categories. According to some embodiments, the categories may include at least one previously unknown category of malware and/or at least one previously unknown malware family.

According to some embodiments, the server is an unknown/new virtual server.

According to some embodiments, wherein the features are extracted from different parts of the volatile memory. According to some embodiments, the one or more features are knowledge based features.

According to some embodiments, the malware is a foreground process, disguised as a background process, and/or a background process.

According to some embodiments, the method further includes analyzing potential malware behavior by applying one or more of a static analysis method and a dynamic analysis method to the data. According to some embodiments, the static analysis method includes binary code analysis. According to some embodiments, the dynamic analysis method includes information extraction during the malware's execution.

According to some embodiments, the hypervisor is a type two hypervisor.

According to some embodiments, the one or more features extracted using at least one convoluted neural network (CNN).

According to some embodiments, the method is devoid of a pre-processing stage, thereby preventing lag time between a malware attack and the detection thereof.

According to some embodiments, the method further includes a virtual box snapshotter configured to control any one or more of the setting of the virtual environment, an application to be sampled, a server type, an amount of snapshots to be captured, a time interval between two or more consecutive snapshots, which server is executed, and which server is the one from which the volatile memory dumps are captured, or any combination thereof.

According to some embodiments, the acquiring of the data set from volatile memory dumps of a Linux cloud server further includes capturing a snapshot of the volatile memory and saving the snapshot as an Executable and Linkable Format (ELF).

According to some embodiments, the method further includes slicing the snapshot and saving the sliced snapshot in a raw format thereof.

According to some embodiments, the method further includes producing at least one jpg image from the snapshots and/or sliced snapshots, wherein each of the volatile memory dumps is represented as one or more RGB array.

According to some embodiments, the method further includes applying the jpg image to the classifier.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, optional elements/components and optional stages may be included within dashed boxes.

In the figures:

FIG. 1 is a flow chart of steps in a method for detection of unknown malware in Linux cloud environments, in accordance with some embodiments of the present invention;

FIG. 2 is a block diagram of the method for detection of unknown malware in Linux cloud environments, in accordance with some embodiment of the present invention;

FIG. 3 shows a schematic illustration of relations between a task_struct and a file, in accordance with some embodiments of the present invention;

FIG. 4 shows a schematic illustration of the relations between a task_struct the virtual memory, in accordance with some embodiments of the present invention;

FIG. 5 shows a block diagram of taxonomy of potential behavior indicative of Linux malware, in accordance with some embodiments of the present invention;

FIG. 6 shows a block diagram of types of hypervisors, in accordance with some embodiments of the present invention;

FIG. 7 shows exemplary categories of malware and malware families, in accordance with some embodiments of the present invention.

FIG. 8 shows the virtualization architecture, in accordance with some embodiments of the present invention;

FIG. 9 shows a schematic process of feature extraction and dataset creation from the volatile memory dump files, in accordance with some embodiments of the present invention;

FIG. 10 shows a pie chart of features, wherein the features are grouped by the potential malicious behavior they are associated with, in accordance with some embodiments of the present invention;

FIG. 11 shows a pie chart of features, wherein the features are grouped by their source in the volatile memory, in accordance with some embodiments of the present invention;

FIG. 12 shows bar graphs of the detection capabilities of the classifiers for all of the samples, in accordance with some embodiments of the present invention;

FIG. 13 shows bar graphs of unknown malware detection capabilities of the classifiers on the DNS and HTTP virtual servers, in accordance with some embodiments of the present invention;

FIG. 14 shows graphs of unknown malware detection capabilities as a function of the number of dumps analyzed in the testing phase, in accordance with some embodiments of the present invention;

FIG. 15 shows graphs of unknown malware category detection capabilities of the classifiers, in accordance with some embodiments of the present invention;

FIG. 16 shows graphs of unknown malware category detection capabilities as a function of the number of dumps analyzed in the testing phase, in accordance with some embodiments of the present invention;

FIG. 17 shows bar graphs of detection of specific malware category, in accordance with some embodiments of the present invention;

FIG. 18 shows pie charts of feature distributions according to data source and potential behaviors, in accordance with some embodiments of the present invention;

FIG. 19 shows IDR values for different feature amounts, of Experiment 5, in accordance with some embodiments of the present invention;

FIG. 20 shows bar graphs of unknown malware detection capabilities of the classifiers using a compact set of features, in accordance with some embodiments of the present invention;

FIG. 21 shows graphs of unknown malware detection capabilities of the classifiers as a function of the number of analyzed dumps analyzed in the testing phase, in accordance with some embodiments of the present invention;

FIG. 22 shows bar graphs of unknown malware detection capabilities on an unknown server, in accordance with some embodiments of the present invention;

FIG. 23 shows bra graphs of unknown fileless attack detection capabilities, in accordance with some embodiments of the present invention;

FIG. 24 shoes a pie chart depicting the malware distribution in the data collection, in accordance with some embodiments of the present invention;

FIG. 25 shows a diagram of the architecture of the Oracle Virtual Box, in accordance with some embodiments of the present invention;

FIG. 26 shows a diagram depicting the process of trusted volatile memory acquisition from Linux virtual servers, using VirtualBox, in accordance with some embodiments of the present invention;

FIG. 27 shows a diagram depicting the method from acquiring a volatile memory dump to generating a visual image, in accordance with some embodiments of the present invention;

FIG. 28 shows a table comparing between benign and malicious images converted from a Linux VM's volatile memory dumps, in accordance with some embodiments of the present invention;

FIG. 29 shows a diagram of the method of malware detection, from a receiving/generating a visual image to a outputting a detection result, in accordance with some embodiments of the present invention;

FIG. 30 shows bar graphs of known malware detection on the DNS server (the results of experiment I), in accordance with some embodiments of the present invention;

FIG. 31 shows bar graphs of known malware detection on the HTTP server (the results of experiment I), in accordance with some embodiments of the present invention;

FIG. 32 shows bar graphs of unknown malware detection on the DNS server (the results of experiment II), in accordance with some embodiments of the present invention;

FIG. 33 shows bar graphs of unknown malware detection on the HTTP server (the results of experiment II), in accordance with some embodiments of the present invention;

FIG. 34 shows bar graphs of unknown malware family in DNS server (the results of experiment III), in accordance with some embodiments of the present invention;

FIG. 35 shows bar graphs of unknown malware family in HTTP server (the results of experiment III), in accordance with some embodiments of the present invention;

FIG. 36 shows bar graphs of malware classification on the DNS server (results of experiment IV), in accordance of some embodiments of the present invention;

FIG. 37 shows bar graphs of malware classification on the HTTP server (results of experiment IV), in accordance of some embodiments of the present invention;

FIG. 38 shows an octagonal spider chart of detection accuracy as a function of image resolution on the DNS server (results of experiment V), in accordance with some embodiments of the present invention;

FIG. 39 shows a table of the summary of the results obtained in experiment V on the DNS server, in accordance with some embodiments of the present invention;

FIG. 40, which shows an octagonal spider chart of detection accuracy as a function of image resolution on the HTTP server (results of experiment V), in accordance with some embodiments of the present invention;

FIG. 41, which shows a table of the summary of the results obtained in experiment V on the HTTP server, in accordance with some embodiments of the present invention;

FIG. 42, which shows bar graphs of unseen malware detection by training on the DNS server and testing on the HTTP server (results of Sub-Experiment VI (A)), in accordance with some embodiments of the present invention;

FIG. 43, which shows bar graphs of unseen malware detection by training on the HTTP server and testing on the DNS server (results of Sub-Experiment VI (B)), in accordance with some embodiments of the present invention;

FIG. 44, which shows bar graphs of unseen malware detection by training and testing on both servers (results of Sub-Experiment VI (C)), in accordance with some embodiments of the present invention;

FIG. 45, which shows bar graphs of transfer learning on the DNS server (the results of experiment VII), in accordance with some embodiments of the present invention; and

FIG. 46, which shows bar graphs of transfer learning on the HTTP server (the results of experiment VII), in accordance with some embodiments of the present invention.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

Linux's main advantages are as follows: 1) it is open-source—this allows it to be installed on many computers with no cost; 2) its scalability—Linux is scalable and can run on older systems and many devices from watches to supercomputers; 3) its flexibility—most computing tasks can be performed due to the availability of the Linux source code; and 4) its reliability—Linux minimizes potential problems due to its use of a modular kernel that loads only the required modules. Due to its advantages, Linux is deployed on many devices, from home desktop computers to enterprise servers and embedded devices, like smartphones, televisions, Internet-of-Things (IoT) devices, etc. Accordingly, Linux distributions are the cornerstone of many server-software combinations that are implied in website hosting.

The detection of malware in cloud environments relies on standard security mechanisms and tools, such as anti-virus. The ability of such tools to detect new unknown malware is limited due to their reliance on known malware signatures used for detection. Moreover, when a new malware appears, it takes the anti-virus companies some time to update their tools with the new signature since this only occurs after domain experts perform a malware investigation. During this time, cloud infrastructures are vulnerable to new malware. During this time, the malware can evolve and mutate further, rendering the new signature irrelevant. While some studies have presented fast, novel methodologies for creating malware signatures in a Windows-based VM (or in other words, non-Linux environment).

Different operating systems, such as Linux and Windows, can be deployed into VMs. In light of the widespread use of cloud computing services, Linux-based VMs that form the core of the cloud infrastructure have become an attractive target for cyber-attackers who attack both individuals and organizations.

The ongoing evolution of malware results in more intimidating, sophisticated, and evasive malware that may cause organizations to lose money, reputation, and data. Some advanced malware samples can detect the presence of anti-virus and other more advanced detection mechanisms (e.g., endpoint detection and response systems, intrusion detection systems). Thus, if the malware can detect the presence of detection mechanisms, the malware can evade the detection mechanisms and even turn the detection mechanisms off. An anti-virus program that is executed on top of the same environment that the malware is operated on is considered an untrusted inspection and detection mechanism. Furthermore, some malware samples can detect that they are being inspected in a sandbox environment and change their behavior and thus evade detection.

According to some embodiments, in the present disclosure, the method may be configured such that the volatile memory dumps are acquired in a trusted manner by querying the VM hypervisor from an external host in which the malware is unaware of its existence. Accordingly, this is done when the guest VM is temporarily frozen; that way, the malware sample being executed cannot detect that it is being analyzed.

According to some embodiments, there is provided a method for monitoring a virtual machine using one or more hypervisors, and obtaining volatile memory dumps using the hypervisor which may be classified using one or more algorithms configured to detect malware. According to some embodiments, the method may be configured to observe different activities of the virtual machines, and thus detect malicious behavior performed on the virtual machines. According to some embodiments, and as described in greater detail elsewhere herein, the method may include implementing one or more algorithms configured to learn the behaviors (normal and otherwise) of the virtual machine which it observes.

Antivirus software and today's even more advanced malware detection solutions have limitations in detecting new, unseen, and evasive malware. Moreover, many existing solutions are considered untrusted, as they operate on the inspected machine and can be interfered with, and can even be detected by the malware itself, allowing malware to evade detection and cause damage.

Accordingly, there are some malware which operate such that the virtual machine's operation may seem to be unchanged, or may seem to be the same over time, such as, for example, in cryptojacking. Other malware may scan files, encrypt them, and use the encrypted files as ransom for an encryption key—These malwares may show signs within different volatile memory dumps over time.

According to some embodiments, the method may be configured to detect known Linux malware in cloud environments in a trusted manner by leveraging malicious behavior traces from the volatile memory using machine learning methods.

According to some embodiments, the method may be configured to detect unknown Linux malware in cloud environments in a trusted manner, by leveraging malicious behavior traces from the volatile memory using machine learning methods.

According to some embodiments, the method may be configured detect unknown Linux malware categories in cloud environments in a trusted manner by leveraging malicious behavior traces from the volatile memory using machine learning methods.

According to some embodiments, the method may be configured to accurately categorize Linux malware in cloud environments in a trusted manner by leveraging malicious behavior traces from the volatile memory using machine learning methods.

According to some embodiments, the method may be configured to detect unknown Linux malware in a trusted manner on a different server than the server from which the detection model (or algorithm) was trained.

According to some embodiments, the method may be configured to detect unknown fileless attacks in cloud environments in a trusted manner by leveraging malicious behavior traces from the volatile memory using machine learning methods.

According to some embodiments, the method may be configured to detect known Linux malware in cloud environments on a specific virtual server, in a trusted manner, by leveraging malicious behavior traces from volatile memory using CNN architectures.

According to some embodiments, the method may be configured to detect unknown Linux malware in cloud environments on a specific virtual server, in a trusted manner, by leveraging malicious behavior traces from volatile memory using CNN architectures.

According to some embodiments, the method may be configured to detect an unknown family of Linux malware in cloud environments, in a trusted manner, by leveraging malicious behavior traces from volatile memory using CNN architectures.

According to some embodiments, the method may be configured to perform accurate Linux malware family classification (e.g., categorization) in cloud environments, in a trusted manner, by leveraging malicious behavior traces from volatile memory using CNN architectures.

According to some embodiments, the method may be configured to determine how characteristics (resolution, number of channels) of the volatile memory dump image affect the CNN architectures generalization capability in the task of unknown malware detection.

According to some embodiments, the method may be configured to detect unknown Linux malware in cloud environments on a specific virtual server, when training a CNN on volatile memory dumps acquired from another virtual server in a trusted manner, by leveraging malicious behavior traces from volatile memory using CNN detectors.

According to some embodiments, some solutions for Windows-based clouds, rely on several features related to DLL files, which are absent in Linux-based clouds. Furthermore, Linux has a different kernel structure that performs differently than Windows kernels and uses different system calls, so if the solution relies on features extracted from the kernel or related to system calls, it will need to be modified to fit Linux. Moreover, solutions that process the entire volatile memory or a specific Windows process will also need to be modified, because Linux volatile memory has different structures and components, including the different file systems with different file permissions (read, write, execute) that each of the OS operates.

According to some embodiments, the method described herein is configured to generate a set of features extracted from volatile memory dumps acquired in a trusted manner. These features may be extracted from various sources, components, and segments of the volatile memory, based on human experts' knowledge of the indications and traces of malicious activity within the volatile memory. When leveraged using machine learning algorithms, the set of features, and based on a representative collection of malicious and benign samples, can contribute to the first trusted mechanism for detecting unknown malicious activity in Linux VMs.

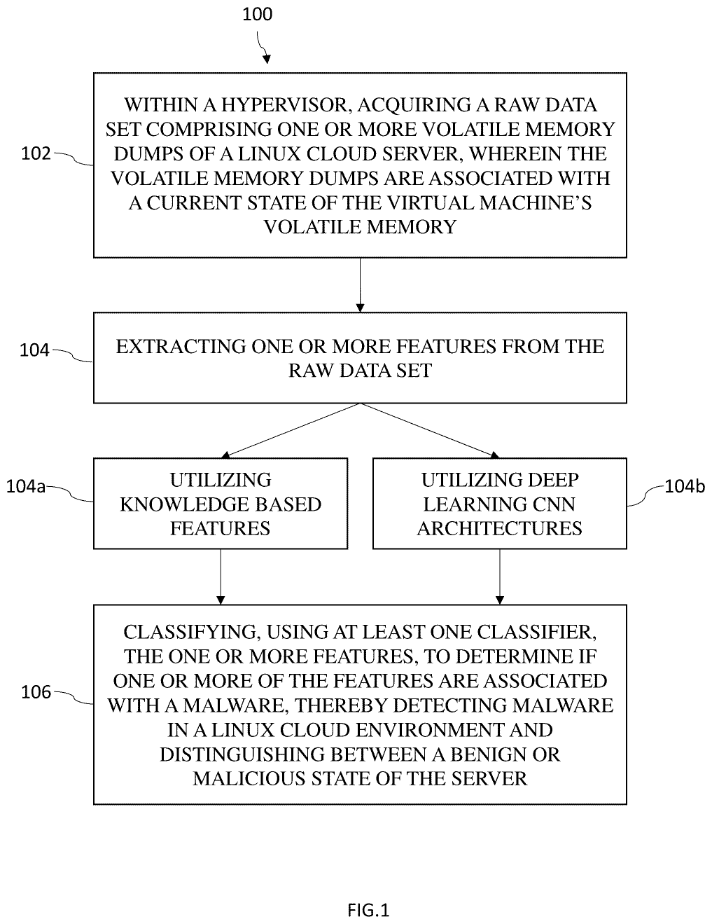

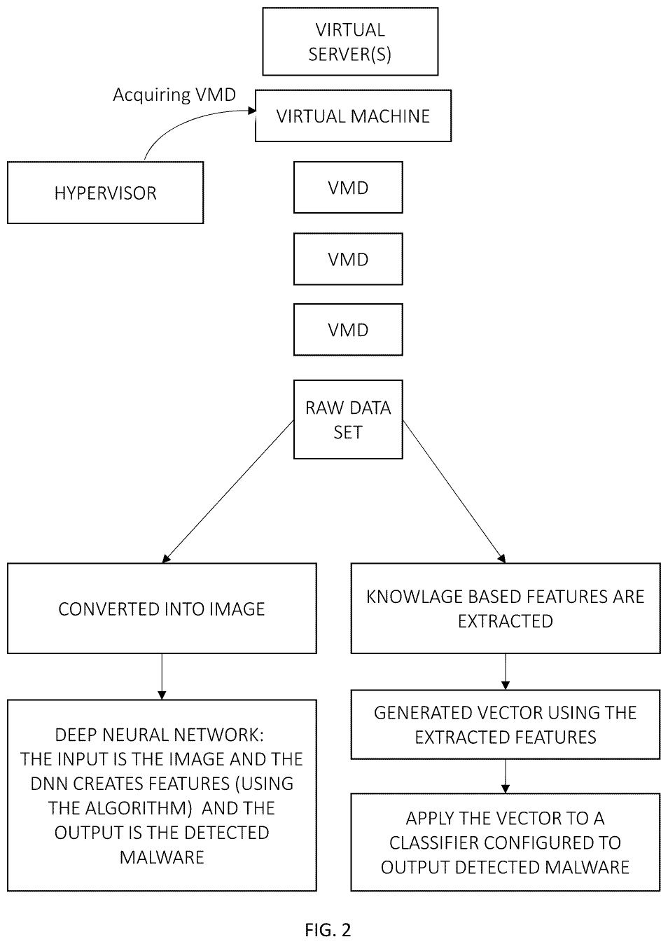

Reference is made to FIG. 1, which shows a flow chart of steps in a method for detection of unknown malware in Linux cloud environments, in accordance with some embodiments of the present invention, and to FIG. 2, which shows a block diagram of the method for detection of unknown malware in Linux cloud environments, in accordance with some embodiment of the present invention.

According to some embodiments, at step 102, the method 100 may include within a hypervisor, acquiring a raw data set comprising one or more volatile memory dumps of a Linux cloud server, wherein the volatile memory dumps are associated with a current state of the virtual machine's volatile memory. According to some embodiments, at step 104, the method 100 may include extracting one or more features from the raw data set. According to some embodiments, at step 104a, the method 100 may include extracting one or more features from the raw data set utilizing knowledge based features. According to some embodiments, at step 104b, the method 100 may include extracting one or more features from the raw data set utilizing Deep Learning Convolutional Neural Network (CNN) architectures. According to some embodiments, at step 106, the method 100 may include classifying, using at least one classifier, the one or more features, to determine if one or more of the features are associated with a malware, thereby detecting malware in a Linux cloud environment and distinguishing between a benign or malicious state of the server.

According to some embodiments, the method may be configured to operate one or more virtual machines on one or more servers. According to some embodiments, the one or more servers may be virtual servers, such as, for example, a cloud server. According to some embodiments, the operating system of the sever may be a Linux operating system. According to some embodiments, the method may include implementing a hypervisor. According to some embodiments, the hypervisor may be configured to manage the one or more virtual machines on the one or more servers.

According to some embodiments, the method may include receiving (or acquiring) volatile memory dumps using (or through) the hypervisor. According to some embodiments, the hypervisor may be a type two hypervisor. According to some embodiments, the hypervisor may be configured to acquire the volatile memory dumps, thereby evading being detected by the malware.

Advantageously, acquiring the volatile memory dumps using a hypervisor prevents malware from knowing that their behavior is being monitored. According to some embodiments, the method described herein is configured to detect malware (or malicious behavior) within the memory dumps captured from the virtual machine. Thus, according to some embodiments, the method may be configured to naturally observe the state of the system (or the virtual machine and/or the server) from the side, in an undetectable manner.

According to some embodiments, the term “volatile memory” as referred to herein may be interchangeable with the term “random access memory” (RAM).

According to some embodiments, at step 102, the method 100 may include within a hypervisor, acquiring a raw data set comprising one or more volatile memory dumps of a Linux cloud server, wherein the volatile memory dumps are associated with a current state of the virtual machine's volatile memory.

It is to be understood that malware of Linux operating system and malware of Windows operating system are different, and thus, memory images (or volatile memory dumps) of Linux operating systems cannot be equated with memory images (or volatile memory dumps) of Windows operating systems.

According to some embodiments, the volatile memory dump of the raw data set may be captured while the one or more virtual machines is running. According to some embodiments, each individual volatile memory dump of the raw data set may therefore represent, or capture, the state of the virtual machine's volatile memory at the time in which the individual volatile memory dump is acquired (or obtained).

According to some embodiments, the raw data set may include at least one volatile memory dump (VMD). According to some embodiments, the raw data set may include one volatile memory dump (or in other words, a single dump, also referred to herein as “single mode”). According to some embodiments, the raw data set may include a plurality of volatile memory dumps (also referred to herein as “multiple mode” or “multiple dump mode”). According to some embodiments, acquiring data associated with volatile memory dumps comprises the entire memory dump.

According to some embodiments, the raw data set may include at least 40, at least 50, at least 100, at least 150, and/or at least 200 volatile memory dumps. Each possibility is a separate embodiment. According to some embodiments, the raw data set may include about 100 volatile memory dumps. According to some embodiments, the raw data set may include between about 60 and 180 volatile memory dumps.

According to some embodiments, acquiring data associated with volatile memory dumps may include acquiring data associated with time intervals between memory dumps. According to some embodiments, the time between two captured volatile memory dumps may vary. According to some embodiments, the time intervals between two captured volatile memory dumps of the raw data set may be constant. According to some embodiments, the volatile memory dumps of the raw data may be acquired (or captured) about 5 seconds apart. According to some embodiments, the volatile memory dumps of the raw data may be acquired about 10 seconds apart. According to some embodiments, the volatile memory dumps of the raw data may be acquired about 20 seconds apart.

According to some embodiments, the method may include generating a plurality of raw data sets. According to some embodiments, the size of the raw data set may be between about 1 and 100 Gigabytes.

According to some embodiments, the method may include implementing a VirtualBox snapshotter. According to some embodiments, the VirtualBox snapshotter may enable acquiring the virtual machine in it's current state. According to some embodiments, the VirtualBox snapshotter may be configured to control any one or more of the setting of the virtual environment, an application to be sampled, a server type, an amount of snapshots to be captured, a time interval between two or more consecutive snapshots, which server is executed, and which server is the one from which the volatile memory dumps are captured, or any combination thereof. According to some embodiments, the server may be a Domain Name System (DNS) server. According to some embodiments, the server may be an HTTP server (or in other words, a web server).

According to some embodiments, the method may include preprocessing the acquired volatile memory dumps and/or the raw data set. According to some embodiments, the method may include preprocessing at least a portion of the acquired volatile memory dumps and/or the raw data set. According to some embodiments, the method may include preprocessing (or processing) the raw data set, thereby generating a processed data set. According to some embodiments, the preprocessing may include removing non-essential data. According to some embodiments, the preprocessing may include converting the acquired volatile memory dumps from a binary format to a non-binary format. According to some embodiments, and as described in greater detail elsewhere herein, the preprocessing may include converting the acquired volatile memory dumps into a visual image format.

According to some embodiments, the method may be devoid of a preprocessing stage, thereby preventing lag time between a malware attack and the detection thereof.

According to some embodiments, the method may include capturing a snapshot of the volatile memory (or in other words, quiring a volatile memory dump) and saving the snapshot (or in other words, the volatile memory dump) as an Executable and Linkable Format (ELF). According to some embodiments, the method may include slicing the snapshot. According to some embodiments, the method may include slicing the snapshot, thereby forming a sliced snapshot. According to some embodiments, the method may include saving the sliced snapshot in a raw format thereof According to some embodiments, the raw data set may include the sliced snapshot. According to some embodiments, the raw data set may include a plurality of sliced snapshots, each corresponding to an acquired volatile memory dump.

According to some embodiments, the method may include producing at least one jpg image from the snapshots and/or sliced snapshots, wherein each of the volatile memory dumps is represented as one or more RGB array. According to some embodiments, the method may include converting the acquired volatile memory dumps into a visual image format, such as, for example, one or more RGB array and/or an image in the form of a jpg file. According to some embodiments, the method may induce converting the one or more volatile memory dumps from a binary format into a visual file including a plurality of pixels. According to some embodiments, and as explained in greater detail elsewhere herein, the method may include applying the image (or jpg file) to a classifier configured to detect malware.

According to some embodiments, the method may include analyzing potential malware behavior by applying one or more of a static analysis method and a dynamic analysis method to the data. According to some embodiments, the static analysis method comprises binary code analysis. According to some embodiments, the dynamic analysis method comprises information extraction during the malware's execution.

According to some embodiments, at step 104, the method 100 may include extracting one or more features from the raw data set. According to some embodiments, the method may include extracting one or more features from the processed data set. According to some embodiments, the method may include extracting the one or more features from the processed data set. According to some embodiments, the method may include extracting two or more features from different parts of the volatile memory. According to some embodiments, the extracted features may be each associated with a different part of the volatile memory, or in other words, different elements of the memory, such as, for example, a number of processes, different processes in the RAM, different communications and/or a number of handles, or any combination thereof.

According to some embodiments, the method may include extracting one or more features from the raw data set utilizing knowledge based features or extracting one or more features from the raw data set utilizing Deep Learning CNN architectures.

According to some embodiments, at step 104a, the method 100 may include extracting one or more features from the raw data set utilizing knowledge based features.

According to some embodiments, the method may include extracting about 250 features. According to some embodiments, the method may include extracting about 200 features. According to some embodiments, the method may include extracting about 170 features. According to some embodiments, the method may include extracting between about 10 and 100 features.

According to some embodiments, the method may include generating one or more vectors, wherein each element (or value) of the array may be associated with one or more of the extracted features. According to some embodiments, the method may include generating one or more vectors for each volatile memory dump, wherein each element (or value) of the array may be associated with one or more of the extracted features. According to some embodiments, the method may include generating the processed data in the form of one or more matrices.

According to some embodiments, the method may include extracting of the one or more features by applying the one or more raw data sets to an algorithm trained using expert knowledge. According to some embodiments, the method may include extracting of the one or more features by applying the one or more processed data sets to an algorithm trained using expert knowledge. According to some embodiments, the method may include extracting of the one or more features by applying the one or more matrices to an algorithm trained using expert knowledge.

Advantageously, extracting knowledge based features enables the reduction of size of the raw data and/or the processed data. According to some embodiments, the method may include converting the raw data and/or the processed data into one or more vectors. According to some embodiments, the method may include converting each of the volatile memory dumps of the raw data and/or the processed data into one or more vectors. According to some embodiments, for each volatile memory dump there may be at least one corresponding vector. According to some embodiments, a plurality of vectors together may define a data set (or matrix) wherein each element of the vector may correspond to a behavior of a different elements, such as described hereinabove. According to some embodiments, each element of the one or more vectors may correspond to computational elements such as, for example, a number of processes, different processes in the RAM, different communications and/or a number of handles, or any combination thereof.

Advantageously, extracting features based on expert knowledge (or in other words, extracting knowledge based features) enables the method to be explainable to the user, and being able to detail exactly what process happened to the user's computer.

According to some embodiments, at step 104b, the method 100 may include extracting one or more features from the raw data set utilizing Deep Learning CNN architectures. According to some embodiments, the method may include extracting the one or more features by applying the one or more image files to a plurality of neural networks. According to some embodiments, the one or more features may be extracted using at least one convoluted neural network (CNN).

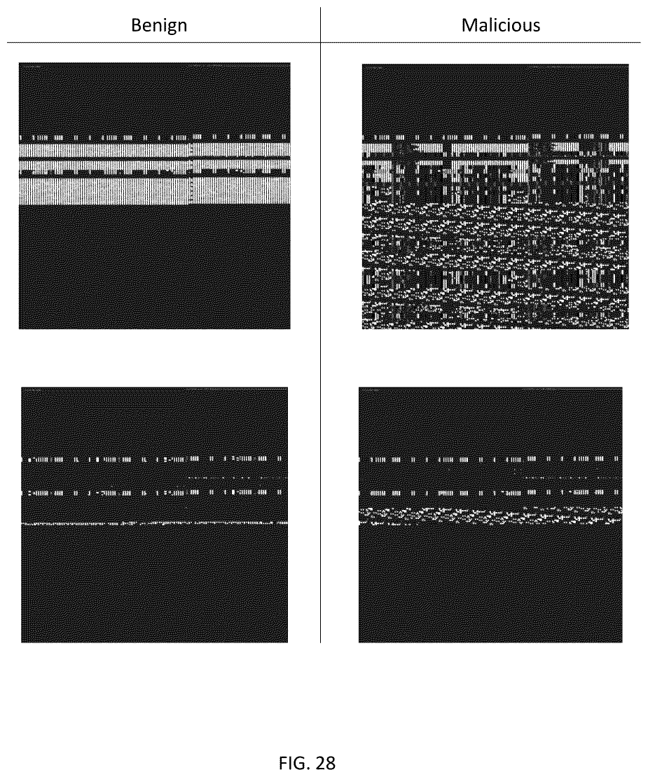

According to some embodiments, the method may include training an algorithm (such as, for example, a deep learning CNN algorithm) by applying a plurality of raw and/or processed data sets to the algorithm. According to some embodiments, the algorithm may be trained using a plurality of images or image files (for example, such as depicted in FIG. 28), wherein the images or image files were converted from one or more volatile memory dumps. According to some embodiments, during training, the algorithm may be configured to define one or more indications (or features) which may be important (for the training of the CNN algorithm).

According to some embodiments, the algorithm may include an input layer configured to receive one or more image files associated with (and/or generated from) the one or more volatile memory dumps. According to some embodiments, the algorithm may be configured to output a classification of the state of the monitored server, virtual machine, and/or computer. According to some embodiments, the algorithm may be configured to implement a representation learning method, in which the algorithm receives an input and creates its own features using machine learning. The term representation learning as used herein may be interchangeable with feature learning, and may refer to one or more techniques that may enable a system to automatically discover the representations needed for feature detection or classification from the raw data set and/or the processed data set.

According to some embodiments, the size of the processed data set (or the image files), may be smaller than the size of the raw data set. According to some embodiments, the resolution of the processed data set (or the image files), may be different than the resolution of the raw data set. According to some embodiments, the channels of the processed data set (or the image files), may be different than the channels of the raw data set. According to some embodiments, the different channels may be any one or more of black and white, colors, two or more specified colors, different ranges of colors, and the like.

Advantageously, using a deep learning CNN algorithm to classify and/or detect malware may be quicker than without using the deep learning CNN algorithm. According to some embodiments, the method for detecting malware may take about 10 seconds for each dump (from the time of acquiring the dump, conversion thereof, and outputting a decision), using a deep learning CNN algorithm.

Advantageously, using a deep learning CNN algorithm to classify and/or detect malware enables the examination of the memory dump as a whole, and not just specific elements of the volatile memory dump and/or the raw data.

According to some embodiments, at step 106, the method 100 may include classifying, using at least one classifier, the one or more features, to determine if one or more of the features are associated with a malware, thereby detecting malware in a Linux cloud environment and distinguishing between a benign or malicious state of the server.

According to some embodiments, the classifier may be configured to classify each processed data set (or raw data set) as being associated with malicious behavior or not being associated with malicious behavior. According to some embodiments, at single mode, the classifier may be configured to classify each volatile memory dump individually (or each vector or image associated with a single volatile memory dump). According to some embodiments, at a multiple dump mode the classifier may be configured to classify the processed data set and/or raw data set.

According to some embodiments, the method may include classifying of the one or more features is based, at least in part, on identified malicious behavioral traces.

According to some embodiments, the classifier may be trained using a validation step, thereby ensuring that the malware is inspected as it performs its malicious activity.

According to some embodiments, the method may include classifying known malware and/or unknown malware families into categories. According to some embodiments, the unknown malware is a malware that the classifier did not encounter during a training process thereof. According to some embodiments, the unknown malware family is a malware family that the classifier did not encounter during a training process thereof According to some embodiments, and as described in greater detail elsewhere herein, the categories may include any one or more of virus, worm, Trojan, DDoS-Trojan, ransomware, botnet, Cryptojacker, APT, cryptominers and rootkit. According to some embodiments, the categories comprise malware families and/or attack type categories. According to some embodiments, the malware may be a foreground process, disguised as a background process, and/or a background process. According to some embodiments, the malware may be a file-less malware, thereby enabling detection of substantially different attack module operandi. According to some embodiments, the categories may include at least one previously unknown category of malware and/or at least one previously unknown malware family.

According to some embodiments, the server may be an unknown (or new) virtual server. According to some embodiments, an unknown (or new) server may be a server on which the classifier and/or algorithm was not trained during the training thereof.

According to some embodiments, there is provided a trusted malware detection framework for Linux-based cloud environments, particularly for Linux virtual machines (VMs) on an organization's private or public cloud. According to some embodiments, the framework is configured to acquire volatile memory from one or more operating Linux virtual servers in a trusted and efficient manner. According to some embodiments, the one or more Linux virtual servers may be one or more Linux Ubuntu virtual servers. According to some embodiments, the framework may be configured to extract a (comprehensive) feature-set from the volatile memory dumps, which may represent various behavioral traces from five parts of the volatile memory. According to some embodiments, the feature set may include about 171 (knowledge-based) features.

According to some embodiments, the feature set may be extracted using a framework based on the Volatility memory forensics framework. For example, according to some embodiments, the feature set may be extracted using a Python framework based on the Volatility memory forensics framework. According to some embodiments, the framework may be configured to leverage the extracted features using one or more machine learning algorithms and/or methods to detect unknown malware. According to some embodiments, the framework as described herein is configured to obtained high True Positive Rates (TPRs) and low False Positive Rates (FPR). Advantageously, obtaining high True Positive Rates (TPRs) and low False Positive Rates (FPR) may be required for further application in evaluation, for example, in commercial security products.

According to some embodiments there is provided a trusted framework for unknown malware detection. According to some embodiments, the framework is configured to implement a method for trusted acquisition of volatile memory dumps from a Linux-based VM. According to some embodiments, the memory dumps may be inputted to deep learning-based algorithms configured to detect unknown malware detection in cloud environments in a trusted manner.

According to some embodiments, an evaluation of the framework included the simulation of two virtual server activities (DNS and HTTP) responding to a variety of clients' requests within a given VM instance. According to some embodiments, the evaluation included, in addition to the main server application, executing a variety of applications (malicious and benign) within the inspected VM. According to some embodiments, during the evaluation, while each of the additional applications was executed, volatile memory dumps were captured (in a trusted and dynamic manner) at a constant frequency by querying the virtual machine's hypervisor. According to some embodiments, after activating the framework over the acquired memory dumps, the acquired dumps may be converted from binary files into JPG images. According to some embodiments, the JPG images may have a variety of resolutions. According to some embodiments, the JPG images may be used as input for training a convolutional neural network (CNN) for the task of unknown malware detection. According to some embodiments, the CNNs may include ResNet50V2, Xception, EfficientNetB2, and VGG 19.

According to some embodiments, there is a trusted unknown malware detection framework for Linux-based cloud environment VMs.

According to some embodiments, the framework may include one or more machine learning algorithms configured to leverage (informative) features extracted from Linux volatile dumps to detect unknown malware in a trusted manner.

According to some embodiments, the trusted detection framework is configured to detect fileless based attacks aimed at compromising Linux cloud infrastructures, such as, for example, DNS spoofing and DDoS attacks.

According to some embodiments, the framework is configured to extract features from the volatile memory. According to some embodiments, the framework is configured to extract features from different parts of the volatile memory. According to some embodiments, the framework is configured to generate a feature set based on the extracted features. According to some embodiments, the feature-set may be knowledge based. According to some embodiments, the framework is configured to generation the feature-set, based on features extracted from different parts of the volatile memory, thereby enabling the framework to capture various malicious behavior performed by malware. According to some embodiments, the malware may be of different malware categories, thereby making the framework more robust.

According to some embodiments, the framework was evaluated on two popular and different virtual servers (DNS and HTTP), making it a more general and comprehensive detection framework. According to some embodiments, the framework is configured to detect unknown Linux malware on new virtual servers (or in other words, servers that it was not trained on).

According to some embodiments, the framework may be Deep-Hook, wherein Deep Hook is a trusted deep learning-based framework for unknown malware detection in Linux cloud environments. According to some embodiments, the framework may use variety of file formats: ELF, SH, JPG, PDF, XLSX, and the like.

According to some embodiments, the framework, or Deep-Hook, may be capable of detecting sophisticated malware that use obfuscation techniques. According to some embodiments, the framework (or Deep Hook) may be configured to implement a hybrid analysis in which inspected applications are executed and dynamically examined, and their true behavior is depicted in the volatile memory dumps captured. Thus, according to some embodiments, the framework (or Deep Hook) may be capable of detecting sophisticated malware that use obfuscation techniques

According to some embodiments, the framework, or Deep-Hook, may be configured to analyze the entire volatile memory dump and consider all of the traces associated with an application's behavior, thereby allowing the framework and/or Deep-Hook to better profile the true behavior of applications.

According to some embodiments, the framework, or Deep-Hook, may be configured to analyze the volatile memory dump quickly and/or automatically without the need for preprocessing and/or without the knowledge of a cyber-security domain expert for feature engineering, thus saving costs and avoiding the issue of a time lag between a malware attack and its detection.

According to some embodiments, the framework, or Deep-Hook, may be configured to detect unseen malware, even malware from new malware families, on different types of servers.

According to some embodiments, the term “server” as used herein may refer to a piece of computer hardware or software (computer program) that provides functionality for other programs or devices, such as “clients”. According to some embodiments, a server can provide various functionalities, often called “services”, such as sharing data or resources among multiple clients, or performing computation for a client. According to some embodiments, a server may be any one or more of a database server, file server, mail server, print server, web server, game server, and application server, or the like. According to some embodiments, information technology (IT) resources, such as computational and processing resources, databases, storage, applications, etc., can be delivered using servers located in large, distant data centers; in this setup, the client's local computer only handles the user interface.

According to some embodiments, the term “cloud” as used herein may refer to a computer system resource, such as, but no limited to, data storage and/or computing power, without active management by a user. According to some embodiments, cloud computing may be deployed using a private cloud, a public cloud, and/or a hybrid cloud. According to some embodiments, a private cloud may be a cloud service dedicated to a single consumer (such as, e.g., an organization). According to some embodiments, a public cloud may be offered to multiple consumers by a cloud provider. According to some embodiments, the cost of using a public cloud may be based on pay-as-you-go pricing. According to some embodiments, public clouds may be divided into three main categories: Infrastructure-as-a-Service (IaaS), Platform-as-a-Service (PaaS), and Software-as-a-Service (SaaS).

According to some embodiments, some of the main advantages of cloud computing may include, but are not limited to, (1) a reduction in operating costs and development time, (2) more efficient IT infrastructure operation, (3) improved load balancing (of the computational workload) for better utilization of computing resources, (4) flexible and scalable IT resources, and (5) fault tolerance to ensure high availability and business continuity in the case of system failures. Accordingly, due to its high importance and popularity, the cloud has become an attractive target for cybercriminals seeking to steal personal data, and sabotage and harm both individuals and organizations using the cloud.

According to some embodiments, the term “virtualization” as used herein may refer to the act of creating a virtual (rather than actual) version of something, including, but not limited to, any one or more of virtual computer hardware platforms, storage devices, and computer network resources.

According to some embodiments, one of the core technologies behind cloud computing is virtualization, which may include an infrastructure used to run multiple virtual machine (VM) instances of diverse computer systems called guests.

According to some embodiments, the term “virtual machine” (VM) as used herein may refer to a virtualization and/or emulation of a computer system. According to some embodiments, the virtual machine may be based on one or more computer architectures and be configured to provide functionality of a physical computer. According to some embodiments, one or more implementation of the VM may involve specialized hardware, software, or a combination thereof. According to some embodiments, the VM may include an efficient, isolated duplicate of a real computer machine.

According to some embodiment, each virtual machine (guest instance) may have an individual virtual hardware configuration and/or may run a separate copy of an operating system (OS). According to some embodiments, the main component that enables the separation (of the virtual hardware configuration and the operating system) may be the virtual machine monitor (VMM), also known as a hypervisor. According to some embodiments, the hypervisor may be responsible for abstracting the computer's physical hardware and creating multiple VMs. According to some embodiments, there are two types of hypervisors: bare metal (Type 1) and hosted (Type 2). According to some embodiments, type 1 hypervisors run directly on the local host's hardware. According to some embodiments, type 2 hypervisors are (essentially) software that runs on top of the operating system. For example, the hypervisor Microsoft Hyper-V is a type 1 hypervisor, and the hypervisor Oracle VirtualBox is a type 2 hypervisor.

According to some embodiments, an operating system (OS) may include a system software that manages the communication between computer software and hardware resources. According to some embodiments, Linux is a Unix-based OS. According to some embodiments, Linux is based on an operating system kernel called the Linux kernel, and has different versions called distributions that are suitable for different types of users and needs. According to some embodiments, some of the distributions of Linux may include Ubuntu, CentOS, and Debian.

According to some embodiments, the kernel may be the core of the OS that manages the CPU, memory, and peripheral devices. According to some embodiments, the Linux kernel may include a monolithic kernel. According to some embodiments, a monolithic kernel may include an architecture where the entire OS is working in the kernel space, which provides a layer of protection from malicious software. According to some embodiments, the Linux kernel can dynamically load modules, making it compact and therefore popular in embedded systems as well. The applications run in another part of the memory (user space) and are supplied with kernel system calls that allow them access to services from the kernel space. Only a verified copy of the request can pass in. Those system calls represent the interactions of a program with the OS and can also be analyzed to detect malicious behavior. The Linux kernel has several extensions that enhance its security, making it more resilient to penetration and attacks.

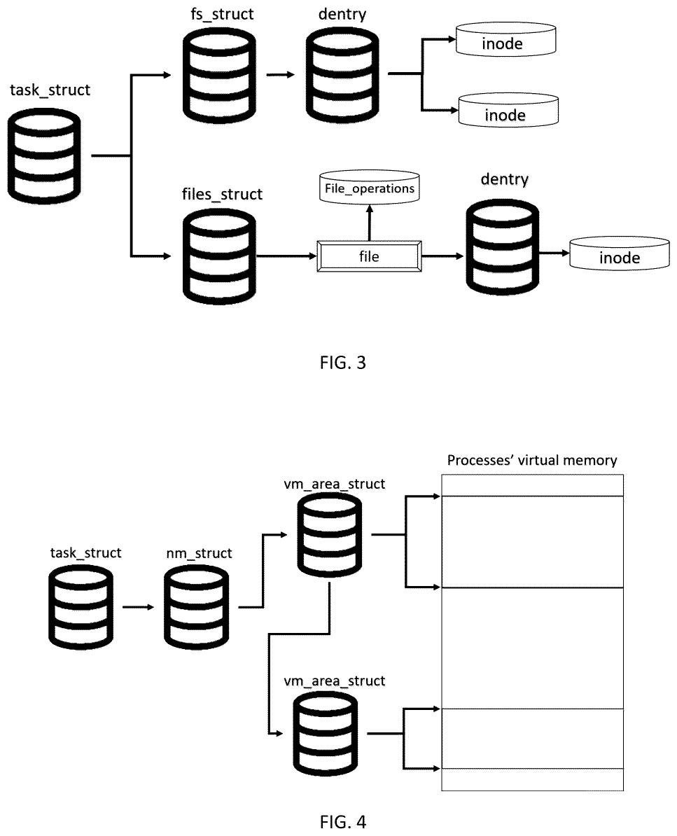

Reference is made to FIG. 3, which shows a schematic illustration of relations between a task_struct and a file, in accordance with some embodiments of the present invention, and to FIG. 4, which shows a schematic illustration of the relations between a task_struct the virtual memory, in accordance with some embodiments of the present invention.

According to some embodiments, a process is an instance of a program. According to some embodiments, a process is a continually changing entity that contains the program instructions, program counter, CPU's registers, current activity in the microprocessor and stacks, and temporary data like saved variables. Every process is represented by a data structure called task_struct, which contains information about the process state and scheduling, inter-process communications, links to parent and siblings, the time the process started, the CPU time consumed, and pointers to open files and directories. According to some embodiments, every process has its own virtual address space, with its rights and/or responsibilities. According to some embodiments, there are two types of processes in Linux: Foreground processes and background processes. According to some embodiments, Foreground processes may include processes that are initialized and controlled through a terminal session by the user. According to some embodiments, Background processes may include processes that are initialized by the system (e.g., managing memory processes). According to some embodiments, one type of background processes may include daemons. According to some embodiments, daemons may be controlled by the user and start at system startup and keep running as a service. In Linux, the user can create a process and send it to run as a background process, so malware on Linux can be running as a foreground process or disguise itself as a background process. According to some embodiments, an init process may include a daemon process. The init process is the first process started during booting of the computer system. Init is a daemon process that continues running until the system is shut down. The init process is the parent of all processes, and it is the first program executed by the kernel when Linux boots up. New processes are created by being cloned from their parent process. The kernel identifies every process by its unique process ID (PID) and its parent process ID (PPID). This PID is valid only as long as the process is in the process table, and it can be used again for a newer process.

Having multiple processes for the same program is possible. For example, when a user executes a command in the Linux console, the program process will have a unique ID, and its parent will be the console. After completing its execution, the child process is terminated, and the parent receives an update about the termination. However, if the parent process is terminated before the child, the child process becomes an orphan process, and its parent becomes the init process.

According to some embodiments, Linux implements virtual memory management through a series of data structures. According to some embodiments, applying forensic methods on those data structures makes it possible to reveal malicious code running on the device. According to some embodiments, data structure, based on their role, may be more indicative and relevant to infer a potentially malicious activity happening within the hosting system.

According to some embodiments, the data structures may include task structures (also referred to herein as task struct, or in other words, “struct” may be interchangeable with “structure”). According to some embodiments, the task struct may be created by the kernel for every process. According to some embodiments, the task struct may contain information about each process's current state, the time it started, open file information, the executable name, the unique process ID (PID), the interrelations between the processes, and/or any combination thereof.

According to some embodiments, a hash table (hash map) may include a data structure configured to implement an associative array abstract data type, a structure that can map keys to values. According to some embodiments, a hash table uses a hash function to compute an index, also called a hash code, into an array of buckets or slots, from which the desired value can be found. According to some embodiments, A hash function may include any function that can be used to map data of arbitrary size to fixed-size values.

According to some embodiments, the method may include implementing a PID hash table. According to some embodiments, the PID hash table is generated by having the kernel create a hash list for all of the processes, hashed on the PID. Advantageously, generating a PID hash table improves the efficiency and time required to find a specific process.

According to some embodiments, the method may include implementing a Kmem_cache. According to some embodiments, a Kmem_cache may be used for structures that are allocated and deallocated and are often used, thereby ensuring that allocation can be done at O(i) efficiency. According to some embodiments, structures that are allocated and deallocated and are often used may be related to process handling, file system manipulation, and/or network processing, or any combination thereof.

According to some embodiments, the method may include implementing a Vm area struct. According to some embodiments, the Vm area struct may contain information regarding a contiguous virtual memory area, the start and end address for the memory area, and/or the access permissions, or any combinations thereof According to some embodiments, the memory region may be a read-only library loaded into the address space or process heap.

According to some embodiments, the method may include implementing a file struct. According to some embodiments, a file struct may contain information about the interaction between a process and any open file it accesses. According to some embodiments, the file struct may include a pointer to the file operation available to the process and a pointer to where the file is.

According to some embodiments, the method may include implementing an Address space struct. According to some embodiments, the address space struct may be created by the kernel for every memory-mapped file. According to some embodiments, the address space struct may contain information about all of the memory pages belonging to a file.

According to some embodiments, the method may include implementing a Kernel module.list. According to some embodiments, the Kernel module.list may include a linked list of the kernel modules loaded.

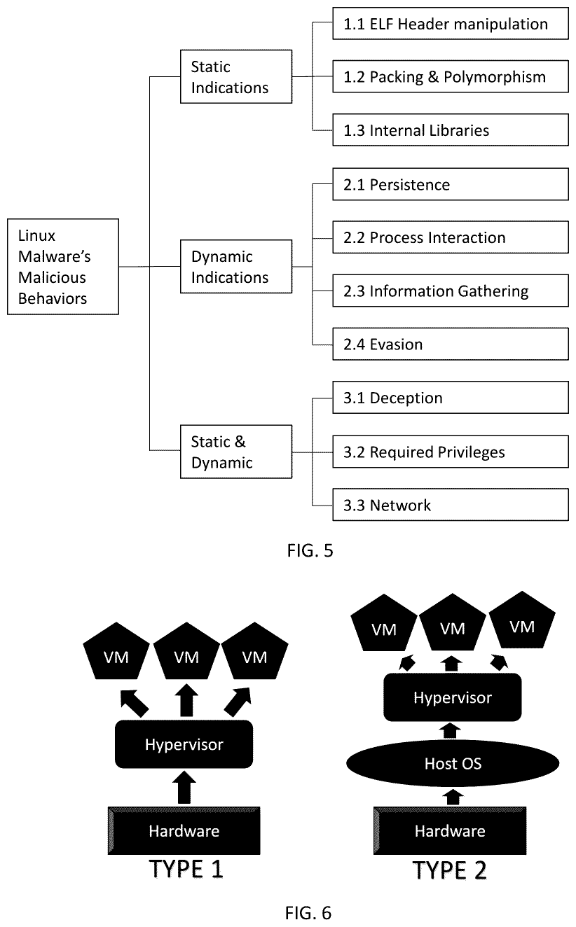

Reference is made to FIG. 5, which shows a block diagram of taxonomy of potential behavior indicative of Linux malware, in accordance with some embodiments of the present invention.

According to some embodiments, malware associated with the Linux operating system, or in other words, Linux malware, can attack a diverse set of targets, such as smartphones, surveillance cameras, medical devices, personal computers, Web servers, and more. This diversity leads to a significant disadvantage that Linux malware encounters, as it needs to be compatible with the target hardware's architecture. Most malware targets specific architectures (for example, such as ARM 32-bit), but some malware has been developed to infect several architectures. Moreover, some malware loads external libraries during its execution, expecting them to be available in the target system, and the malware's execution is halted or interfered with when the required library is lacking.

According to some embodiments, Linux malware may be categorized according to its main malicious activity. According to some embodiments, Linux malware may be categorized according to its malicious activity. According to some embodiments, the categories into which Linux malware may be categorized may include, but are not limited to, any one or more of ransomware, Trojans, cryptominers, worms, and the like. According to some embodiments, each category of Linux malware may have different behavior (and/or a different attack goal). Thus, each category of Linux malware may result in different indications and traces in a hosts' volatile memory. According to some embodiments, potential malware behavior can be analyzed by applying static analysis methods, like binary code analysis. According to some embodiments, the method may include analyzing potential malware behavior. According to some embodiments, the method may include analyzing potential malware behavior by applying static analysis methods thereto.

According to some embodiments, every computerized system may be exposed to cyber threats, such as attacks, malware, etc. Malware can perform various functions, including stealing, encrypting or deleting sensitive data, altering or usurping core computing functions, and monitoring users' computer activity without their permission.

In some embodiments, Malware may be classified based on the malware family it is part of. According to some embodiments, the (main) malware families, may include any one or more of virus, worm, ransomware, trojan, botnet, cryptojackers, advanced persistent attacks (APTs), and rootkits. According to some embodiments, a virus may be configured to inject its malicious code into other files, and hence spreads within the host and sometimes to other hosts. According to some embodiments, a worm may be a program that replicates itself and spreads through computer networks to additional hosts. According to some embodiments, Ransomware may encrypt the local files within a computer using a robust encryption form and then demands payment in exchange for the decryption key. According to some embodiments, a Trojan may be a type of malware usually employed by cybercriminals and hackers trying to access users' systems and is often disguised as benign software, such as game or useful tool. According to some embodiments, a botnet, short for robot network, may include “zombies” designed to automatically carry out malicious operations, such as, for example, stealing sensitive data and/or spying on user activities. According to some embodiments, botnets may mainly excel at launching distributed denial-of-service (DDoS) attacks in which web services are overloaded. According to some embodiments, Cryptojackers may usurp any available computing power of the victim's computer to mine valuable cryptocurrency for the attacker. According to some embodiments, advanced persistent attacks (APTs) may be compound network attacks with multiple stages that combine different hacking techniques. According to some embodiments, an APT's main objective may be to gain access to a system to steal information over an extended period of time, sabotage operations, or destroy the system's infrastructure. According to some embodiments, Rootkits poses extensive system's root privileges, thereby allowing attackers to control a compromised machine to steal data or sabotage a system by installing additional malware.

According to some embodiments, the method may include analyzing potential malware behavior by applying dynamic analysis methods thereto. According to some embodiments, dynamic analysis methods may include information extraction during the malware's execution. According to some embodiments, the potential behavior (or behavioral indications) can be categorized into three or more main categories: static indications, dynamic indications, and/or any combination thereof, such as depicted in FIG. 5. Accordingly, FIG. 5 shows each of the behavioral indications, each having a reference number. According to some embodiments, and as described in greater detail elsewhere herein, the set of features may be based, at least in part, on the behavioral indications.

According to some embodiments, techniques for analyzing malware differ in terms of how they work, and each technique has advantages and disadvantages. According to some embodiments, static analysis may be defined as the process of analyzing software without executing it, and it is used to extract meta-features regarding the software's structure, such as control flow graphs, opcode sequences, and the like. According to some embodiments, static analysis may be relatively fast, and usually, the inspected malware isn't aware of the static inspection process, meaning that static analysis is usually considered trusted. However, in the case of sophisticated malware that uses code obfuscation (or encryption or packing) techniques, the malware can evade static analysis techniques; this can result in the misclassification of malware as benign.

According to some embodiments, in dynamic analysis, the software is executed and sampled during runtime to obtain behavioral features, such as API calls, registry changes, network traffic, and more. According to some embodiments, a sandbox environment may be used for dynamic analysis to protect and isolate malware's execution from the local inspected host. Although it is more robust and reliable than static analysis, dynamic analysis may consume considerable resources and requires a significant amount of time. Furthermore, some malware can detect that they are being executed in an emulated environment, especially when being inspected by different antivirus software running simultaneously. According to some embodiments, some malware can change their behavior, allowing them to evade detection mechanisms which classify them as benign files. A hybrid analysis approach can be used by combining both static and dynamic analysis techniques (referred to herein as static and dynamic indications2), an approach which is considered much more robust, accurate, and trusted.

According to some embodiments, the reliability of such malware analysis techniques may depend on whether it is trusted or not. According to some embodiments, an analysis technique may be untrusted in cases in which the inspected system is used for both malware execution and runtime analysis. According to some embodiments, in the setting in which the inspected system is used for both malware execution and runtime analysis, the malware's awareness of the inspection process allows it to transform from malicious to benign behavior. Moreover, in untrusted analysis, malware can interfere with, and even turn off, the existing detection mechanisms. According to some embodiments, an analysis technique may be trusted or secure when the malware isn't aware that it is being inspected. Thus, according to some embodiments, when a trusted or secure analysis technique is applied, the malware does not change or delay its malicious behavior to evade detection and cannot interfere with the detection mechanism. For instance, analysis methods in which the malware is executed within a VM while memory snapshots are continuously captured and dumped by the hypervisor, isolated from the VM guest, are trusted. According to some embodiments, during snapshot capturing, the VM guest is suspended. However, since the hypervisor runs on a separate abstraction layer, the malware isn't aware that it is under inspection.

According to some embodiments, an analysis technique may be semi-trusted when the analysis method relies on trusted memory dump capturing using a hypervisor combined with additional untrusted features extracted within an untrusted environment. According to some embodiments, an untrusted environment may be when malware execution and runtime analysis are conducted on the same inspected system.

According to some embodiments, the behavioral indications may include static indications. According to some embodiments, the static indications may include ELF header manipulation 1.1. According to some embodiments, the static indications may include packing and polymorphism 1.2. According to some embodiments, the static indications may include Internal Libraries 1.3.

According to some embodiments, the ELF header manipulation may include tampered ELF headers, wherein the tempered ELF headers may be configured to evade or crash standard analysis tools. According to some embodiments, malware developers tamper with the ELF headers to evade or crash standard analysis tools, for example, ELF files that still follow the ELF specifications but report a different OS application binary interface (ABI) and can be executed correctly by the kernel.

According to some embodiments, the packing and polymorphism may include a technique aimed at slowing down and/or preventing the attempts to statically analyze the malware by transforming some of the original malware data (its binary code) into a series of random-looking data or by decrypting parts of it. According to some embodiments, polymorphism may include a technique used by program developers to provide a single interface with different data types and obfuscate static analysis.

According to some embodiments, the internal libraries may include one or more libraries having no external dependency. According to some embodiments, most Linux malware is statically linked to its libraries without any external dependency, or in other words, internal libraries. However, when libraries are imported, the most common libraries imported are glibc (GNU C), which provides critical APIs, such as open read and write. Accordingly, this library (the glibc, GNU C, library) is also commonly imported by benign programs. Additionally, the library Clibc provides an APIs to embedded Linux systems.

According to some embodiments, the behavioral indications may include dynamic indications. According to some embodiments, the dynamic indications may include persistence 2.1. According to some embodiments, the dynamic indications may include process interaction 2.2. According to some embodiments, the dynamic indications may include information gathering 2.3. According to some embodiments, the dynamic indications may include evasion 2.4.

According to some embodiments, persistence may be used to describe the malicious executable's ability to run regardless of possible reboots and power-offs. According to some embodiments, persistence may be achieved by applying one of the following approaches: execute on reboot, scheduled execution, and/or file infection and replacement. According to some embodiments, the execute on reboot may include one or more Linux malware configured to modify the system rc script executed at each run level (like a reboot), thereby executing the malware as well. According to some embodiments, the execute on reboot may include a scheduled execution. According to some embodiments, the scheduled execution may be when one or more Linux malware tries to modify the cron configuration files, thereby getting a scheduled execution at a fixed time interval. According to some embodiments, the execute on reboot may include a File infection and/or replacement. According to some embodiments, the file infection and replacement may include a method in which the malware tries to replace or infect files that already exist in the target file system, such that the malicious code will be executed when the infected file is executed. According to some embodiments, the execute on reboot may include a process interaction. According to some embodiments, the process interaction may be a Linux malware which interacts with other processes in the system and/or their children's processes, and such information can be obtained during execution. According to some embodiments, the execute on reboot may include one or more multiple processes. According to some embodiments, the multiple processes may be when malware spawns processes during its execution. For example, some botnets create several processes to parallel DDoS attacks. According to some embodiments, the execute on reboot may include a process injection. According to some embodiments, the process injection may be when malware injects code into other program's processes, making the sample more difficult to detect. According to some embodiments, process injection may be done using on or more different techniques involving the ptrace system call and/or other process related system calls.

According to some embodiments, the dynamic indications may include information gathering. According to some embodiments, information gathering may include a method in which during execution, Linux malware collects information regarding the environment it is executed in, controls the execution, and sends system data to a C&C (Command and Control) server. According to some embodiments, there are four main types of information gathered: Network configuration, system configuration, process enumeration, and configuration files. According to some embodiments, network configuration may include obtaining the active network interfaces, active TCP sockets, ARP table, and transmission queue. According to some embodiments, System configuration may be when malware samples collect data about the system's kernel, physical and volatile memory, and files used by the sandbox. According to some embodiments, Processes enumeration may be a process of extracting user names, machine names, network resources, shares and/or services from a system, or any combination thereof. According to some embodiments, for example, malware samples may perform a full scan of the proc, searching for other programs. According to some embodiments, the processes enumeration and/or the full scans may be used to prevent multiple malware executions and/or identify other programs executed in the same environment, thereby enabling them to identify AV and/or sandbox environments. For example, some cryptominers may try to kill any other cryptominers that may be running, such that they will have more computational resources for their execution.

According to some embodiments, the information gathering may include configuration files. According to some embodiments, Linux malware may access configuration files to achieve persistence, obtain a list of the registered accounts, and/or create a backdoor account.

According to some embodiments, the dynamic indications may include evasion. According to some embodiments, evasion may be when Linux malware can hide its malicious behavior by detecting the presence of analysis or detection tools or detecting if it is being executed within an analysis environment. According to some embodiments, when malware detects that it is executed in an inspection environment, it can stop its execution, delay its malicious activity, or even try to delete user and system files. According to some embodiments, there may be three main types of evasion techniques used by malware: Absence of human interaction, artifact-based, and timing based.

According to some embodiments, evasion in the absence of human interaction may be when malware samples search for common human user interactions like mouse movements to identify whether or not it is being executed in a real environment. According to some embodiments, artifact-based evasion may be when the VM may have unique artifacts like specific process names, service lists, and/or different CPU instruction results. According to some embodiments, the timing based evasion may be when one or more sandboxes monitor malware's execution for a certain amount of time. Some malware delays its execution or executes benign code at the beginning of the monitoring process and starts its malicious activity only after it has been examined.

According to some embodiments, the behavioral indications may be static and dynamic. According to some embodiments, the static and dynamic behavioral indications may include deception 3.1. According to some embodiments, the static and dynamic behavioral indications may include required privileges 3.2. According to some embodiments, the static and dynamic behavioral indications may include network 3.3. According to some embodiments, deception may when Linux malware tries to hide its maliciousness by appearing as a benign application; either static or dynamic indications can identify this behavior. According to some embodiments the deception may include a static indication in which the malware tries to hide by assuming names that look genuine and innocuous at first glance to trick the user into opening a file that looks benign (such as, e.g., a file name). According to some embodiments, the deception may include a dynamic indication in which the application assumes that different names in the list of running processes will exist (like ‘sshd’) or even an empty process name. According to some embodiments, some malware invokes the system call prctl with the request PR_SET_NAME to change its name, and some use the prctl to change its name in the /proc/<PID>/status or /proc/<PID>/cmdline name lists.

According to some embodiments, the static and dynamic behavioral indications may include one or more required privileges. According to some embodiments, Linux malware shows different behavior when it is executed with different privileges. For example, some malware samples may need higher privileges to delete files from protected folders like /var/log that contains file logs. According to some embodiments, Some Linux malware will try to retrieve the user or group identities to decide how to act. In the case that malware is being executed without the required privileges, EPERM or EACCES errors will be invoked. According to some embodiments, there may not be evidence of samples that have successfully elevated their privileges or were able to perform privileged actions under user credentials. Some malware samples use known Linux kernel vulnerabilities like CVE-2016-5195 and CVE-2015-1328 to escalate their privileges.

According to some embodiments, the static and dynamic behavioral indications may be in the network. According to some embodiments, some Linux malwares communicate over the network to perform its malicious behavior or to receive and send information; note that some malware does not communicate over the network at all. According to some embodiments, the indication may be in the Network flow routine. According to some embodiments, (and like Windows-based malware,) Linux malware may generate network traffic with a few random elements, receive commands and send reports in a specific structure, and test particular credentials and ports in the same sequences. According to some embodiments, some malware samples communicate with a C&C server (command and control server) to receive attack commands, updates, and encryption keys; send back status and keepalive messages, as well as exfiltrating information stolen from the host (for example, e.g., some samples from the Mirai family communicate through the Tor network). According to some embodiments, some malware communicates with a static IP address, and some resolve a domain name that is hardcoded in its executable. According to some embodiments, the Linux malware can perform different kinds of manipulation on the network, like shutting down Telnet and SSH services in the host device.

According to some embodiments, some malware can detect that it is being executed in a malware analysis environment or under inspection and then react by ceasing its execution or by delaying or even changing its behavior. A detection mechanism is considered trusted both when it cannot be affected or manipulated by the subject that it is examining and when the malware is unaware of the existence of the detection mechanism. Software-based mechanisms like antiviruses that are installed on the hosting machine are considered untrusted, as they can be manipulated or affected by the malware resident on the same host.

According to some embodiments, the cloud's virtualized environment may enable a trusted method of malware inspection. According to some embodiments, by querying the hypervisor, the memory dumps which contain the current state of the virtual machine's volatile memory may be acquired in a trusted manner. According to some embodiments, the dumps may be extracted by external clients, as programs inside the VM are unaware of these clients, while the VM is temporarily frozen.

Reference is made to FIG. 6, which shows a block diagram of types of hypervisors, in accordance with some embodiments of the present invention.

According to some embodiments, there may be two types of hypervisors: a type 1 hypervisor and a type 2 hypervisor. According to some embodiments, the type 1 hypervisor, which may also be called a “bare-metal hypervisor,” may run directly on the host machine's physical hardware. Examples of type 1 hypervisors may include VMware ESXi and Microsoft Hyper-V. According to some embodiments, the type 2 hypervisor, which may also be called the “hosted hypervisor,” may be a software (or program) that is installed on top of an existing OS (operating system). According to some embodiments, the type 2 hypervisor may rely on the host OS to manage its CPU, memory, storage, and network resources. Examples of a type 2 hypervisor may include the Oracle Virtual Box.

Type 1 hypervisors are considered to be safer because of the absence of a guest OS with its vulnerabilities. Furthermore, they are considered faster because they have direct access to the hardware. Still, type 1 hypervisors may need hardware acceleration technologies in order to well perform all of the tasks that are required to manage the virtual resource, which may eventually lead to a decreased performance.

In contrast to the type 1 hypervisor, the type 2 hypervisor may have an advantage in its ability to use hardware accelerations, if the host hardware chipset supports it, which contributes to better performance. Moreover, unlike type 1, the type 2 hypervisor does not need a management console deployed on another machine in order to set up and manage the VMs, since these tasks can be performed from the hosting machine. Furthermore, the type 2 hypervisor has unique security features that may enable to intercept operations that have a potential to interfere with the host hardware whenever the guest attempts to perform a malicious act. However, in the type 1 hypervisor, there is no separation, thereby a malicious code can harm the hardware. Accordingly, the type 2 hypervisor may be as efficient and/or secure as the type 1 hypervisor, but with more convenient management.

According to some embodiments, memory forensics analysis (MFA) tools may be used to address the semantic gap between the information obtained regarding a virtual machine's memory state represented in raw binary form and the extraction of high-level features, such as the processes running, system calls, threads, network connections, etc. According to some embodiments, such information can capture the abnormal behavior of malicious programs executed on an inspected VM. According to some embodiments, since the MFA phase is time-consuming, intrusion detection systems (IDSs) must reduce the amount of time spent on knowledge discovery due to their dependence on the analysis output. Since malware is configured to evolve and become more sophisticated, both of the behavior and the symptoms of the malware may vary.

An advantage of using dynamic analysis, whereby the application being inspected is executed. Therefore, cases in which sophisticated malware uses evasion techniques, such as code obfuscation, can be discovered, unlike in static analysis. According to some embodiments, the methods provided herein may be suitable for a large number of malware types and may be configured to generalize given a new kind of malware.

According to some embodiments, there may be three types of analysis approaches: trusted, semi-trusted, and untrusted analysis. According to some embodiments, the analysis approach of the methods disclosed herein is a trusted approach.

According to some embodiments, a dynamic analysis approach may be considered more robust and accurate than static analysis approaches. However, dynamic analysis-based solutions are time-consuming and require additional sandbox software or hardware resources.

### Method for Trusted Unknown Malware Detection and Classification in Linux Cloud Environments Using Knowledge-Based Features

### A. Data Collection and Acquisition

In total, the data collection consists of 21,800 different volatile memory dumps, taken from two widely-used virtual servers during their ongoing use and during the execution of a varied and representative collection of benign and malicious Linux applications. Provided herein a detailed explanation regarding the collection of benign and malware samples used in the detection framework's trusted acquisition process.

### 1. Benign Sample Collection

Our benign sample collection includes 56 samples (54 benign applications and two additional samples representing the states of the VM itself). A list of the samples and their SHA256 can be found in Appendix I. It was aimed to compile a collection of samples that reflect and mimic the activities performed in a real-world server, so samples were collected from various popular programs and applications that assist in the VM's management. There are several activities that the applications perform, such as monitoring network traffic, monitoring the processes and their resources, tracking the system performance, or performing server maintenance, and it is essential to mention that these activities will have a different impact on the volatile memory and the proposed feature set. There are five types of benign programs. The first type executes build-in Linux terminal commands, like monitoring the active process with a top command or copying files with a cp command. The second type executes light monitoring software, like the bandwidth monitoring tool Bmon that can be downloaded and executed from a simple command in the Linux terminal. The programs used were downloaded from the GNU projects. The third type is benign software with a multifunctional GUI that is commonly used in servers, such as the packet analyzer program Wireshark. The fourth consists of different file types that an administrator may open, like xslx files or PDFs. And in the process of opening these files, other programs that are executed by the OS (e.g., LibreOffice Calc that handles xslx files). The fifth consists of different programming language installations and updates.
To those 54 samples, two samples were added-one is a sample of the clean VM when the VM is not executing any programs except for the OS processes, and the other sample is obtained when the VM is executing its main program, either a DNS server or an HTTP server while responding to clients. Those two samples are considered the baseline representing the most common state of the server.

### 2. Malware Sample Collection

50 active malware samples were collected from VirusTotal and ViruShare. All of the samples were verified to be malicious by the VirusTotal testing framework. Because of the wide range of Linux architecture, all the malware samples were verified to be compatible with the infrastructure. Malware samples that are not compatible are not a threat to the VM because they cannot perform their malicious activity. In addition, only tested malware were samples that do not need user interaction, meaning that they start to operate right after execution.

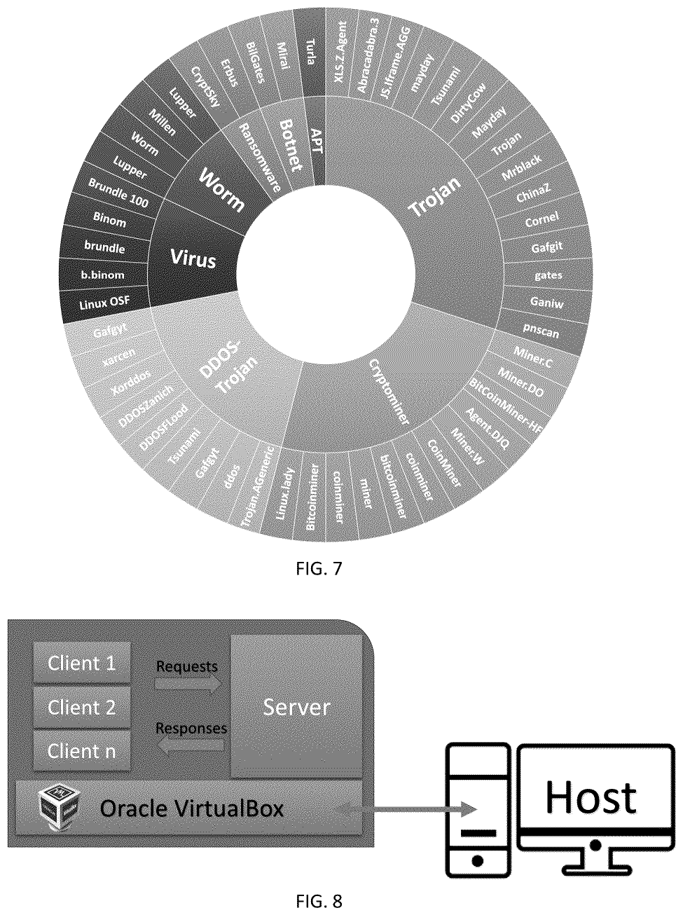

Reference is made to FIG. 7, which shows exemplary categories of malware and malware families, in accordance with some embodiments of the present invention.

To test the framework against different malicious behavior, malware samples were collected from different categories, including ransomware, cryptominers, Trojans, viruses, botnets, and APT. To make the malware collection more comprehensive, also included were infected non-executable files, like JPG and PDF files that contain malicious code and exploit vulnerabilities in the default Linux OS hosting programs that execute them. This was done to better represent administrator activity on such a server in the cloud (for example, administrators often open documents when performing maintenance work, such as reading about a new patch or server updates). As presented in FIG. 7, the collected malware samples, using their common name and grouped by category. A full list of the malware with their unique SHA-256 is provided in Appendix II. To increase the evaluation's robustness to those 50 samples, three additional fileless attacks, were added.

3. Trusted Acquisition of Volatile Memory from Linux-Based VM

Experiments were conducted in a virtual environment, where there is a separation between the guest and the host, so programs executed on the guest machine are not aware of programs executed on the host. The communication between the guest and host can be performed by the hypervisor, which manages the guest OS. The hypervisor can transfer files and shell commands from the host to the guest, enabling us to inject benign and malicious programs to the tested VM and execute them. This infrastructure allows us to use the host to acquire volatile memory dumps from the guest in a trusted manner while the guest's VM is momentarily frozen. Thus, the executed programs are unaware that they are being inspected.

Oracle Virtual box is a hosted hypervisor for software-based virtualization. It supports the creation and management of a guest VM, including Linux-based VMs. It is free software available under GNU general public license. VirtualBox is a type 2 hypervisor, which is software installed on top of an existing OS. This hypervisor relies on the host OS to manage its CPU, memory, storage, and network resources. Type 2 virtualization was used due to its main advantage and ability to use hardware accelerations managed by the guest OS, providing us with better performance. In the research, the guest VMs were Ubuntu 18.04.2 with the Linux kernel 5.0.0-37 VM hosted on Virtual box 6.0. This infrastructure allowed us to inject files into the guest VM and use command line commands to execute them in the VM. The volatile memory samples were extracted by using the VBoxManage command dumpvmcore. This command creates a system dump in the standard ELF core format. This ELF file is obtained while the VM is frozen, without the malware awareness. In this study, a validation pipeline was created by which it could be ensured that the malware is inspected as it performs its malicious activity.

To acquire the memory dumps in a trusted manner and still simulate reality as accurately as possible, the memory was acquired from the hypervisor level. Therefore, the programs executed inside the guest VM cannot reach the hypervisor or interfere with the hypervisor execution. There are sophisticated malware samples capable of detecting that they are being executed in a VM, but they cannot interfere with or shut down the hypervisor; therefore, the methodology is trusted. Moreover, if malware detects that it is in a VM, it does not attack the system, and the malicious operation is not invoked.

Two types of common servers were installed on top of the operating system and simulated their routine operation in organizations with various clients that sent requests: a hypertext transfer protocol (HTTP) server and a domain name server (DNS). For the HTTP server, an Apache HTTP server was used that performs different tasks for its users (mainly retrieving Web pages). The clients establish transmission control protocol (TCP) connections and send requests over the HTTP protocol. The server receives the request, performs the task, and responds to the client over HTTP protocol. The DNS server represents a company's DNS server or an Internet provider's DNS server. This server's primary purpose is to receive a DNS request from the client, translate the domain name to its IP address, and return the client's DNS response. Table 1 summarized the differences between the servers. In addition to the substantial differences in the servers' operations, they also differ in terms of the type of network communication used. The HTTP server communicates over transmission control protocol (TCP) at a lower rate with different packet sizes. In comparison, the DNS communicates over user datagram protocol UDP at a higher rate with small packets, meaning that the two servers will have different network values and system resource-related features.

TABLE 1
Differences between the HTTP server and the DNS server

| | HTTP Server | DNS Server |
|---|---|---|
| Transport Method | TCP | UDP |
| Packet Size | varies | Small |
| Request Rate | Lower | Higher |
| Network Cache | No | Yes |
| Framework | Apache HTTP server | customized |

In the study, the servers used had 1 GB RAM. This amount of RAM was sufficient for the server's execution with the addition of the benign or malicious sample; these applications did not require much memory, and a reasonable amount of the RAM went unused. Note that there was no research need to increase the amount of RAM, an act that will cause longer processing time of the dumps and the need for more storage space.

### 4. Memory Dump Collection

Reference is made to FIG. 8, which shows the virtualization architecture, in accordance with some embodiments of the present invention.

FIG. 8 describes the virtualization architecture used. Two new virtual machines were created with 1 GB RAM based on Ubuntu 18.04.2 with the Linux kernel 5.0.0-37. The first one served as a server and the second as the client. During execution, the client's VM simulated multiple clients that send requests to the server, and the server responded to them with response packets. A volatile memory dump acquired from the server's volatile memory every 10 seconds until 100 memory dumps were reached during the server-client execution. The first execution without any other program running is the baseline, which represents the regular functioning server. A snapshot from the VM baseline was taken, so that it will be able to roll back to the same baseline after every execution of an additional application (malicious or benign). After that, the sample was injected (malicious or benign) into the server, executed, and 100 memory dumps were acquired along with its execution. One should note that during the execution, the applications, particularly the malicious applications, demonstrate a variety of different behaviors, which are reflected in the 100 snapshots, meaning that each snapshot documents and is comprised of various traces of various behaviors. For example, ransomware starts by scanning the victim's system to find the files to encrypt (aka information gathering and reconnaissance phases). Later on, its behavior changes, and it starts the process of encrypting sensitive files; its behavior keeps changing until finally, it demands the ransom. These behavioral changes are reflected in the snapshots and create variability among the snapshots, resulting in a rich data collection that consists of 5,600 benign snapshots and 5,000 malicious snapshots for each of the inspected virtual servers.

It is possible to inject multiple applications into the server and execute them concurrently, both multiple malware and multiple benign programs. However, it was selected to inject only one application at a time in order to keep the VM environment as sterile as possible so that the volatile memory dumps would represent an execution of one application alongside the main server program; moreover, this can improve the learning capabilities of machine learning algorithms and better capture the specific behavior and traces that each type and sample of malware leaves in the volatile memory. By doing so, it was ensured that the ML classifiers can distinguish between a benign or malicious state of the server based on the granular behavioral traces of just one application, rather than on multiple combinations of additional behaviors that contain interactions and aggregations of combined behaviors.

### B. Feature Extraction

### 1. The Volatility Framework

The volatility framework is an open-source, free collection of tools implemented in Python under the General Public License (GNU) to extract digital artifacts from volatile memory samples. Due to a large number of Linux kernel versions, a specific profile for the particular kernel version used is needed. Such a profile consists of generating a set of VTypes (structure definitions) and a System.map file. In the research, a profile for Linux kernel 5.0.0-37 was created. The volatility framework uses different plugins to extract digital artifacts from the volatile memory; for example, the plugin linux_pslist extracts the active process list from the Linux memory dump.

### 2. Feature Extraction and Dataset Creation

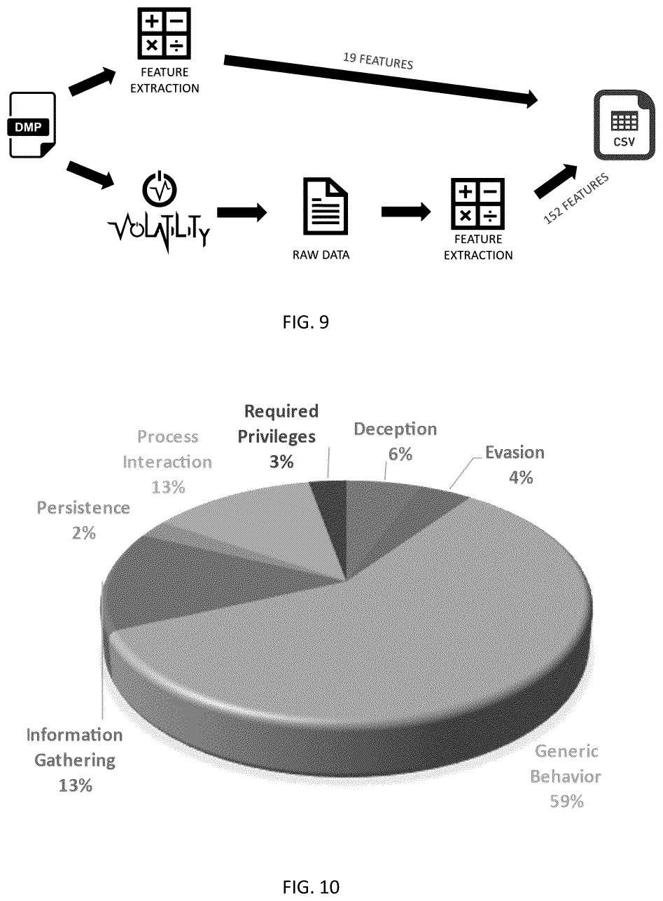

Reference is made to FIG. 9, which shows a schematic process of feature extraction and dataset creation from the volatile memory dump files, in accordance with some embodiments of the present invention.

A Python-based script that used 21 different Volatility 2.6.1 Linux plugins was developed. Table 2 presents the volatility plugins used by the feature extraction framework. The data extracted from every dump file were processed into a total of 171 knowledge-based features, like the maximum number of child processes that a process has or the number of kernel modules. Nineteen features related to the number of specific system calls in the memory were extracted directly from the memory dump. Appendix III contains a full description of all of the features. The features extracted from all of the dump files were collected and stored in a repository of CSV file format. The columns in the dataset represent the features, and the rows represent the memory dumps. FIG. 9 presents the process of extracting features from the volatile memory dump file for the creation of a database file.

TABLE 2
Volatility plugins used by the feature extraction framework

| Volatility plugin | Description |
|---|---|
| linux_pslist | Extracts the list of all active processes from the |
| | task_struct |
| linux_pstree | Extracts the parent/child relationship tree from |
| | task_struct |
| linux_bash | Recovers the bash history from memory |
| linux_proc_maps | Extracts details regarding the process memory, including |
| | heaps, stacks, and shared libraries |
| linux_check_creds | Returns a list of processes that share the cred_structure |
| linux_psaux | Extracts the list of all active processes with their command |
| | line arguments |
| linux_threads | Extracts a list of all threads of every process |
| linux_lsmod | Extracts a list of loaded kernel modules from the modules.list |
| | linked list |
| linux_check_tty | Returns a list of unhooked receive_buf functions for every |
| | active tty_driver on the system |
| linux_check_modules | Extracts a list of hidden kernel modules |
| linux_iomem | Extracts a list of physical addresses currently reserved for IO |
| | devices |
| linux_tmpfs | Extracts the list of tmpfs filesystems from the memory |
| linux_check_fop | Returns a list of files whose pointer is not in the kernel or |
| | loadable kernel module |
| linux_mount | Extracts the status of all mounted file systems in the memory |
| linux_elfs | Returns a list of ELF files in the memory |
| linux_enumerate_files | Return a list of files referenced by the file system cache |
| linux_lsof | Returns a list of file descriptors and their paths |
| linux_check_afinfo | Returns a list of modified UDP and TCP protocol data |
| | structures from file_operations and sequence_operations |
| linux_ifconfig | Extracts a list of active network interfaces |
| linux_netstat | Extracts a list of active network connections |
| linux_arp | Extracts the ARP table that contains the link layer addresses |
| | with their Internet layer addresses |

### The Proposed Features

Reference is made to FIG. 10, which shows a pie chart of features, wherein the features are grouped by the potential malicious behavior they are associated with, in accordance with some embodiments of the present invention.

FIG. 10 shows a pie chart that displays the percentage of features for each type of malicious behavior:Fifty-nine percent of the features are related to generic malware behavior; for example, the different_tcp_ports feature belongs to that category and represents different open ports for TCP connections in the memory. This feature can be indicative of a malware sample that communicates over TCP, like malware that communicates with a C&C server. Thirteen percent of the features are related to process interactions performed by malware; for example, the avg_child_per_process feature represents the average number of child processes for every process. This feature can be indicative of malware that uses multiprocessing as part of its malicious activity. An additional Thirteen percent of the features are related to information gathering that malware may perform during its execution; for example, the localtime_access feature represents the number of files from the “/etc” directory related to the local time that is loaded to the memory. This feature can indicate malware that accesses this specific configuration file as part of its information gathering. Six percent of the features are related to deception abilities that Linux malware has; for example, the empy_process_name feature represents the number of processes without a name. This feature is indicative of malware that has a process with an empty name. Four percent of the features are related to evasion abilities that some Linux malware present; for example, the nanosleep_sys_call feature represents the number of nanosleep system calls in the memory. This feature can be indicative of malware that delays its execution, invoking the nanosleep system call. Three percent of the features are related to the required privileges and can indicate malware that tries to elevate its privileges; for example, the kernel_module_amount feature represents the number of kernel modules loaded and can be indicative of malware that loads a kernel module to the kernel. Two percent of the features are related to the persistence abilities some Linux malware possess; for example, the init_child feature represents the number of child processes that the init process has and may indicate malware that managed to start at boot.

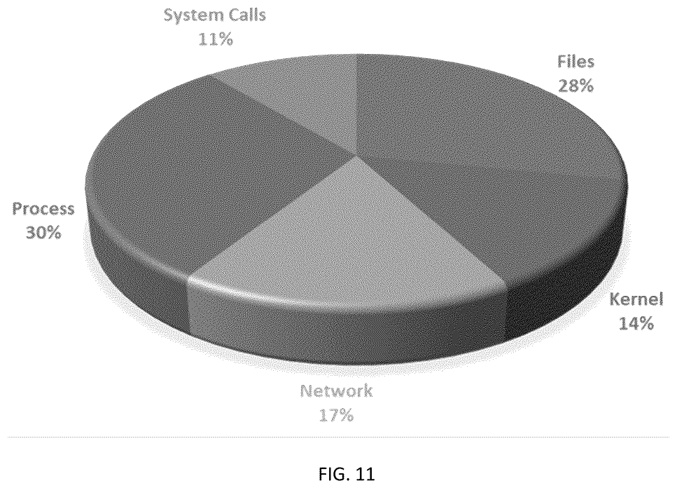

Reference is made to FIG. 11, which shows a pie chart of features, wherein the features are grouped by their source in the volatile memory, in accordance with some embodiments of the present invention.

FIG. 11 depicts a pie chart that displays the amount of features according to their source: 13% percent of the features are related to the process; for example, the threads_avg feature represents the average number of threads for every process and can be indicative of malware that uses multithreading as its malicious activity. Twenty-eight percent of the features are related to the files that are in the volatile memory; for example, the tmp_file_amount feature represents the number of temp files currently in the memory. This feature can be indicative of malware that has interactions with files. Seventeen percent of the features are related to the kernel; for example, the cpu_info_access feature represents the files from the/proc/cpuinfo directory in memory. This feature may be indicative to a malware that accesses CPU-related data structures. Fourteen percent of the features are related to network activity; for example, the tcp_conn_amount feature represents the number of active TCP connections. This feature can be indicative of malware samples that communicate through TCP connections. Eleven percent of the features are related to system calls; for example, the open_sys_call feature is related to the number of open system calls in the memory. This feature can indicate malware that invokes the open system call as part of its malicious activity.

### I. Evaluation

A. Evaluation Metrics

To evaluate the proposed feature set and the framework's detection capabilities, five different statistical measurements were used. The TPR (true positive rate (Eq 1)) measures the proportion of correctly identified positives. In this case, it measures the ratio of malicious samples that were correctly identified. The FPR (false positive rate (Eq 2)) measures the proportion of negatives incorrectly classified as positives of the total number of negatives. In this case, it measures the ratio of false alarms/false alerts, meaning benign samples that were classified as malicious. Since there is a tradeoff between the TPR and FPR, it is desired to maximize the TPR while minimizing the FPR. The IDR (integrated detection rate (Eq 3)), which integrates the FPR and TPR was used.

The AUC (area under the receiver operating characteristic curve (Eq 4)) of the different machine learning classifiers was measured, in which the true positive rate (TPR) is plotted against the false positive rate (FPR) at various threshold values ranging from zero to one to create the curve. A high AUC value is achieved with a high TPR and a low FPR. The fifth measurement is the accuracy (Eq 5), which measures the proportion of correct predictions, malicious or benign, among the total number of cases examined.

$$TPR = \frac{TP}{TP + FN} \qquad ( 1 )$$

$$FPR = \frac{FP}{FP + TN} \qquad ( 2 )$$

$$IDR = TPR * ( 1 - FPR ) \qquad ( 3 )$$

$$AUC = {\int }_{X = 0}^{1} TPR ( {FPR}^{- 1} ( X ) ) dx \qquad ( 4 )$$

$$Accuracy = \frac{TP + TN}{TP + TN + FP + FN} \qquad ( 5 )$$

B. Machine Learning Algorithms

In each experiment performed, seven diverse ML algorithms were used to test the detection capability. Each algorithm differs from the others regarding the principles and the theories it is based on and the training and classifying methods used. The seven algorithms are: Naïve Bayes classifier—a probabilistic classifier based on applying Bayes' theorem with strong (naïve) independence assumptions between the features. More specifically, the classifier assumes that a particular feature's value is independent of any other feature's value, given the class variable. Logistic regression—a statistical model that uses a logistic function to model a dependent variable. The algorithm creates a linear combination of the independent variables and provides classification decisions rather than the specific predicted value. Support vector machines (SVM)—an algorithm that makes a representation of the examples as points in space and finds the optimal separating hyperplane (with a maximum margin) that well divides the examples of separate categories. SVM usually uses kernel functions and maps the examples in a higher dimensional space to cope with nonlinear separable data. New examples in the test set are mapped to the same higher space and predicted to belong to a category based on the side of the separating plain where they are found. K-nearest neighbors (KNN)—a pattern recognition algorithm that maps the examples into points in space and predicts the new examples in the test set using plurality voting between the k closest neighbors to that point (e.g., most similar based on a predefined similarity measurement). This algorithm does not induce a model but applies a “lazy” strategy of similarity calculation for each new unseen sample. Random forest—an ensemble learning method that consists of constructing different decision trees from randomly selected features in the training phase; the final decision is based on a voting strategy. All of the subtrees classify new examples in the test set, and a voting strategy calculates the final decision. Artificial neural networks (ANNs)—a model inspired by biological neural networks. It consists of a network of interconnected neuron nodes that process numerical input information and produces classification or prediction outputs. In the training phase, the neural network attempts to learn about the presented information by updating the weights between the neurons in the network to minimize the error. It produces the output by recognizing patterns in the data and adjusting itself according to the network output compare to the desired result. Deep neural networks (DNNs)—a model based on artificial neural networks, with multiple hidden layers between the input and output layer. In the study, a DNN architecture that included 33 hidden layers was used. This architecture was chosen, because it has been proven effective in the task of malware detection based on knowledge-based features.

Table 3 presents the parameters for each of the ML algorithms and the values used to perform the tuning.

TABLE 3
Parameters and the different values used to tune the machine learning algorithms

| Algorithm | Parameter | Description | Parameter Values Examined |
|---|---|---|---|
| LR | Solver | Used in the | {newton-cg, lbfgs, liblinear, sag, |
| | | optimization | saga} |
| | | problem | |
| | C | Inverse of | {0.001, 0.01, 0.1, 1, 5, 10, 15, 20, |
| | | regularization | 25, 30, 40, 50, 60, 70, 80} |
| | | strength | |
| SVM | kernel | Specifies the | {linear, poly, rbf, sigmoid} |
| | | kernel type to | |
| | | be used in the | |
| | | algorithm | |
| | gamma | Kernel | {1/(n_features * X.var( )), 1/ |
| | | coefficient | n_features} |
| | C | Regularization | {0.001, 0.01, 0.1, 1, 5, 10, 15, 20, |
| | | parameter | 25, 30, 45, 50, 100, 500, 750, 800, |
| | | | 1000, 10000} |
| KNN | n_neighbors | Number of | {3, 5, 7, 9, 11, 13, 15, 17, 19, |
| | | neighbors to | 21, 23.25} |
| | | use | |
| | metric | The distance | {manhattan, euclidean} |
| | | metric to use | |
| RF | n_estimators | The number of | {1, 5, 10, 15, 20, 25, 30, 40, 50, 75, |
| | | trees in the | 100, 150, 250, 300, 500, 1000, |
| | | forest | 2000, 2500, 3333, 5000, 7500, |
| | | | 10000} |
| | criterion | The function | {gini, entropy} |
| | | to measure the | |
| | | quality of a | |
| | | split | |
| | min_samples_split | The minimum | {0, 10, 20, 30, 40. 50} |
| | | number of | |
| | | samples | |
| | | required to | |
| | | split an | |
| | | internal node | |
| | max_features | The number of | {5, 10, 15, 20, 25, 30} |
| | | features to | |
| | | consider when | |
| | | looking for the | |
| | | best split | |
| ANN | activation | Specifies the | {relu, sigmoid, tanh} |
| | | neuron | |
| | | activation | |
| | | function type | |
| | | to use | |
| | units | Amount of | {0.25 * n_features, |
| | | neuron in the | 0.5*n_features, 0.75* n_features, |
| | | layer | n_features, 1.5*n_features, |
| | | | 2*n_features, 4*n_features, |
| | | | 8*n_features} |
| | optimizer | The | {SGD, Adagrad, Adam} |
| | | optimization | |
| | | algorithm | |
| | epoch | Number of | {1, 5, 10, 15, 20, 25, 50, 75, 100, |
| | | passes over | 200} |
| | | the entire | |
| | | dataset | |
| | Batch | Defines the | {1, 5, 10, 15, 20, 25, 50, 75, 100, |
| | | number of | 200} |
| | | samples | |
| | | propagated | |
| | | through the | |
| | | network. | |
| DNN | epoch | Number of | {1, 5, 10, 15, 20, 25, 50, 75, 100, |
| | | passes over | 200} |
| | | the entire | |
| | | dataset | |
| | Batch | Defines the | {1, 5, 10, 15, 20, 25, 50, 75, 100, |
| | | number of | 200} |
| | | samples | |
| | | propagated | |
| | | through the | |
| | | network. | |

C. Experimental Design

The overall experimental design is aimed at performing an extensive and comprehensive evaluation of the proposed framework, using different machine learning algorithms, to perform effective (high TPRs and low FPRs) malware detection on a Linux-based virtual server. To better assess the framework's generalization, all of the experiments were conducted on the two abovementioned Linux servers: the DNS and HTTP servers. The ML algorithms mentioned above were used to induce detectors, in order to evaluate the detection capabilities in all of the experiments.

### 1. Experiment 1—Known Malware Detection

This experiment evaluates the framework's ability to distinguish between two states of the server, infected by malware or not (only benign applications are executed). Each classifier was trained in a standard 10-fold cross-validation setup, meaning that the test set included some dumps representing malware behavior, while other dumps (with other behaviors) representing the same malware were included in the training set. Thus, the dumps in the test set are considered as dumps from malware samples which are already known to the classifiers. Note that a single dump detection mode was applied in which the decision regarding maliciousness is based solely on the classification of the single dump examined. This basic experiment serves as a “sanity check” to understand whether or not the framework has the basic ability to detect known malware when different dumps with different behaviors from the same malware exist in the training set.

### 2. Experiment 2—Unknown Malware Detection

This experiment aims at evaluating the framework's ability to identify whether or not a virtual server was infected by unknown malware. To ensure that the test set consists of unknown samples only, the dataset was randomly divide by excluding all of the 100 dumps of eight benign samples and eight malicious samples so that these 16 samples along with their 1,600 dumps served as the test set, while the remaining 90 samples along with their 9,000 dumps served as the training set. Each such random division is considered a single fold (repetition), and the exclusion, random division, and evaluation processes were repeated 10 times, and in each repetition, there was a different sample combination in the training and test sets. To reduce any variance that might stem from the dataset's random division, it was ensured that every malware sample appeared in the test set at least once. Note that the malware samples in the test set are from various malware categories—in this way, the test set will represent the diversity of malicious behavior demonstrated by the different malware categories, as exists in the wild. Here a single dump detection mode (in which the sequence of dumps of the same malware was not considered when making a final decision regarding the examined sample; every dump of the sample was classified independently) was applied. The ability to improve detection rates in a multi-dump mode where the n-first dumps were considered was applied. In this mode, the training set remained the same, however in the testing phase, instead of making a final decision for every dump independently, it was provided a final classification decision based on a voting strategy among the classification decisions of the n-first dumps. The main idea that lies at the core of the n-first dumps mode (AKA multi-dump mode) derives from the fact that some malware samples are known to change their behavior during execution and might have different kinds of behaviors, such that basing the detection on just a single dump could lead to inaccurate results. Ransomware, for example, has different behavior and various steps during its execution: it scans the victimized system and looks for files (documents and information) to encrypt, then it handles the files (so it can later encrypt them) and starts encrypting the files, and eventually, it demands the ransom. Other sophisticated malware samples can halt or delay their malicious actions in order to evade detection or while waiting for commands from their command and control (C&C) server. In those cases, some of the dumps taken during the execution of the malware may have benign characteristics or significantly different malicious characteristics than other dumps associated with the same behavior of the examined malware sample. Thus, the n-first detection mode should be more robust because instead of considering just a single dump, this mode considers a series of dumps associated with a variety of malicious behaviors of the malware; thus, reducing the chances of incorrectly classifying the malware as benign because of a specific dump that did not contain any malicious indications. In the study, the memory dumps were extracted at the same time that the malware was executed, however since volatile memory dumps are acquired from the VM sequentially with multiple dumps (100) with a 10 second delay between them, the chance of obtaining more dumps that contain malicious activity increase. In a real live implementation of this mode, the dump series can be taken using a sliding window method, and in a constant manner over time, regardless of the time the malware is executed; thus, at any given time, the method can provide a better detection decision, as the decision is not based on just a single dump. Once malware starts exhibiting its malicious behavior, it is be documented in a series of multiple dumps, a series that will be analyzed and detected by the proposed multi-dump mode.

### 3. Experiment 3—Unknown Malware Category Detection

In this experiment, the ability of the framework to identify whether or not a virtual server was infected by unknown malware from an unknown category was tested. To do so, an entire malware category was excluded from the training set, meaning that all 100 dumps of each sample belonging to the particular malware category wanted to be excluded, and they served as the test set. The memory dumps of the other malware categories along with randomly selected benign samples were used in the training set. The number of benign samples in the test set matched the number of malware samples in the excluded category in order to avoid any bias that might stem from an imbalanced test set. This execution was repeated eight times, which is equal to the number of different malware categories in the data collection, so that each time a different malware category was excluded and used as part of the test set and served as the unknown category. Then, the results were averaged across the eight repetitions. This method aims to evaluate ML algorithms' ability, when trained on the proposed feature set, to detect unknown malware of an unknown category. Such a capability is vital to coping with new malware trends and phenomena; in this experiment, a weighted mean according to the category size was used; for example, 12 cryptominers were present, so their weight is 12/50 of the total TPR, FPR, and the other measurements. In addition, the ability to improve detection rates in the same n-first dumps mode mentioned above was examined.

### 4. Experiment 4—Malware Categorization

This experiment evaluates the framework's ability to distinguish between various malware categories. Such an experiment is essential for identifying the type of attack performed and allows an organization's security team to respond appropriately and mitigate an attack and minimize its potential damage. The dataset used consisted of only malware samples. Each classifier was trained in a standard 10-fold cross-validation setup.

### 5. Experiment 5—Feature Selection and its Impact on the Generalization Capabilities

In this experiment, two feature selection approaches were implemented to determine the most relevant features for unknown malware detection. In order to be able to compare the results to experiment two, the same format and division of training and testing sets is as was used in experiment two. The first feature selection method used rates a feature by its information gain value. The information gain is the Kullback-Leibler divergence, which measures the amount of information gained about a random variable by observing another variable. The second method rates the feature by its Fisher score. In this method, the features are selected by calculating the difference of the mean of the malicious samples and the benign samples, divided by the sum of their standard deviation, for every feature. After ranking the entire feature set, the top 100 features obtained by each method were selected.

An iterative process of feature elimination and model evaluation over the same unknown test sets used in the second experiment was performed. To avoid convergence to a local optimum and finding the global that maximizes the IDR, features from the feature set (based on the ranking each feature received by the feature selection method) were eliminated until a minimal set of five features (to exhaust the feature list) was reached and ultimately the feature set with the best performance based on the IDR was selected. The model was evaluated by the IDR measure because the primary goal is to detect malware with the highest performance (maximum TPR) with a minimal amount of false alarms (minimum FPR). Note that the IDR helps identifying the point where the tradeoff between the TPR and the FPR is optimal, which cannot be deduced from the popular F-measure.

### 6. Experiment 6—Malware Detection on Unknown Linux Server

This experiment evaluates the proposed framework's ability to detect malware on unknown Linux servers that the classifiers were not trained on. The classifiers were trained on a different Linux server. More specifically, in this experiment, the training set consisted of all of the data from one server (benign and malicious), and the test set consisted of all of the data from the other server. The experiment was repeated twice. First, training was performed on the DNS data and then tested on the HTTP server, and then trained on the HTTP data and tested on the DNS server. Such an experiment is of great importance since success in detecting unknown malware in an unknown Linux server can demonstrate the generalization capability of the framework and its ability to serve as a detection mechanism for both unknown servers and unknown malware. It can also shed additional light on the feature set extracted from the volatile memory dumps.

7. Experiment 7—Coping with Fileless Attacks on the Server

In this experiment, the proposed detection framework's detection abilities in the task of detecting fileless attacks aimed at virtual servers was tested. Volatile memory dumps from the server were extracted while carrying out several types of fileless attacks that are unknown and have not been presented to the framework before. Note that the malicious data collection did not include any samples from fileless-based attacks (which are becoming more and more common), and thus this experiment is very challenging; a demonstration of the framework's ability to detect such attacks in this experiment would be a testament of its detection and generalization capabilities.

Moreover, since it is unclear how a fileless attack is reflected in the virtual server's volatile memory, a malware-based attack may have traces in the volatile memory that can be predictive for detecting fileless attack traces. This experiment investigates the robustness of the feature set extracted from the volatile memory. To thoroughly evaluate the abovementioned capability, three different widespread and dangerous fileless attacks that can cause severe damage in cloud environments were considered: (1) the first attack carried out was DNS spoofing, San attack that is conducted by gaining man-in-the-middle access between the client and server using ARP (Address Resolution Protocol) spoofing and responding to the client's DNS requests with different IP addresses (most of the time to addresses where malware can be downloaded); (2) the second type of attack is a DDoS attack against the virtual server. In this type of attack, the server is bombarded with requests (either TCP or UDP, based on the compromised DNS or HTTP server), preventing the server from providing its services to the clients. For the DNS server, the default DNS port 53 was targeted, and for the HTTP server, the default HTTP port 80 was targeted; (3) the third type of attack is a fileless crypto-miner, in which the malicious mining code is executed in the targeted virtual server through a web browser executing the malicious code in JavaScript (and not by a malicious file in the server).

For every fileless malicious attack, the testing process was repeated 10 times, and each time the 100 dumps of both the fileless sample and one randomly selected benign sample were used for the test set, while all the other samples were used as the training set. In total, this process was repeated three times (once for each of the different fileless attacks). The results were averaged for each fileless malicious attack separately so as to reduce any variance that might stem from the random division of the dataset.

### D. Results

### 1. Results of Experiment 1—Known Malware Detection

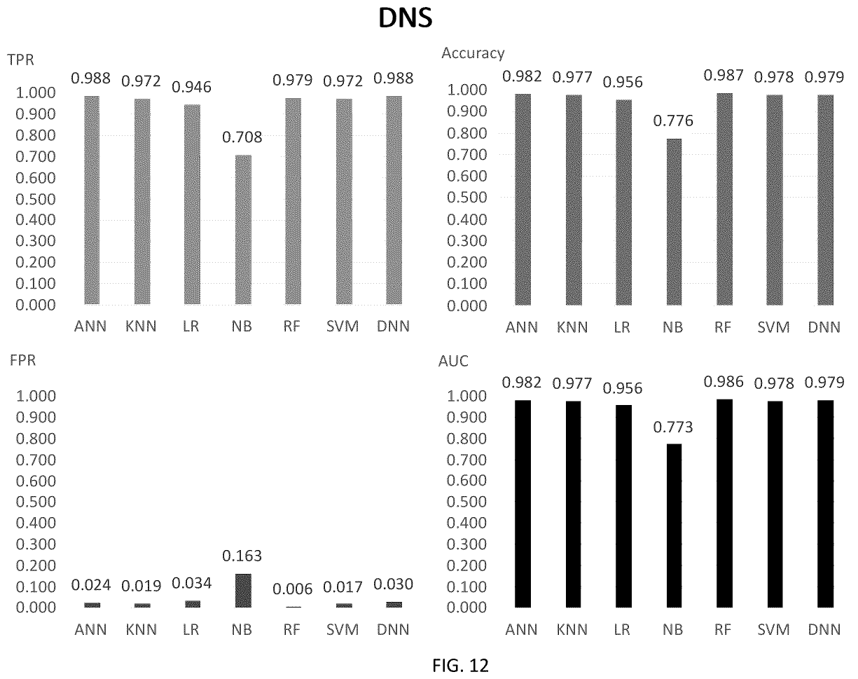

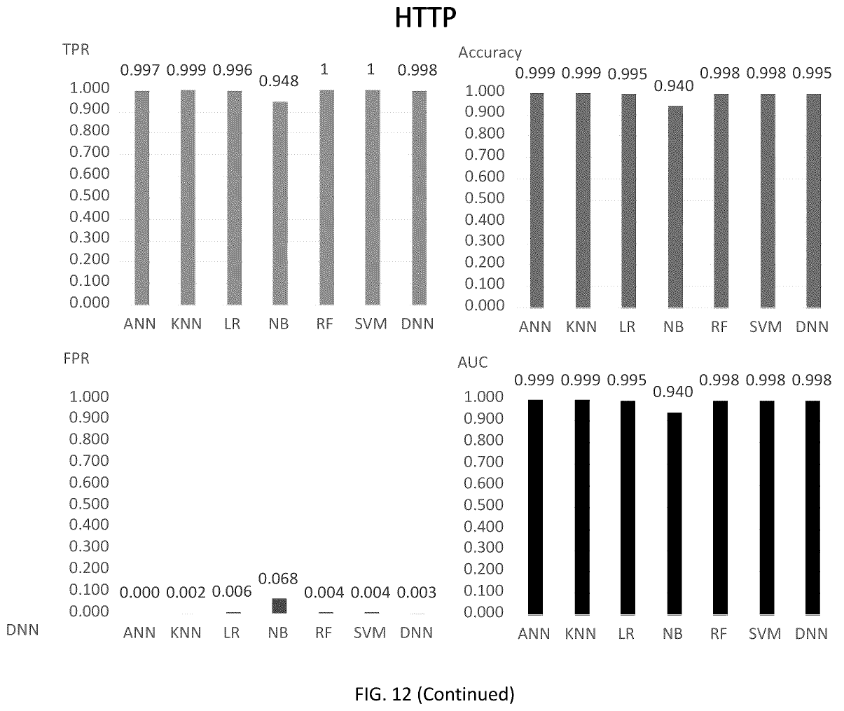

Reference is made to FIG. 12, which shows bar graphs of the detection capabilities of the classifiers for all of the samples, in accordance with some embodiments of the present invention.

FIG. 12 presents the ML classifiers' detection capabilities. For the DNS server, TPR=0.988 was achieved with both DNN and ANN. However, the ANN achieved a lower FPR of 0.024. The lowest FPR of 0.006 was achieved with an RF of 100 trees. Overall, the RF achieved the highest IDR of 0.973. The highest TPR of one was obtained for the HTTP server with an RF classifier with 15 trees and an SVM with an RBF kernel. Moreover, the lowest FPR of zero was achieved with an ANN. However, the highest IDR of 0.9972 was achieved with a KNN algorithm with three neighbors.

This experiment's results show that by leveraging malicious behavior traces from the volatile memory using ML methods, it is possible to perform trusted known malware detection on both servers.

### 2. Results of Experiment 2—Unknown Malware Detection

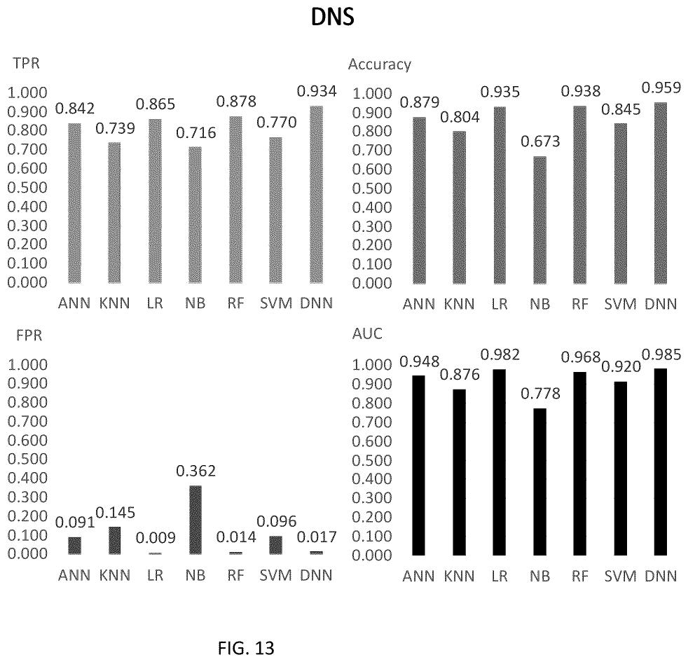

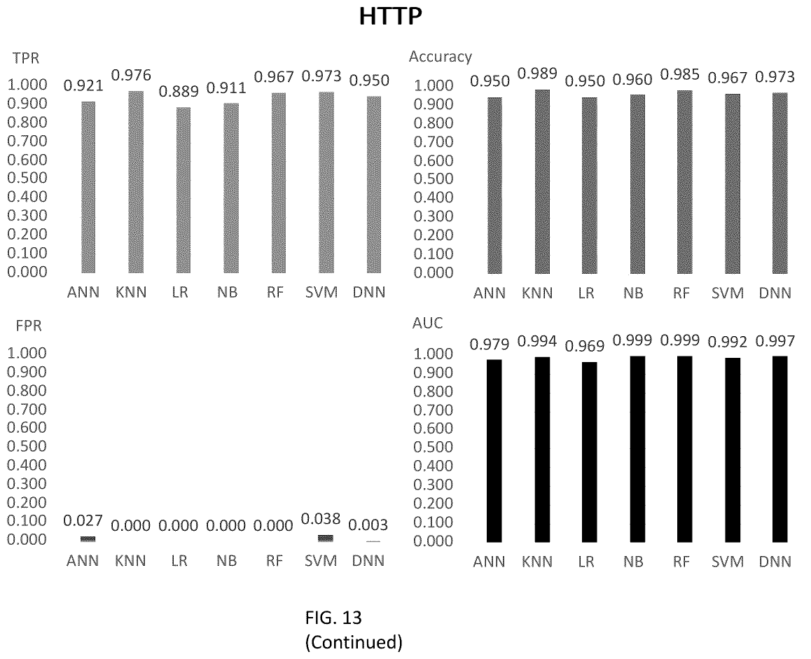

Reference is made to FIG. 13, which shows bar graphs of unknown malware detection capabilities of the classifiers on the DNS and HTTP virtual servers, in accordance with some embodiments of the present invention.

FIG. 13 presents the ML classifiers' ability to detect whether a virtual server was infected by unknown malware. For the DNS server, the highest TPR of 0.934 was achieved by the DNN. However, the lowest FPR of 0.009 was achieved by the LR classifier with an LBGS solver. Overall, the highest IDR of 0.918 was achieved by the DNN. The best results of TPR=0.976, FPR=0, and IDR=0.976 were obtained using a KNN classifier with nine neighbors for the HTTP server.

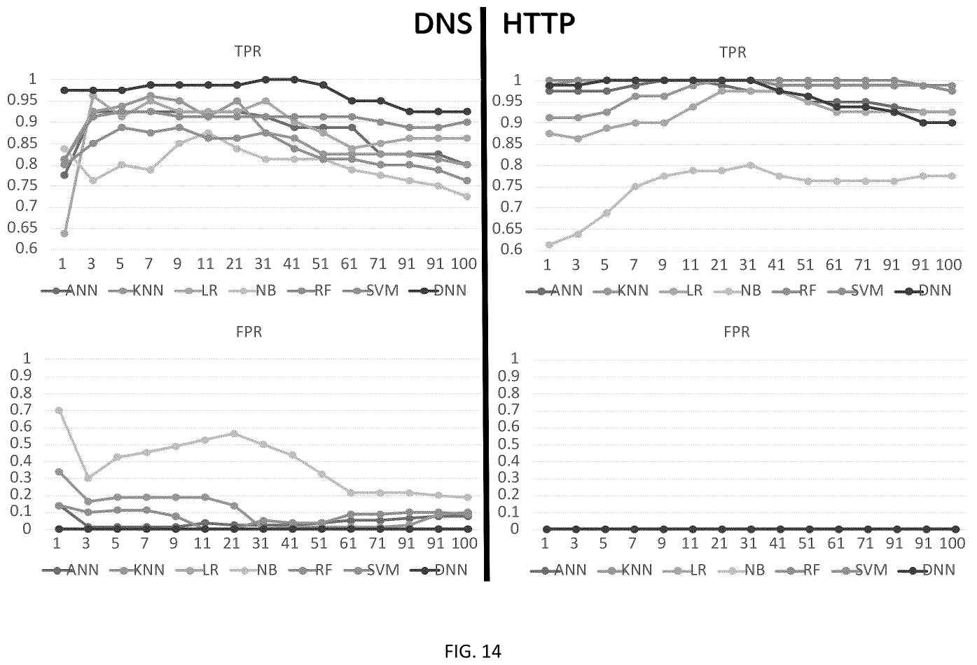

Reference is made to FIG. 14, which shows graphs of unknown malware detection capabilities as a function of the number of dumps analyzed in the testing phase, in accordance with some embodiments of the present invention.

FIG. 14 presents the n-first dumps' unknown malware detection mode results, where the X-axis represents the first n-first memory dumps. For the DNS server, the best results of TPR=1, FPR=0 were achieved by the DNN for the first 31 dumps. For the HTTP server, a TPR=1 was achieved with five classifiers: RF for the first dump, SVM for the first three dumps, DNN for the first five dumps, ANN for the first nine dumps, and KNN for the 21 first dumps. An FPR=0 was achieved with all of the classifiers. This experiment's results show that by leveraging malicious behavior traces from the volatile memory using ML methods, it is possible to perform trusted unknown malware detection in both servers and that a multi-dump detection mode can improve the detection results.

### 3. Results of Experiment 3—Unknown Malware Category Detection

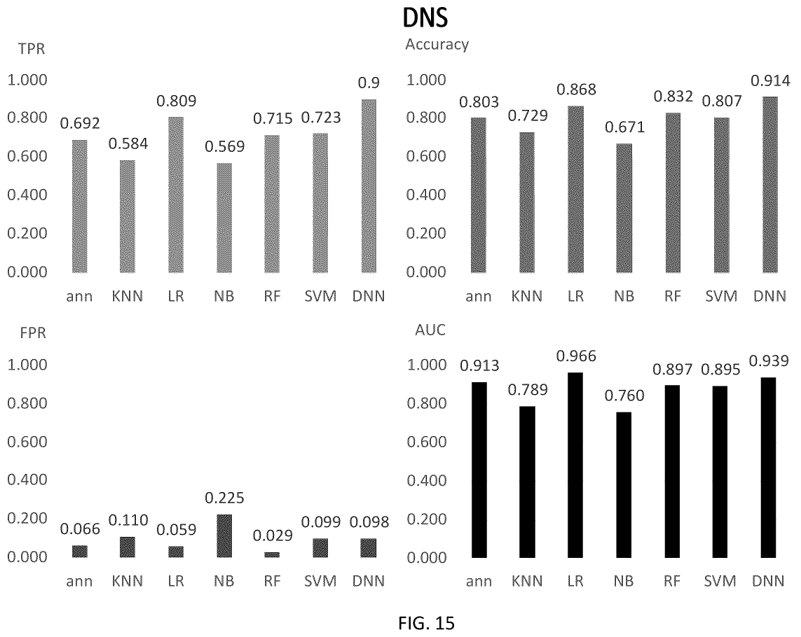

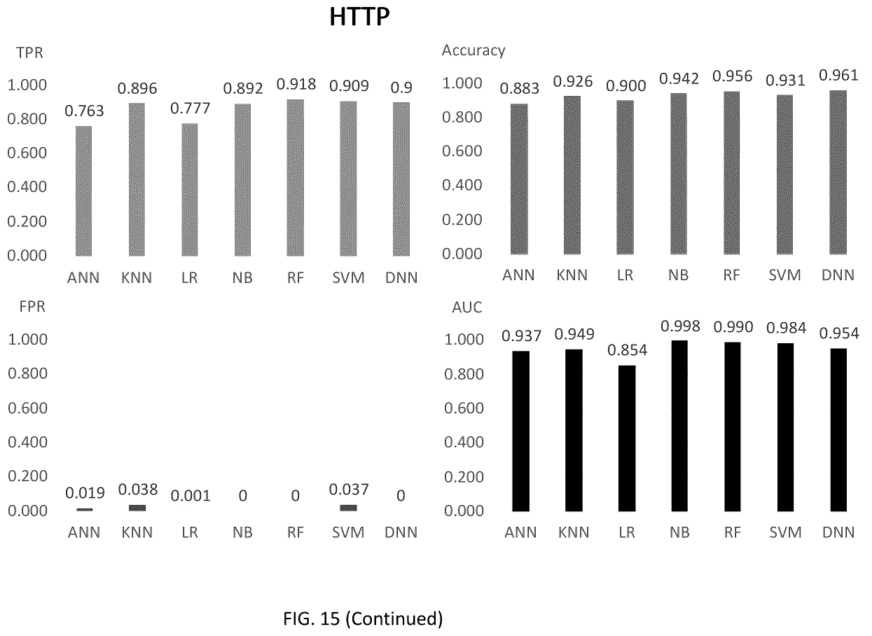

Reference is made to FIG. 15, which shows graphs of unknown malware category detection capabilities of the classifiers, in accordance with some embodiments of the present invention.

FIG. 15 presents the machine learning (ML) classifiers' ability to detect unknown malware categories on the two examined servers. For the DNS server, the best result of TPR=0.9 was achieved with the DNN. However, the best FPR of 0.029 was obtained with an RF classifier. Overall, the DNN achieved the highest IDR of 0.812. For the HTTP server, the best results of TPR=0.918, FPR=0, and IDR=0.918 were achieved by the RF classifier.

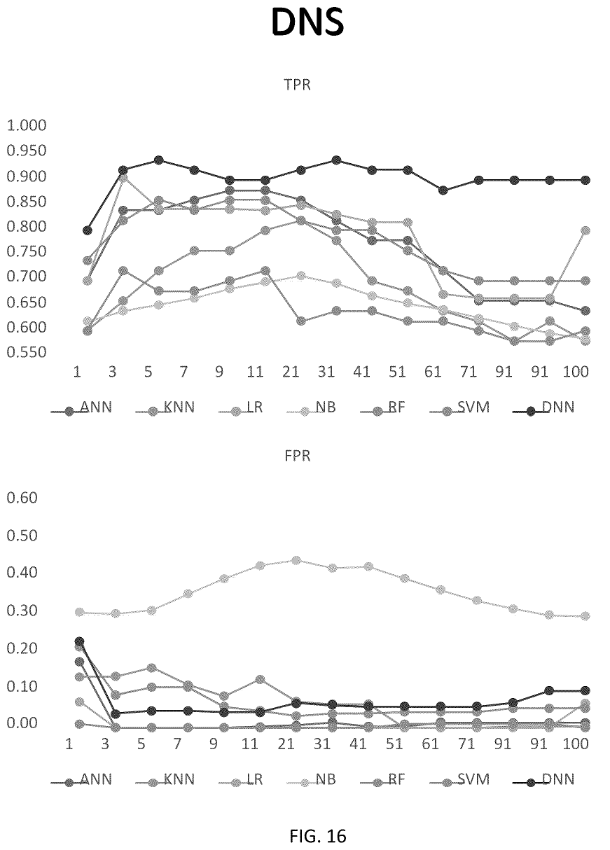

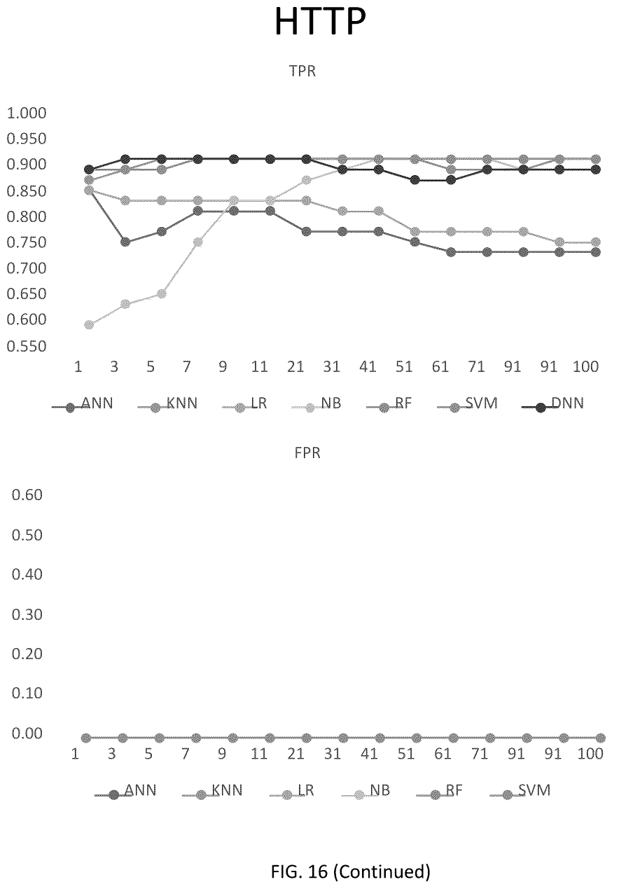

Reference is made to FIG. 16, which shows graphs of unknown malware category detection capabilities as a function of the number of dumps analyzed in the testing phase, in accordance with some embodiments of the present invention.

FIG. 16 presents the n-first dumps' unknown malware detection mode results, where the X-axis represents the first n-first dumps. For the DNS server, the best results of TPR=0.94 and FPR=0.044 were achieved by the DNN classifier for classifying the first five dumps. For the HTTP server, the best result of a TPR=0.92 was achieved with five different classifiers: DNN for the first three dumps, RF for the first five dumps, KNN and SVM for the first seven dumps, and NB for the 41 first dumps. An FPR=0 was achieved with all of the classifiers. This experiment's results show that it is possible to detect malware from an unknown category by leveraging the proposed feature set with ML algorithms and that a multi-dump detection mode can improve the detection results.

### 4. Results of Experiment 4—Malware Categorization

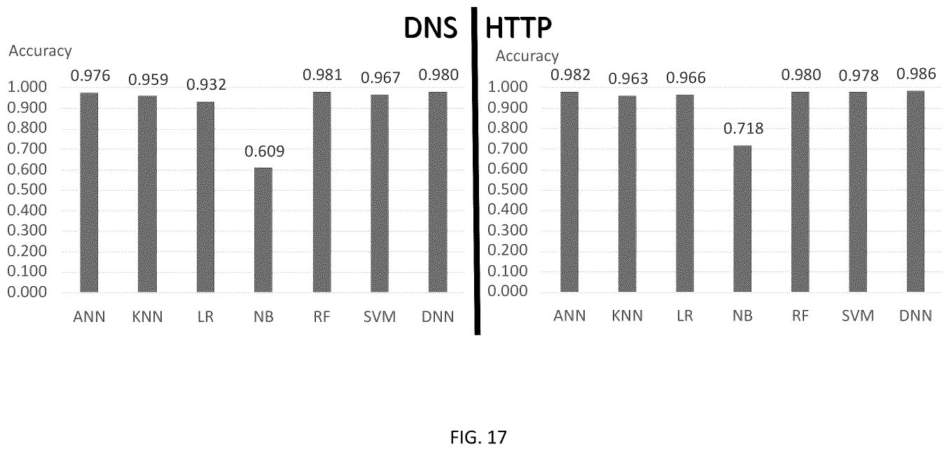

Reference is made to FIG. 17, which shows bar graphs of detection of specific malware category, in accordance with some embodiments of the present invention.

FIG. 17 presents the classifiers' detection capabilities for the task of detecting the specific category of malware on the DNS and HTTP servers. The FPR and TPR measurements are more relevant for binary classification than the other measurements used in this study. So, in this experiment, evaluated was the categorization capabilities using the accuracy measurement. For the DNS server, the best result of an ACC=0.981 was achieved with an RF classifier with 15 trees. For the HTTP server, the best result, ACC=0.982, was acquired with an ANN classifier with the same configuration used in the second experiment. The results clearly show that it is possible to perform trusted and accurate malware categorization.

### 5. Results of Experiment 5—Feature Selection and its Impact on the Generalization Capability

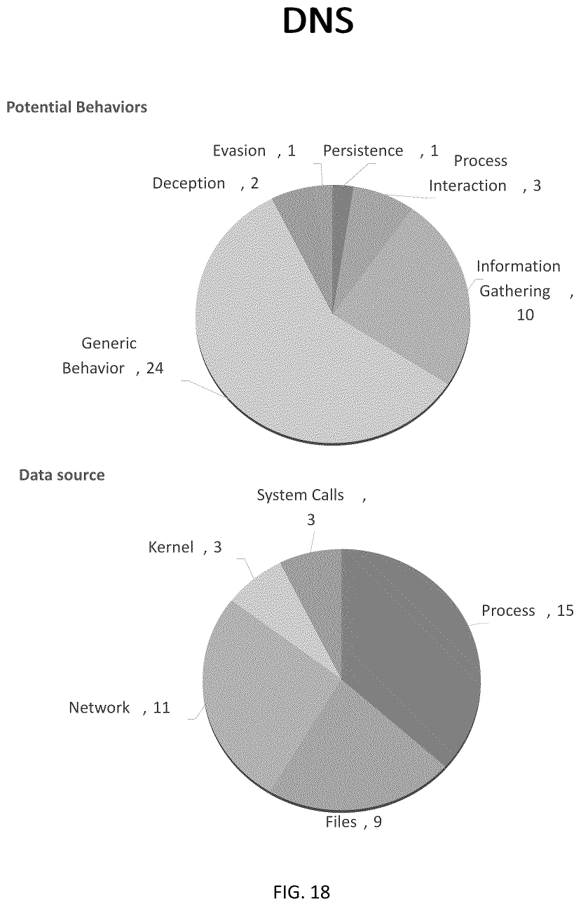

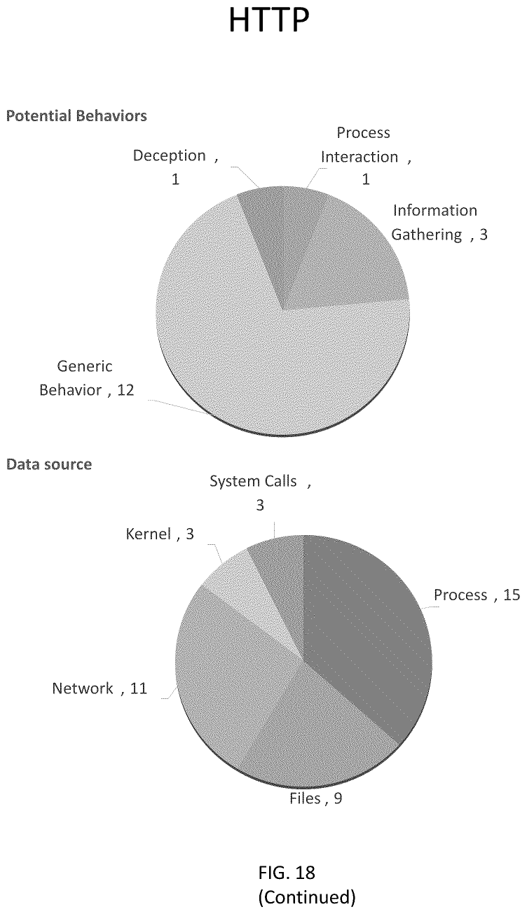

Reference is made to FIG. 18, which shows pie charts of feature distributions according to data source and potential behaviors, in accordance with some embodiments of the present invention.

In this section, exemplary feature selection method and set of features that yielded the best detection performance are presented. For the DNS server, it was a Fisher score with 26 features, and for the HTTP server, it was a Fisher score with 17 features. Four features are the same for the DNS server and the HTTP server, and the rest are different. FIG. 18 presents the feature distribution according to the potential malicious behaviors and the data source. As can be seen, the resulting feature sets consist of different behaviors and different data sources, a fact that enhances the ability to detect various types of malware with different behaviors. The DNS result yielded a more robust feature set consisting of features related to more data sources and malicious behaviors.

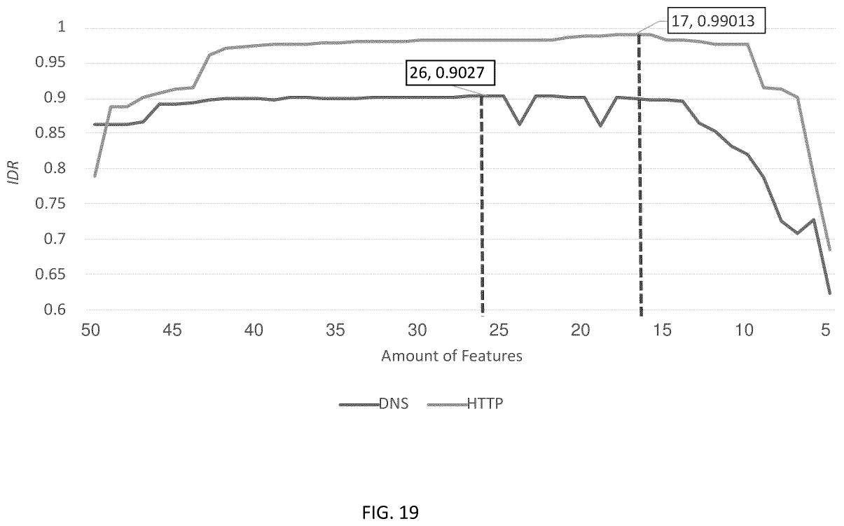

Reference is made to FIG. 19, which shows IDR values for different feature amounts, of Experiment 5, in accordance with some embodiments of the present invention.

FIG. 19 presents the IDR values for different amounts of features (X-axis) and the number of features and their associated results, showing that optimal detection results were achieved with the RF classifier, which outperformed the others.

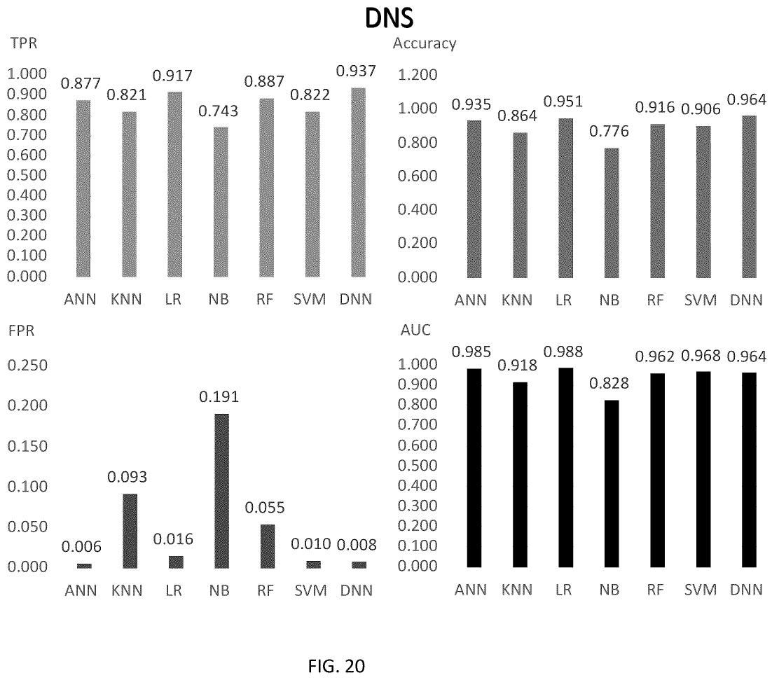

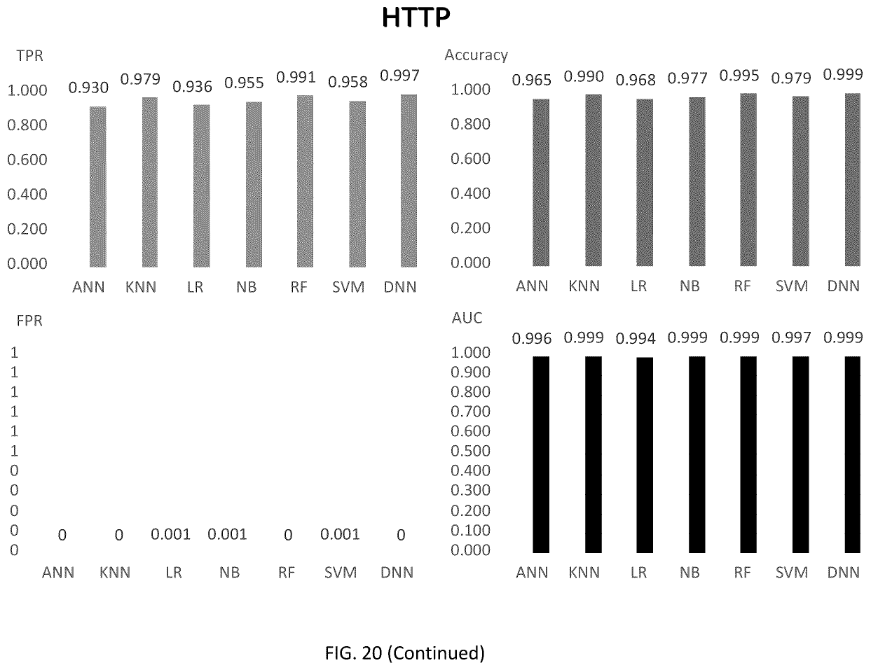

Reference is made to FIG. 20, which shows bar graphs of unknown malware detection capabilities of the classifiers using a compact set of features, in accordance with some embodiments of the present invention.

FIG. 20 shows the classifiers' detection capabilities for the detection of unknown malware when the smaller set of optimal features identified was used. For the DNS server, the best TPR of 0.937 was achieved using the DNN, a minor improvement of 0.003 from the DNN's TPR obtained in the second experiment, with a lower FPR of 0.008. The lowest FPR of 0.006 was achieved with an ANN classifier. However, the highest IDR of 0.929 was achieved with the DNN. The best results were achieved for the HTTP server with the DNN (TPR=0.999, FPR=0, and IDR=0.99). Comparing these results to the best results achieved in experiment 2 shows an improvement of 0.015 in the TPR obtained, with the same FPR.

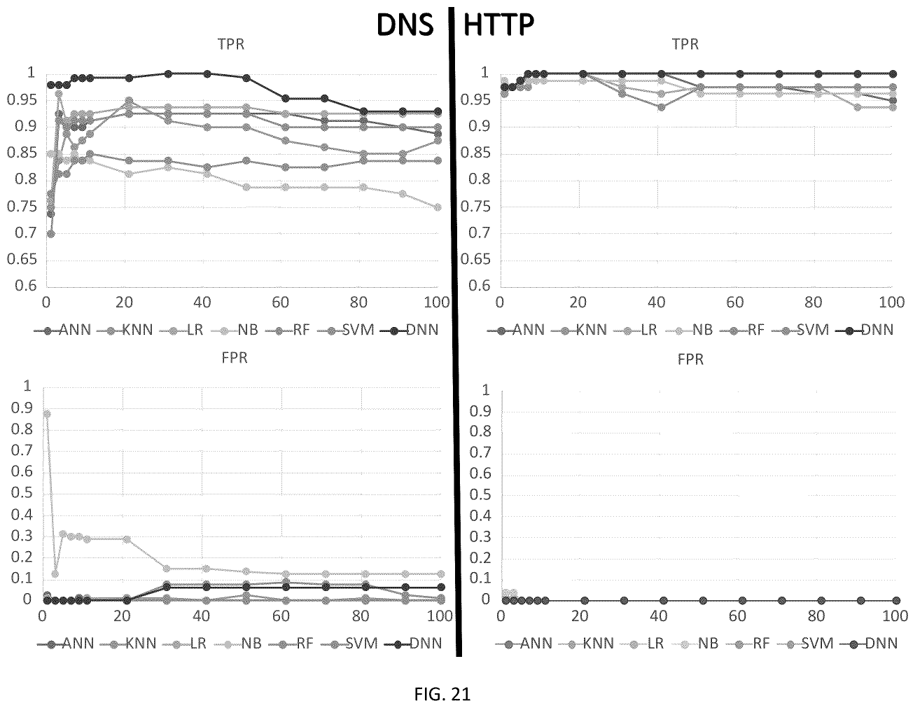

Reference is made to FIG. 21, which shows graphs of unknown malware detection capabilities of the classifiers as a function of the number of analyzed dumps analyzed in the testing phase, in accordance with some embodiments of the present invention.

FIG. 21 presents the n-first dumps' unknown malware detection mode results, where the x-axis represents the first n-first snapshots. For the DNS server, the best results of TPR=1, FPR=0, and IDR=1 were achieved with the DNN for the first 31 dumps. The same results were achieved in the second experiment. For the HTTP server, the best results of TPR=1 and FPR=0 were achieved with six different classifiers: LR, RF, ANN, DNN, and SVM for the first seven dumps, and KNN for the first nine dumps. All of the classifiers achieved an FPR=0. Compared to the second experiment, fewer dumps are required for accurate detection. Table 4 summarizes all of the improvements achieved using the compact set of features. A zero value in the table means that there was no improvement, while a negative value indicates a decrease in performance (the opposite of improvement). All in all, as can be seen, the detection capabilities remained more or less the same both for the entire set of features (171) and the compact set (17 for HTTP and 26 for DNS), however the main contribution of the results achieved in this experiment is related to the fact that is was able to significantly reduce the number of features required for accurate unknown malware detection, thus also reducing the time required for feature' extraction, which affects the applicability of the framework.

TABLE 4
Performance improvement due to feature selection

| | Selected | TPR | FPR | IDR |
|---|---|---|---|---|
| Server | features | Improvement | Improvement | Improvement |
| DNS | 26 | 0.003 | −0.009 | 0.011 |
| HTTP | 17 | 0.015 | 0 | 0.015 |

### 6. Experiment 6—Unknown Malware Detection on Unknown Linux Server

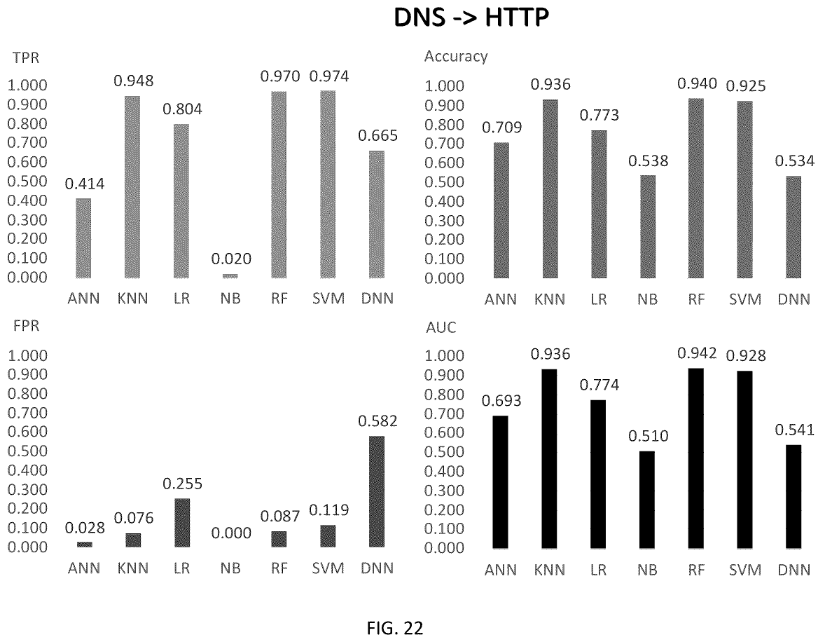

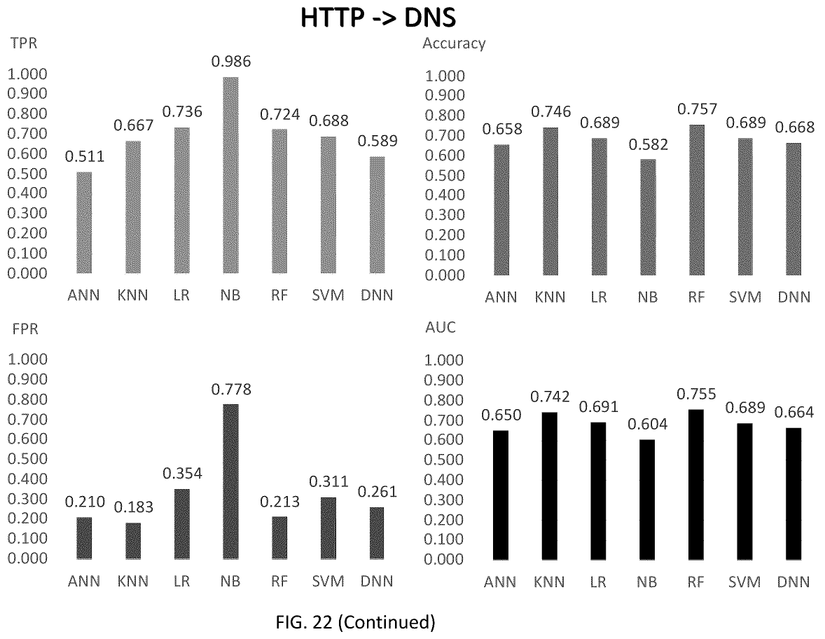

Reference is made to FIG. 22, which shows bar graphs of unknown malware detection capabilities on an unknown server, in accordance with some embodiments of the present invention.

FIG. 22 presents the ability of the ML algorithms that were trained on one server to detect malware on the other server. When training was performed on the DNS server and tested on the HTTP, using the optimal feature set for the DNS server obtained in the fifth experiment, the best results of TPR=0.97, FPR=0.087, and IDR=0.886 were achieved with an RF classifier with five trees. However, in the opposite case, when the training was done on the HTTP server, and testing was done on the DNS server, using the optimal feature set for the HTTP server that was obtained in the fifth experiment, although the NB achieved a TPR=0.986, it had a high FPR of 0.778—so overall, it did not perform well (IDR=0.219). Better results were achieved with an RF classifier with 30 trees −TPR=0.724, FPR=0.213, and IDR=0.57.

Despite the differences in the results, this experiment shows that it is possible to perform transfer learning from one server to the other and perform trusted malware detection. Better performance was obtained when transferring from the DNS to the HTTP; this finding can be explained, and as was presented in the fifth experiment, the DNS server yields a more robust feature set, which consists of features from more parts of the volatile memory and more behaviors.

7. Results of Experiment 7—Coping with Fileless Attacks on the Server

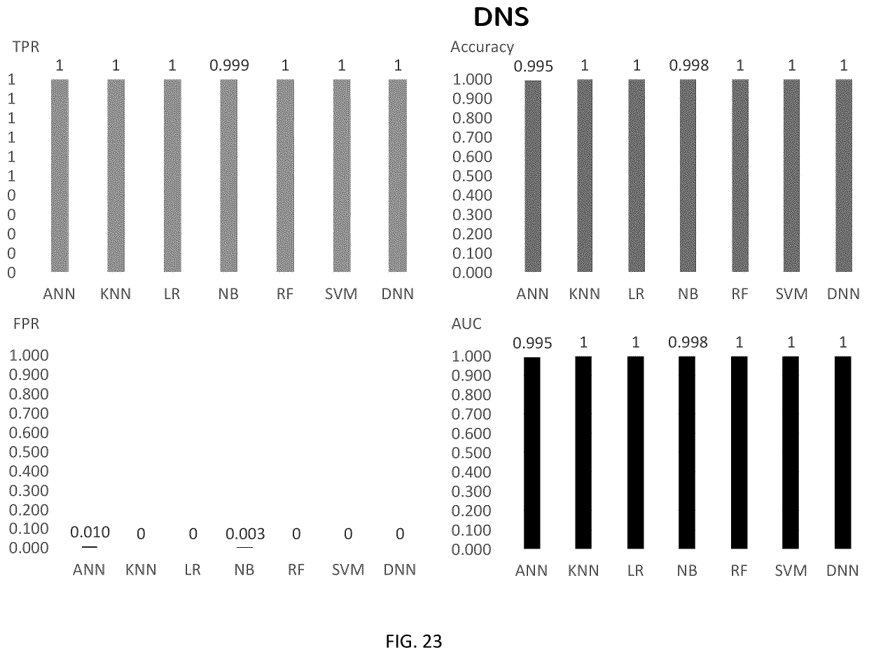

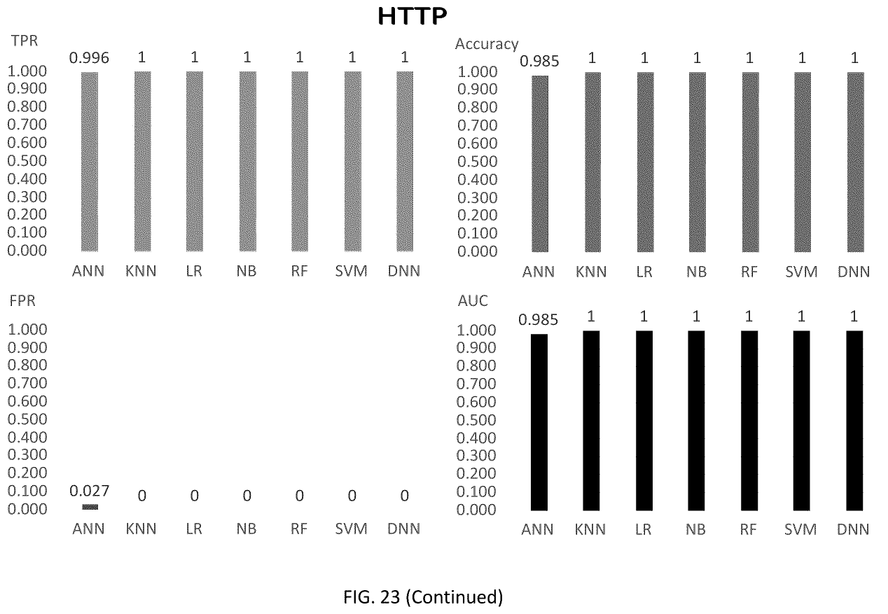

Reference is made to FIG. 23, which shows bra graphs of unknown fileless attack detection capabilities, in accordance with some embodiments of the present invention.

FIG. 23 presents the detection capabilities of seven different ML classifiers in the task of unknown fileless attack detection. The results presented are the average for the three different attacks previously mentioned (DNS Spoofing, DDOS, cryptominer) with an average of the 10-fold cross-validation over the three attacks. For the DNS server, the best results of TPR=1, FPR=0, and IDR=1 were achieved with five different classifiers—DNN, KNN, LR, RF, and SVM. For the HTTP server, the same top results were achieved with six different classifiers—DNN, KNN, LR, RF, NB, and SVM. As can be seen, one can understand that fileless attack is being reflected in the virtual server's volatile memory, in the same way, that malware-based attacks remained traces in the volatile memory. Thus, the malware-based attack traces can be leverage also for detecting fileless attacks, as has been demonstrated additional important generalization capabilities for malware detection.

According to some embodiments, as detailed and exemplified herein, provided herein is a trusted ML-based framework for the detection of unknown malware, from nine different categories, in Linux VM cloud environments; this is accomplished due to the ability to leverage the comprehensive feature set, using ML algorithms, in order to detect malicious behavior of Linux malware. Two common types of Linux servers were used—a DNS server and an HTTP server. 54 benign samples were collected from various popular programs and applications widely used in Linux virtual environments and also included two server baseline states (for a total of 56 benign samples). To those, 53 malware samples were added from nine different categories. A trusted acquisition of volatile memory dumps during the samples' executions was conducted. In total, the dataset consisted of 21,800 volatile memory dumps (10,900 from each server). The volatility framework was used to extract the proposed 171 knowledge-based meta-features from different parts of the volatile memory, aiming to cover a variety of malicious behavior presented by Linux malware samples.

As exemplified herein, the methodology was tested in seven experiments. In the first experiment, it was able to identify a benign or infected state of each server when it was attempted to classify memory dumps from known malware and benign samples. In the second experiment, the framework's ability to identify unknown malware that the classifiers did not encounter during the training phase was demonstrated. As shown in Table 5, in this experiment, TPR=1 and FPR=0 were achieved for both servers in an n-first detection mode. Experiments three and four showed the framework's ability to detect the servers' infected state when the malware is from an unknown category and its ability to correctly identify the malware category; the best results achieved are presented in Table 5. In the fifth experiment, the feature set were explored and two different feature selection methods were used to eliminate features that did not contribute to the classification performed by the ML classifiers. By removing them, the classifier's performance in the single detection mode was improved, obtaining TPR=0.937 for the DNS server using 26 features and TPR=0.991 for the HTTP server using 17 features. In the sixth experiment, it was demonstrated that a classifier trained on the DNS server data could identify malware sample executed in the HTTP server with TPR=0.97 and FPR=0.087. However, for the opposite task of training on the HTTP server data and testing on the DNS server, the detection performance was lower, but standard, with TPR=0.724 and FPR=0.213. In the final experiment, it was demonstrated that the framework could also deal with unknown fileless attacks against the server, achieving TPR=1 and FPR=0 for both servers.

When comparing the malware detection results obtained with each of the servers, it is important to note that detecting malware on the DNS server is a harder task than doing so on the HTTP server. The main difference between the servers is in the way that they communicate with the client; each of the servers uses a different method. The DNS communicates over UDP with smaller and more frequent packets, while the HTTP communicates over TCP with larger and less frequent packets. Moreover, the DNS server uses a cache that adds more indications and information to the volatile memory. For the abovementioned reasons, overall, the DNS server produces more activity within the volatile memory during its normal execution, activity that might be considered “noise” by the learning algorithm. Such “noise” in the volatile memory can sometimes mask malicious activity and cause difficulty in the detection of some types of malware. This can be overcome by using the n-first detection mode, which is more robust.

TABLE 5
The results of all of the experiments performed

| | Detection | DNS server | | | | | | HTTP server | | | | | |
|---|---|---|---|---|---|---|---|---|---|---|---|---|---|
| Experiment | mode | ACC | TPR | FPR | IDR | AUC | Mode | ACC | TPR | FPR | IDR | AUC | Model |
| Known malware | single | 0.987 | 0.979 | 0.006 | 0.973 | 0.986 | RF | 0.999 | 0.999 | 0.002 | 0.999 | 0,999 | KNN |
| Unknown malware | Single | 0.959 | 0.934 | 0.017 | 0.918 | 0.968 | DNN | 0.989 | 0.976 | 0 | 0.976 | 0.994 | KNN |
| | n-first | 1 | 1 | 0 | 1 | 1 | DNN | 1 | 1 | 0 | 1 | 1 | RF |
| Detection of | single | 0.914 | 0.900 | 0.098 | 0.812 | 0.939 | LR | 0.956 | 0.918 | 0 | 0.918 | 0.990 | RF |
| Malware from | n-first | 0.940 | 0.940 | 0.044 | 0.899 | 0.955 | DNN | 0.958 | 0.920 | 0 | 0.920 | 0.986 | DNN |
| Unknown Category | | | | | | | | | | | | | |
| Malware | single | 0.981 | — | — | — | — | RF | 0.986 | — | — | — | — | DNN |
| Categorization | | | | | | | | | | | | | |
| Feature Ser | Single | 0.964 | 0.937 | 0.008 | 0.929 | 0.964 | DNN | 0.995 | 0.991 | 0 | 0.991 | 0.999 | RF |
| Optimization | n-first | 1 | 1 | 0 | 1 | 1 | DNN | 1 | 1 | 0 | 1 | 0.988 | RF |
| Detection of | single | 0.940 | 0.970 | 0.087 | 0.886 | 0.942 | RF | 0.757 | 0.724 | 0.213 | 0.570 | 0.755 | RF |
| Unknown Malware | | | | | | | | | | | | | |
| on Unknown server | | | | | | | | | | | | | |
| Detection of Fileless | single | 1 | 1 | 0 | 1 | 1 | DNN, | 1 | 1 | 0 | 1 | 1 | DNN, |
| Malware | | | | | | | KNN, | | | | | | KNN, LR, |
| | | | | | | | LR, | | | | | | RF |
| | | | | | | | RF | | | | | | |

According to some embodiments, the method may be configured such that the volatile memory dumps are extracted in a trusted manner from different parts of the volatile memory, making it more difficult for even sophisticated malware to evade detection. Malware that attempts to evade AV often relies on basic methods like scanning the active process or files in the system to discover the AV. However, to evade the framework, malware will need to change the values of several meta-features, which means changing its malicious activity and applying it in a new and under the radar manner, a challenging task for malware writers aimed at developing new zero-day behavior.

According to some embodiments, the method disclosed herein may implement a machine learning-based trusted unknown malware detection framework for Linux-based cloud environment VMs and perform trusted fileless attack detection in this environment. According to some embodiments, the method may use knowledge-based feature set extracted from different parts of the volatile memory, enabling the framework to capture various malicious behavior performed by malware samples from different categories. According to some embodiments, the method may be configured to detect various malware of different categories and types, in a trusted manner.

### Method for Trusted Unknown Malware Detection and Classification in Linux Cloud Environments Using Deep Learning

C. Machine and Deep Learning

A sub-domain of Artificial Intelligence (AI), Machine Learning (ML) may refer to the automated detection of meaningful patterns in data. ML's main advantages are 1) its ability to discover specific trends and patterns that would not be apparent to humans given a reasonable amount of data; 2) ML-based algorithms' ability to keep improving, in terms of both accuracy and efficiency, by gaining more experience; 3) the fact that it can be applied to multi-dimensional data; 4) its suitability for solving problems in various fields, such as medicine, cyber-security, psychology, agriculture, etc. Despite its many advantages, ML has several drawbacks: 1) ML requires a sufficient amount of data to train on, and to avoid selection bias, it should represent the actual distribution of the population explored well; 2) to obtain satisfactory accuracy results, ML algorithms need sufficient time and resources for learning; 3) some traditional ML algorithms generate results that are difficult to interpret; and 4) features fed into most ML algorithms usually needed to be extracted and engineered using knowledge provided by domain experts, which incurs costs.

Deep learning (DL) is a sub-domain of ML, which is based on artificial neural networks (ANNs) and representation learning. ANNs are computing systems inspired by the biological neural networks in the brain of animals and derived from the multilayer perceptron introduced in 1967. A shallow neural network (NN) consists of a single input layer, a hidden layer, and an output layer, where the layers of neurons are interconnected. The hidden layer consists of neurons, and their inner and outer connections represent the estimated weights used for different learning tasks, such as classification, regression, etc. Note that the word “deep” in this context refers to a NN with multiple hidden layers, making the network deeper and hence capable of learning more complex representations. DL's main advantages are: 1) it provides higher accuracy than other classic ML algorithms, as it can improve its generalization capabilities when more data is obtained, allowing it to better profile, represent, and estimate the sample space distribution more effectively; 2) the training process can be performed in parallel by using a GPU; 3) in some DL architectures, features are automatically engineered and extracted, eliminating the need for a domain expert; 4) there are many DL architectures, which can be used for different types of data and objectives. Some limitations of DL are 1) it requires a large amount of data compared to traditional ML algorithms; 2) the training phase is longer than with traditional ML algorithms and usually requires a GPU; 3) it requires hyperparameter tuning and optimization; and 4) there can be a lack of explainability about the model's decisions, a property that some other ML algorithms also have, including decision tree-based algorithms and temporal probabilistic profile algorithms, etc.

A convolutional neural network (CNN) is a particular class of deep neural network architecture usually applied to visual data or other grid-like topology data. CNNs serve as the foundation of modern computer vision capabilities, and they are used for learning tasks, such as classification, object detection, image segmentation, etc. The core part of a CNN is the convolutional layer, in which parameters consist of a set of learnable filters (kernels) with small receptive fields. These filters convolve across the input volume's height and width by computing the element-wise product between the input and their entries. As a result, 2-dimensional activation maps are formed, which are used to represent different features at various spatial positions. In addition to the convolution layer, most CNNs consist of pooling layers; a pooling operation replaces the output in a particular location, with summary statistics of the nearby outputs placed within the same rectangular neighborhood.

For instance, in average pooling or max pooling, the maximum output or the average output for each rectangular area is extracted. Pooling layers help make the representation approximately invariant to small changes in values. Note that the learnable features' representations become more complex as we go deeper towards the network output. CNNs are also frequently used in the field of transfer learning (TL). According to some embodiments, TL is defined as follows: Given two domains: Source ( [symbol] _{S}) and Target ( [symbol] _{T}), and two correspondent learning tasks, [symbol] and [symbol] respectively, transfer learning seeks to improve the learning of f_{T}(⋅), a target predictive function in the target domain, [symbol] _{T}, by transferring the knowledge captured from [symbol] _{S} using [symbol] , where [symbol] _{S}≠ [symbol] _{T} or [symbol] ≠ [symbol] .” For the above definition, a domain is a pair [symbol] ={ [symbol] , P(X)}, where [symbol] is the feature space and P(X) is the marginal probability distribution. A task is a pair [symbol] ={y, f(⋅)}, where y is the label space and f(⋅) is the objective predictive function learned from the training data. TL is especially useful in cases where there is not enough data to train a model from scratch.

### II. Data Collection

In this section, details about the data collection are provided. Exemplary automated application mapping procedure used for data labeling and categorization according to predefined malware and benign families is also described. Exemplary automated data validation procedure performed to ensure the sample space's reliability and quality. Exemplary validated malicious and benign sample space distributions is further described.

1. Data Collection

To address the task of unknown malware detection, a deep learning-based approach that requires preliminary steps, such as data collection, labeling, and preprocessing was used. Since one of the goals was to detect if a given Linux VM instance is infected based on its volatile memory dump, malicious and benign samples were required. Malware samples were collected from two well-known malware repositories: VirusTotal and VirusShare. Tens of thousands of malicious applications were downloaded. For data labeling, MalTag, an automated malware labeling mechanism using VirusTotal's API was developed. Then, by using the scan results of 58 antivirus service providers per application, for counting purposes, the classification of each AV provider to each of the following malware families: virus, worm, Trojan, DDoS-Trojan, ransomware, botnet, Cryptojacker, APT, and rootkit was mapped. Finally, the malware class was labeled according to the most frequent malware family appearing within VirusTotal's list of antivirus providers.

56 benign applications were collected and divided them into five main groups that differ in terms of their installation process, dependencies, and execution, in order to capture different types of applications and their diverse modus operandi and behaviors (e.g., some have GUI and some do not) which can affect the volatile memory in different ways. The first group, referred to as Type 1, is composed of both Linux built-in bash commands, such as top, install, copy, etc., and built-in applications, such as the Firefox browser; note that most Type 1 built-in commands were sampled twice, with and without the sudo command, allowing a permitted user to access restricted administrative resources by executing a command as a superuser. The second group, referred to as Type 2, contains small-size execution programs, such as htop, ZMap, netstat, etc., requiring preinstallation using the Linux apt-get install command followed by a direct application execution. The third group referred to as Type 3, contains large applications like Wireshark that require a more extensive installation procedure in which a compressed image tar file needs to be downloaded and then decompressed, installed, and finally, executed. The fourth group is referred to as Non-Executable Files (NEF) and consists of files that require a custom viewer to be executed, such as PDF, JPG, XLSX, etc. The last group, referred to as Natural, includes cases in which no file is executed except the main server application.

The data collection process described above resulted in a collection of thousands of benign samples and a substantial amount of diverse malicious samples. Although the ratio of benign and malicious applications is imbalanced in nature, the amount of malicious data was reduced by using a validation procedure which ensured the validation and refinement of Linux OS compatible applications that are flawlessly executed yet embody suspicious behavior. The exemplary validation procedure is elaborated in the next subsection.

2. Data Validation

“Garbage in, garbage out” (GIGO) is a computer science concept in which flawed input data produces faulty output, or “garbage,” that can lead to poor decision-making. Therefore, data quality is considered a major preliminary constraint when interacting with data both for analysis and learning purposes. In this subsection, it is described how this issue was addressed by developing an automated data validation procedure calledMalVal. MalVal validates malicious data's execution from an operating system compatibility perspective MalVal validates malicious data's execution from an operating system compatibility perspective (i.e., compatibility of x86 processor and 32/64 bit OS). Also, MalVal helps avoid mislabeling of benign and malicious samples, which can lead to poor detection results. Note that every Linux command executed by the shell script or user returns an exit status, in the form of an integer number (0-255).

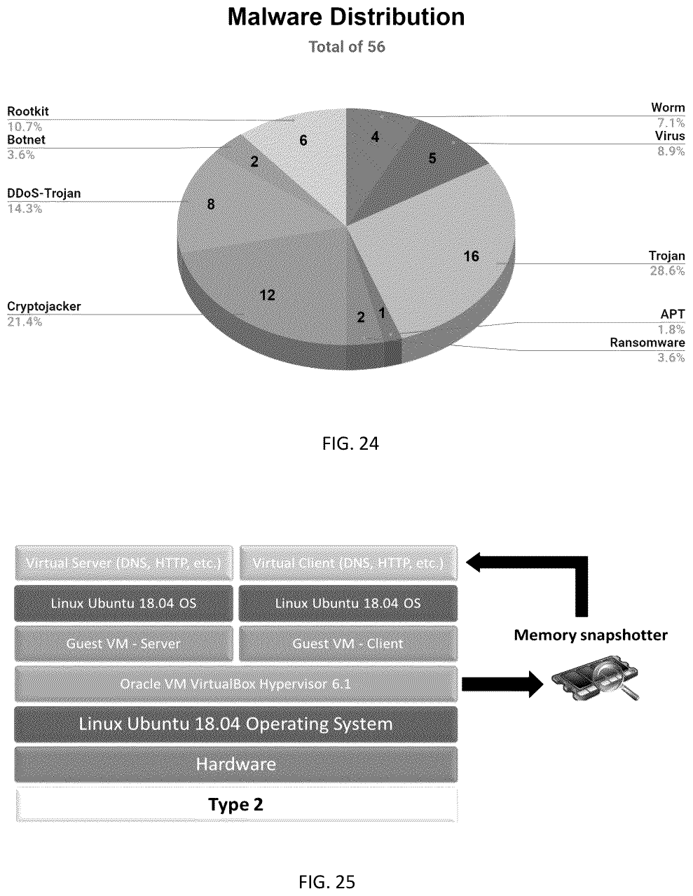

Reference is made to FIG. 24, which shoes a pie chart depicting the malware distribution in the data collection, in accordance with some embodiments of the present invention.

For the Linux shell, a command that has succeeded exits with a zero exit status (a non-zero exit status indicates failure). MalVal receives a list of applications as input and outputs a list of applications that returned an exit code of zero, meaning that the application was executed without any errors. Although for some malware, the execution status does not fully reflect whether the malicious activity ran successfully or not, by filtering such applications, it was able to avoid cases of mislabeling, which could result in biased detection results. At the end of the validation process, a total of 56 malware samples were found, which included 47 ELFs, four bash scripts, and five non-executable files (NEFs) with a GUI. Three of the NEFs were disguised to appear in PDF format, whereas the rest were wrapped as Microsoft Excel Open XML spreadsheet (XLSX) or JPG formats. In FIG. 24, the distribution of the malware collection is presented and grouped by family.

Appendix II, lists each malware's name, family, file type, and SHA-256 signature. Appendix I contains details on the benign sample collection.

### III. Methods

In this section, methods used are disclosed. First described are the virtual environment's design and architecture, in which virtual servers' activity and the execution of benign and malicious applications are simulated. Second, described is how simulation of real server scenarios addressed, with two commonly used types of organizational servers: DNS and HTTP. Third, the process of acquiring volatile memory dumps from the inspected VM. Is described. Thereafter, the visual representation method applied to the volatile memory dumps is explained and the visual dataset creation process is clarified. Finally, the deep learning architectures used for the task of malware detection are disclosed.

### D. Establishing Organizational Linux Cloud Environment

1. VMs in Linux Cloud Environment Architecture

This subsection describes the creation and configuration of the controlled virtual environment used as the basis of the experiments. A virtual environment using an Oracle open-source product called VirtualBox, a type 2 hypervisor was sued. VirtualBox is suitable for both AMD and Intel 64×86 processors and can be installed on a range of host operating systems (OS), such as Linux, Windows, Mac OS X, and Oracle Solaris. In addition to those OSs, in the guest virtual machine, the FreeBSD and DOS OSs are also supported. VirtualBox offers several types of virtualization techniques, such as hardware virtualization, paravirtualization, and full virtualization. Note that hardware virtualization is supported if AMD-V or Intel VT-x technologies are built in the host hardware chipset. In hardware virtualization, although the VM guest is virtualized, its instructions can be executed directly in the processor. However, if an anomalous event occurs or an anomalous instruction has been received, instead of being managed directly by the processor, it is documented and handled using the hypervisor, which serves as a mediating layer between the guest and host operating systems. Paravirtualization is enabled when paravirtualization interfaces are supported within the guest OS. In this technique, since the guest OS is aware that it is being virtualized, when communicating with the hypervisor, the guest source code is combined with sensitive data that the hypervisor interprets directly through API calls.

Reference is made to FIG. 25, which shows a diagram of the architecture of the Oracle Virtual Box, in accordance with some embodiments of the present invention.

In another scenario where the hardware or the guest OS does not support the technologies mentioned above, VirtualBox employs the full virtualization technique. In this technique, which uses the QEMU emulator, the guest OS's executed code is recompiled and analyzed in a form that prevents the host from modifying or viewing the hypervisor's actual state. However, this technique is time-consuming and a more complex procedure. Therefore, it is less recommended than hardware virtualization or paravirtualization. Considering the performance and security perspectives, a combined approach of both paravirtualization and hardware virtualizations was used in the experiments. In these settings, in cases where VirtualBox identifies any abnormal operation, such as an unauthorized memory request, it essentially allows the hypervisor to take control of the guest code and thus creates a much secure environment. Although both type 1 and type 2 hypervisors lead to a more secure virtual setting, type 2 hypervisors also have the property of high performance. Therefore, the abovementioned combined approach, which is a type 2 hypervisor was selected. The guest machines were configured with both VT-X hardware virtualization and paravirtualization; KVM was selected as the paravirtualization configuration, since it is considered the most recommended Linux guest provider by VirtualBox. It is important to emphasize that the guest operating systems are isolated from both the host and the hypervisor, making the experimental virtual environment fully trusted. Furthermore, the whole volatile memory dump acquisition process described in the subsections that follow is done via the VBoxManage control command, performed by VirtualBox's hypervisor. Fully trusted means that any program that is being executed within a guest machine cannot evade, terminate, or interfere with the memory dump acquisition process. FIG. 25 presents Oracle's VirtualBox infrastructure, where the lower layer represents the host machine's hardware. The layer on top represents the installed operating system, which is Linux Ubuntu 18.04. The VirtualBox hypervisor is installed on top of the OS. The hypervisor enables the instantiation of multiple virtual machine guest instances in which each guest has a separate operating system and applications that are executed on the top layer. In the next subsection, additional details about the guest OS configuration and the VM's guest instances used as an infrastructure for the HTTP and DNS servers, designed to simulate enterprise server activities in real-time are described.

2. Virtual Organizational Server Simulations

In this subsection, the VM instances used to create the desired architecture for the simulated servers are described. The first VM instance, which is denoted as “Server,” is used as the sampling environment in which each injected app is inspected and has its snapshot taken (i.e., a snapshot is captured). Note that the Server instance's initial state, when no main application is executed in the background, is referred to as “Baseline” and considered benign. To examine real organizational server scenarios deployed in industry, Two commonly used server applications: Hypertext Transfer Protocol (HTTP) and domain name system (DNS) servers were simulated. According to a web technology survey presented by W3Techs at the beginning of 2020, 38.6% of websites worldwide are powered by Apache, which dominates the web server market. As a result, to simulate an HTTP server that allows web developers to distribute their content over the web, Apache-2 and curl-loader were used.

Due to its essential role when locating services' addresses on the web is required, in the second scenario, a DNS server is simulated using BIND and DNSperf; Despite their different uses, to create a suitable architecture and configuration for both HTTP and DNS servers, there is a need to simulate client requests that are intended for the sampled guest server. As a result, a second VM guest instance was instantiated, denoted as “Client,” which generates client requests targeted to the server instance (Server) during the inspection of the executed app; in this way, it was able to emulate feasible cloud-based scenarios of an active overloaded server in real-time with high CPU utilization. The final experimental virtual environment consists of two Linux-based guest instances, where each instance is configured with 1 GB RAM and an updated Ubuntu 18.04 OS. While, 1 GB of memory may be considered small compared to virtual machines, which usually have about 8, 16, etc., gigabytes of RAM, however there is sufficient memory to run the servers, the sampled application, and the background's built-in OS services; although the specified applications use some of the memory, most of the memory is still empty and unallocated, so the correctness and validation of the study is also relevant for larger RAM sizes.

### E. Dataset Creation

1. Trusted Linux VM's Volatile Memory Dump Acquisition

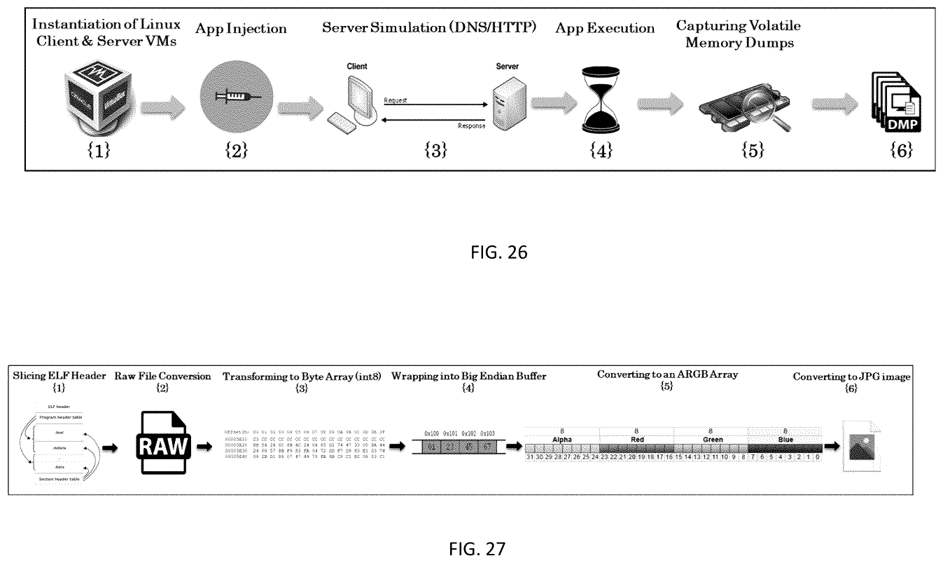

Reference is made to FIG. 26, which shows a diagram depicting the process of trusted volatile memory acquisition from Linux virtual servers, using VirtualBox, in accordance with some embodiments of the present invention.

This subsection discusses how volatile memory dumps are acquired from the inspected VM in a trusted manner. First, note that for each VM state, VirtualBox stores information regarding both machine and hard-disk settings in *.vbox and *.vdi files, respectively. As a result, using the VirtualBox obj dump command, a snapshot of both the CPU and volatile memory can be captured and saved as an ELF, along with its header. In order to execute and sample each malicious or benign application uniformly in real-time while controlling the variance, as part of the framework, an automated module called “Virtual Box Snapshotter” was developed, which controls the settings of the virtual environment and the parameters to be configured (such as applications to be sampled), simulated server type (such as baseline, DNS or HTTP), amount of snapshots to be captured, and a fixed time interval between consecutive snapshots. As shown in FIG. 26, after setting up the parameters and activating the snapshotting process, first, an instance of the desired VM is created {1}. Second, the inspected applications are injected into the server instance {2}; however, at this point, applications are not executed. Also, note that a new snapshot of the new VM state is captured after injecting the applications; this will serve as a starting point for each app to be inspected. Third, a simulation of client-server requests based on the chosen server type is activated {3}. Fourth, the injected app is executed {4}. Then, during the injected app's execution, volatile memory snapshots are captured, based on a predefined time window {5} resulting in a batch of volatile memory dumps for each injected app {6}. For purposes of differentiation and identification, memory dumps are named based on their VM configuration parameters, followed by the acquisition timestamp. Note that the snapshotting procedure is repeated for each injected application sequentially. Before executing a new injected application, the framework restores the inspected virtual environment to the initial state mentioned above.

Note that the virtual guest OS is isolated from the host. Before each resource-based instruction is executed, the instruction triggered by the guest OS is inspected by the hypervisor. After inspection, the hypervisor decides whether to perform or discard the instruction when a request is considered suspicious. The volatile memory dump acquisition is accomplished via the VBoxManage command control, and thus by the hypervisor; therefore, the acquisition process is trusted, so that programs executed within the guest machine cannot evade, terminate, or interfere with the acquisition process. Sophisticated cases in which the analyzed application is aware of the virtualized environment (e.g., anti-VM) can end up with a self-termination of the inspected program, including its malicious behavior. The self-termination prevents the application from harming the VM.

In order to create a dataset composed of volatile memory dumps for the experiments, as well to capture more representative and varied behavior among the applications inspected, the virtual environment was configured so that 100 snapshots of each injected app are taken, with a 10 second time interval in between each dump. Each volatile memory dump's size is 1.1 GB, including its ELF header, which is sliced and removed as described in the next subsection; as a result, the dump size is reduced to 1 GB. For each injected app, 100 memory dumps are captured over time; thus, the total size of the memory dumps collected for each app is 100 GB. Therefore, after injecting and sampling 56 benign and 56 malicious applications for both DNS and HTTP servers, a raw volatile memory data of ˜23 TB was obtained.

2. Visual Representation of the Acquired Volatile Memory Dumps

Reference is made to FIG. 27, which shows a diagram depicting the method from acquiring a volatile memory dump to generating a visual image, in accordance with some embodiments of the present invention.

In this subsection, the process of preprocessing the extracted volatile memory dumps is described. During preprocessing, the volatile memory dumps are transformed into visual image representations which are then used as input to the CNN detectors. FIG. 27 describes the preprocessing pipeline which consists of the following steps. First, since each volatile memory snapshot is stored as an ELF, its ELF header is sliced and removed{1}, both of which reduce the size of the volatile dump to be converted and remove unnecessary information that contains details about the structure of the ELF and non-essential data from the volatile memory itself. Second, the sliced snapshot is saved in its raw format {2}. In the third step, to transform the raw files into a viewable image format, each raw file is represented as a byte array sequence in the int8 format {3}. Then, each volatile memory's byte array is wrapped into a big endian buffer, which stores the most significant byte of a digital word at the lowest memory address and the least significant byte at the highest memory address {4}. Then, each buffer is transformed into an ARGB (alpha, red, green, blue) array where the byte order is as follows: bits 24-31 represent the transparency axis, denoted as alpha; bits 16-23 represent the red axis; and 8-15 and 0-7 bits represent the green and blue axes respectively {5}. Finally, each volatile memory dump represented as an RGB array (the alpha axis is ignored) is used to map the bytes to a pixel that consists of the RGB axes and is saved in JPG format {6} using

Pixel(x,y)=RGB[offset+(y−y₀)*scanSize+(x−x₀)] (1):

Pixel(x,y)=RGB[offset+(y−y₀)*scanSize+(x−x₀)] (1)

where offset represents the offset of the RGB array, and scanSize stands for the scanline stride for the given RGB array. Note that the origin of the image is located at coordinate (x₀, y₀), where x₀=y₀=0. This process, which is repeated for each volatile memory dump captured, results in a *.jpg viewable image that visually represents the memory dump and can be used to train a CNN-based classifier (to be discussed in the next subsection). By learning from different image representations of volatile memory, the CNN architectures selected can learn representations that can be used to induce accurate detection rates for unknown malware.

Reference is made to FIG. 28, which shows a table comparing between benign and malicious images converted from a Linux VM's volatile memory dumps, in accordance with some embodiments of the present invention.

FIG. 28 presents two images produced from benign samples, which are compared to two images produced from malicious samples. As shown in the first row, the two images are dissimilar, even to the human eye. However, the images in the second row are much more similar and difficult to distinguish; such similar images require an advanced profiling method to determine the indications that can be used to distinguish between memory dumps from servers executing malicious or benign applications. After utilizing the dump to image transformation pipeline, images were generated in eight different resolutions, including 256×256 and 224×224 resolutions, in color and grayscale, which is used in the experiments to explore the tradeoff between resolution and detection rates, which is discussed in the evaluation section.

F. CNN-Based Architecture for Unknown Malware Detection

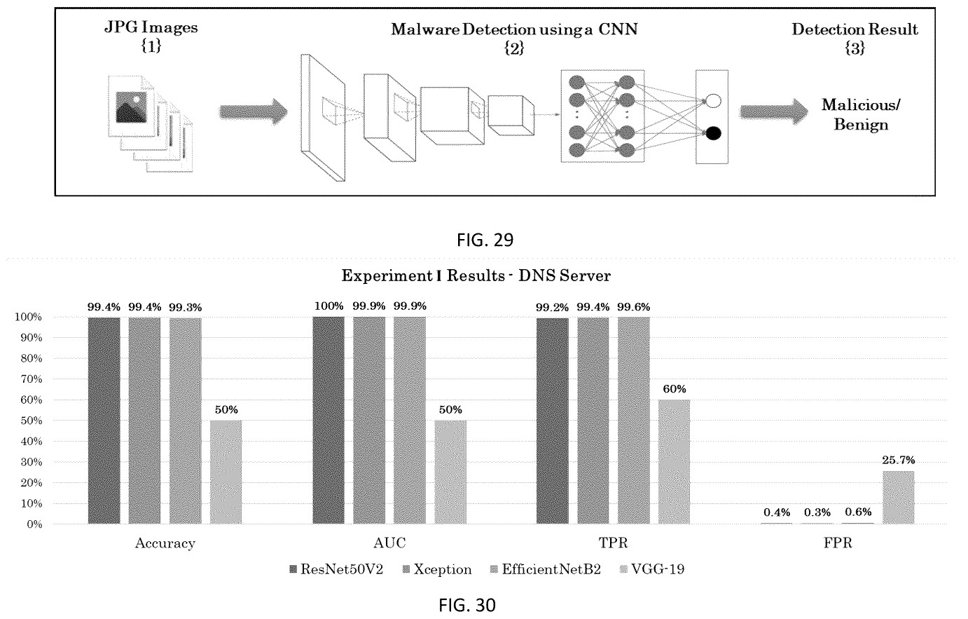

Reference is made to FIG. 29, which shows a diagram of the method of malware detection, from a receiving/generating a visual image to a outputting a detection result, in accordance with some embodiments of the present invention.

To achieve the goals of this study, state-of-the-art architectures suitable for the task of unknown malware detection and classification in Linux VMs were explored. As is shown in FIG. 29, the JPG images are converted from a Linux VM's volatile memory dumps {1}, and then used as an input to train a CNN model, for the task of malware detection {2}. Last, the trained CNN model is used to detect if a given image (representing VM's volatile memory) is more likely to be malicious or benign {3}. This subsection briefly describes the CNN architectures compared during the experiments to determine the top performing model capable of achieving the best results using images generated from the Linux VM volatile memory dumps.

### 1. VGG-19

One of the architectures with the greatest impact on computer vision in recent years is AlexNet, which is similar to, but deeper than LeNet-5, with approximately 60M parameters. It also uses ReLU activation functions, instead of using either tanh or sigmoid activations, and is trained on multiple GPUs. Convolution blocks are normalized using Local Response Normalization (LRN) to reduce the number of neurons with high activation values, meaning that each spatial position (height and width) within a block is normalized across all channels located below it. The VGG-19 network was derived from a VGG-16 network architecture. The VGG-16 architecture was simplified using “same” convolution (i.e., a type of convolution where the output matrix is of the same dimension as the input matrix) layers consisting of 3×3 filters, a stride of one combined with max pooling layers of 2×2 and a stride of two. The 16 appears in the network's name (i.e., VGG-16) derive from the fact that this network has 16 layers with weights, resulting in ˜138M parameters. Another important principle that the authors used was doubling the number of filters after each pooling layer, from 64 filters to 128 filters and so on until it reached to 512 filters. Thus, going deeper into the network, the height and width decreased, and the number of channels increases. In contrast, despite its similarity the VGG-19 network is slightly larger compared to VGG-16, and it has ˜143M parameters.

### 2. Residual Network (ResNet50V2)

According to some embodiments, residual networks, known as ResNet, may pass initial information that is much more in depth compared to the last-mentioned architectures without compromising the optimization process. As a result, ResNets can learn more complex representations from the considerably increased depth, leading to higher classification rates. In light of the benefits of ResNets, ResNet50V2 was chosen as another candidate, which contains about 25.6M parameters for estimation.

### 3. Xception

Xception may be based on the architecture of Inception-v3. In general, instead of picking a specific operation for a particular input, the Inception architecture's main idea is to apply several operations, such as convolution and pooling, to an input. Then, the layers are concatenated to form an Inception block. Despite its advantages, each Inception module's formation has a high computational cost due to the substantial number of parameters calculated per block. However, by using 1×1 convolutions that form an intermediate bottleneck layer, the authors were able to reduce the number of parameters per module by a factor of 10. In the case of the Inception-v3 architecture, the Inception modules first look at cross-channel correlations using a set of 1×1 convolutions. Then, the input data is mapped into three or four separate spaces which are smaller than the space of the original input. Lastly, all correlations are mapped in smaller 3D spaces by using regular 3×3 or 5×5 convolutions operations. In the Xception architecture, however, Inception modules are replaced with a depthwise convolution followed by a pointwise convolution. This operation is denoted as a separable convolution where a spatial convolution is performed independently over each channel of an input, followed by a 1×1 convolution, in which the channels' output is projected onto a new channel space using the depthwise convolution. The Xception architecture outperformed the Inception-v3 architecture on the ImageNet dataset and a larger image classification dataset comprising 350 million images and 17,000 classes. Although the Xception architecture has almost 23M parameters (fewer than the Inception-v3 architecture which has approximately 24M) it uses the model parameters more efficiently and, therefore, resulted in better classification rates. Thus, the Xception network was selected as an additional candidate.

### 4. EfficientNet

According to some embodiments, better performance can be achieved by carefully balancing between a CNN's depth, width, and resolution. According to some embodiments, using a scaling method in which all dimensions of depth/width/resolution are uniformly scaled with a fixed ratio using an effective compound coefficient may be used to obtain a family of models called EfficientNets that outperform previously proposed CNNs in accuracy and efficiency. According to some embodiments, EfficientNets uses a compound scaling technique in which width, depth, and resolution scaling are combined and modified as a function of the input resolution. The intuition behind this is related to the effectiveness of training a CNN on an input of high dimensional images. Hence, to gain a satisfactory accuracy level, a larger image will require a network architecture with more layers and channels to form a wider and deeper network to increase the receptive field and capture more complex patterns of the larger image.

### IV. Evaluation

G. Experimental Design

In this subsection, the goals and design of the experiments conducted during this research to evaluate the ability of the CNN architectures selected to detect and classify malicious and benign images of the volatile memory dumps are disclosed. The experiments have different levels of difficulty, and they were conducted twice for each of the servers examined (HTTP and DNS). Note that from the eight image datasets which differ in resolution size, a resolution of 256×256 RGB was used in all of the experiments, except Experiment V. This was done to retain all of the essential information needed for effective CNN learning and high accuracy results. Also, CNN architectures were modified for the task by slicing out their last fully connected layers and replacing them with a global average pooling layer, followed by a prediction layer. In all of the experiments except Experiment IV, the CNN models were optimized using the binary cross-entropy loss function and compared based on the evaluation measurements described in the next subsection. Also, regularization techniques such as L2 regularization and dropout were also applied in some architectures to prevent overfitting. The best configurations of hyperparameters determined after optimizing each network are presented in Table 6 in the appendix. The experiments were conducted in a Linux Ubuntu 18.04 environment, and the models were trained on an NVIDIA GeForce RTX 2080 Ti GPU with a frame buffer of 11 GB GDDR6 and a memory speed of 14 Gbps.

1. Experiment I—Known Linux Malware Detection Using CNN Architectures

This experiment is designed to evaluate CNN-based models' ability to detect known malware in infected volatile memory dumps of HTTP and DNS servers. The images were labeled as benign or malicious, respectively, and were used to feed the CNNs mentioned above. This experiment was addressed using the stratified 10-fold cross-validation procedure of scikit-learn, which reduces noise by averaging each fold's measurements. Each fold is composed of a training set consisting of 90% of equally distributed benign and malicious samples' images and a test set consisting of the remaining 10%. In this experiment, for each application sampled, it was ensured that some of its samples would appear in the training set, while the rest would appear in the test set. This experiment is referred to as known Linux malware detection.

2. Experiment II—Unknown Linux Malware Detection Using CNN Architectures

This experiment is designed to evaluate the selected CNNs' generalization capability to effectively distinguish between images transformed from volatile memory dumps of unknown malware and benign samples captured from a given server (HTTP or DNS). By unknown, it is meant that none of the images of some types of malware and benign samples from a given server were included within the training set and were thus seen for the first time in the testing phase. By doing this, it can be determined whether the induced CNN models can generalize and detect new unseen Linux malware and benign samples. The experiment was conducted using scikit-learn's Shuffle-Group(s)-Out 10-CV procedure. This procedure provides randomized train/test indices to split data according to a given third-party group. This experiment considers the number of unique malicious and benign samples; therefore, each of the 10 folds consists of 10% of the image dataset. Hence, from a total of 11,200 images per server, 1,120 images belonging to six types of benign samples and six types of malicious samples were randomly selected from the 56 malicious and 56 benign sample types and do not appear in the rest folds contain the rest 8960 images. Therefore, this experiment is considered more complex, and it challenges the CNN detectors to learn more complex filters that can straighten the models' robustness from a generalization perspective.

3. Experiment III—Unknown Linux Malware Family Detection Using CNN Architectures

This experiment is designed to evaluate the selected CNNs architectures' ability to detect an unknown Linux malware family. Since malware families are distinguished by their goals, which are achieved through different mechanisms with corresponding actions, a model's ability to generalize and detect unknown malware families based on other types of malware families is a more challenging task. To further explore the ability to detect new malicious images belonging to new types of malware families that are substantially different from the ones already known, the images were labeled as benign and malicious. Since 56 different infected samples and nine unique malware families are represented in the infected samples, for each server, this experiment was conducted nine times using scikit-learn's Leave One Group Out procedure. In this procedure, in every fold, one of the nine malware families (Ransomware, APT, Cryptojacker, Worm, DDoS, Trojan, virus, Botnet, and Rootkit) is not present in the training set. Due to the difference in the number of samples belonging to each malware family in the dataset, they are not distributed uniformly, and thus, the prior probabilities of each family are different; it was therefore ensured that in each fold, the number of benign images in the test set is identical to the number of malicious samples belonging to a particular malware family. Lastly, a weighted average between the resulting folds' scores tuned based on the abovementioned prior probabilities was used.

4. Experiment IV—Classification of Linux Malware Families

This experiment is designed to evaluate the CNNs architectures' ability to classify and distinguish between different malware families based on images generated from a given server. The importance of multiclass classification stems from the fact that after an IDS detects any malicious activities within a system, an appropriate (i.e., suited to the malware detected) recovery procedure must be performed. A functionality that can also be handled by the IDS. In this experiment, each malicious image was labeled by its family; hence, there is a total of nine classes. In this scenario, a stratified 10-CV procedure with 90% for the train set and 10% for the test set was used. The multiclass confusion matrix was used to calculate accuracy. Since this experiment involves multiclass classification, it was the only experiment in which CNN models were optimized using the categorical cross-entropy loss function and evaluated using the accuracy measurement.

5. Experiment V—Unknown Malware Detection as a Function of Image Characteristics

This experiment is designed similar to Experiment II. However, in this scenario, evaluated and compared each CNN's detector's results for the image characteristics (resolution, number of channels) function. The resolution of an image dictates the number of pixels and the amount of information displayed within it. A high resolution implies a higher level of detailed information (e.g., more pixels), which affects the size of an image and leads to a higher number of learnable features. Several resolution candidates were created for which the width, height, and number of channels (e.g., one for grayscale or three for RGB) differ. The candidates' pairs of width and height used were 180×180, 224×224, 256×256, and 280×280. Each candidate pair was split into both grayscale and RGB images, resulting in eight different resolutions to be evaluated. Similar to Experiment II, a 10-fold cross-validation format for each combination of resolution and CNN architecture was used, and then their performance was compared.

6. Experiment VI—Detection of Unknown Malware in Another Unseen Virtual Server

This experiment, which consists of three sub-experiments, is designed to examine the CNN detectors' generalization capability when training on both the malicious and benign images from one type of server and evaluating the performance on malicious and benign images captured from another type of server (the HTTP and DNS servers represented the two server types). Due to the variety of servers used in enterprises, it is more efficient to train a generic and robust detection model that can successfully detect malicious activity among several servers instead of training custom models separately. This experiment's importance stems from its goal of showing how the CNN-based models perform on different server mechanisms associated with different configurations and behavior. In the first sub-experiment (A), trained each model was trained on malicious and benign images captured from a DNS server and evaluated the performance on unknown malicious and benign images captured from the HTTP server, whereas the second sub-experiment (B), is the opposite scenario of sub-experiment (A) meaning training over images from the HTTP server and testing over DNS server's images. In both sub-experiments, Experiment II was repeated on unseen malicious and benign samples; also, similar to Experiment II, in the Shuffle-Group(s)-Out 10-CV procedure, each detector was trained on images of samples executed on a particular type of server and tested on images of unseen samples executed on another server. In addition to the last two sub-experiments, a third sub-experiment (C) was conducted in which each detector was trained on samples from both servers and test it on unseen samples executed on both servers. Like the other two sub-experiments, Experiment II was repeated, but 20,160 images were used for training and test on the remaining 2,240 images.

7. Experiment VII—Detection of Unknown Malware Using Transfer Learning

This experiment is designed to evaluate the detection rates of the CNN architectures by using transfer learning. The purpose of this experiment is to explore whether transferring knowledge from another visual domain contributes to and improves the accuracy measurements compared to models trained from scratch in the domain, as was examined in Experiment II. Therefore, the results obtained in Experiment II in which models were trained from scratch using random weight initialization were compared against models that were partially trained using the TL approach. In this experiment, the CNN models were initialized with weights retrieved from models pretrained on the ImageNet database, which contains thousands of classes of images, such as animals and fruits, belonging to another domain. To avoid overriding some of the prelearned weights in which past knowledge is stored, the first layers of the CNN were modified to be frozen by setting their trainable parameter to false. However, the last layers remained trainable, allowing the detectors to acquire new knowledge regarding the problem domain using the image dataset. Experiment II was repeated using TL and, finally, it was explored whether the knowledge transfer improved the detection rate of each of the servers (HTTP and DNS).

H. Evaluation Measurements

In each of the experiments mentioned above, several CNN-based models were evaluated to identify the model that achieved the best results. Measuring just the accuracy is insufficient and can lead to a misleading inference, especially when dealing with imbalanced classes. As a result, each model was measured using the following performance metrics: accuracy (see Accuracy=TP+TNP+N (2)), true positive rate (TPR/Recall), and false positive rate (FPR). The TPR

$$( see TPR Recall = \frac{TP}{P} = \frac{TP}{TP + FN} ) \qquad ( 3 )$$

is the percentage of correctly classified positive (malicious) samples. In contrast, the FPR

$$( see FPR = FPN = \frac{FP}{FP + TN} ) \qquad ( 4 )$$

is the percentage of misclassified negative (benign) samples. The area under the receiver operating characteristic (ROC) curve (AUC, see AUC=x=01TPR(FPR−1(x))dx (5)) was also calculated. The main advantage of the AUC metric is that it avoids the “accuracy paradox” when dealing with imbalanced classes. The underlying issue is that there is a class imbalance between positive and negative classes. Hence, a given classifier's accuracy can be equal to a near perfect score, such as 99%, even though it may be one classifier that simply classifies everything as a zero, failing to distinguish between the two classes. Note that the ROC curve is created by plotting the TPR versus the FPR at various threshold settings. Hence, in the case, a high AUC score indicates that the trained CNN-based detectors are better able to distinguish between images of benign and malicious samples.

$$Accuracy = \frac{TP + TN}{P + N} \qquad ( 2 )$$

$$TPR ( Recall ) = \frac{TP}{P} = \frac{TP}{TP + FN} \qquad ( 3 )$$

$$FPR = \frac{FP}{N} = \frac{FP}{FP + TN} \qquad ( 4 )$$

$${\int }_{x = 0}^{1} TPR ( {FPR}^{- 1} ( x ) ) dx \qquad ( 5 )$$

I. Results

8. Experiment I—Known Linux Malware Detection Using CNN Architectures

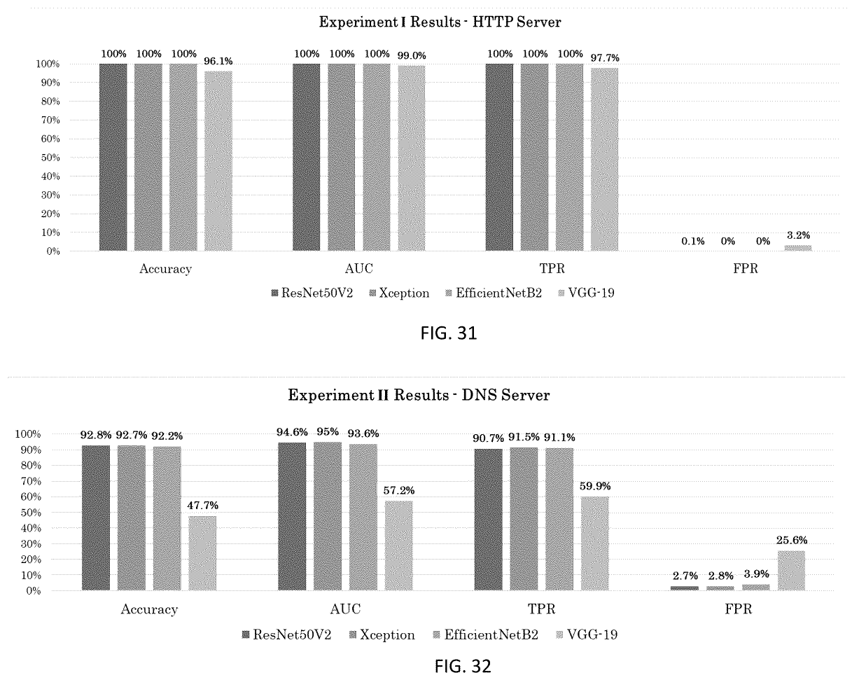

Reference is made to FIG. 30, which shows bar graphs of known malware detection on the DNS server (the results of experiment I), in accordance with some embodiments of the present invention, and to FIG. 31, which shows bar graphs of known malware detection on the HTTP server (the results of experiment I), in accordance with some embodiments of the present invention.

Based on the design of Experiment I, in which the task was detecting known malware, FIG. 30 presents the detection capabilities (average of the 10 folds) of the CNN models trained on the images generated by the DNS server. As can be seen, the CNN models had much better results, with minor differences, except for the VGG-19 for which detection rates were substandard. In terms of higher accuracy, which is a positive indication of a detection model's effectiveness, both ResNet50V2 and Xception obtained the highest score of 99.4%. In terms of the AUC, ResNet50V2 outperformed and obtained a perfect score of 100%, which is slightly higher than the rest. However, its corresponding TPR was 99.2%, which is lower than the maximal TPR of 99.6% achieved by the EfficientNetB2. However, both the ResNet50V2 and Xception models resulted in slightly lower FPR scores of 0.4% and 0.3%, respectively, compared to EfficientNetB2 which obtained an FPR score of 0.6%.

However, as shown in FIG. 31, in the HTTP server case, all of the CNN models performed well, with the ResNet50V2, Xception, and EfficienNetB2 models achieving perfect results of 100% for accuracy, the AUC, and the TPR. Both ResNet50V2 and Xception obtained the lowest FPR of 0%, and EfficientNetB2 had a slightly higher FPR of 0.1%. Moreover, unlike in the DNS server case, the VGG-19 was also able to learn useful representations, obtaining high accuracy results of 96.1%, and an AUC of 99%, a TPR of 97.7%, and an FPR of 3.2%.

9. Experiment II—Unknown Linux Malware Detection Using CNN Architectures

Reference is made to FIG. 32, which shows bar graphs of unknown malware detection on the DNS server (the results of experiment II), in accordance with some embodiments of the present invention.

Based on the design of Experiment II, in which the task was detecting images of unknown benign and malicious samples, FIG. 32 presents the detection capabilities (average of the 10 folds) of the CNN models trained on the images generated from the snapshots acquired from the DNS server's volatile memory. Despite minor differences, the best results were achieved by ResNet50V2 and Xception which obtained accuracy scores of 92.8% and 92.7%, respectively, and AUC scores of 94.6% and 95%, a TPR of 90.7% and 91.5%, and an FPR of 2.7% and 2.8%, respectively. As a result, in terms of the AUC and TPR, the Xception model performs slightly better than the ResNet50V2 although it obtains a 0.1% higher FPR. However, after conducting a one-way ANOVA test followed by an independent t-test with significance level of 5%, the observed difference between the folds means is not convincing enough to say that the average AUC and TPR of ResNet and Xception differ significantly. As can be seen, VGG-19 had substantially low results than the rest of the models, as it did in the previous experiment with the DNS server.

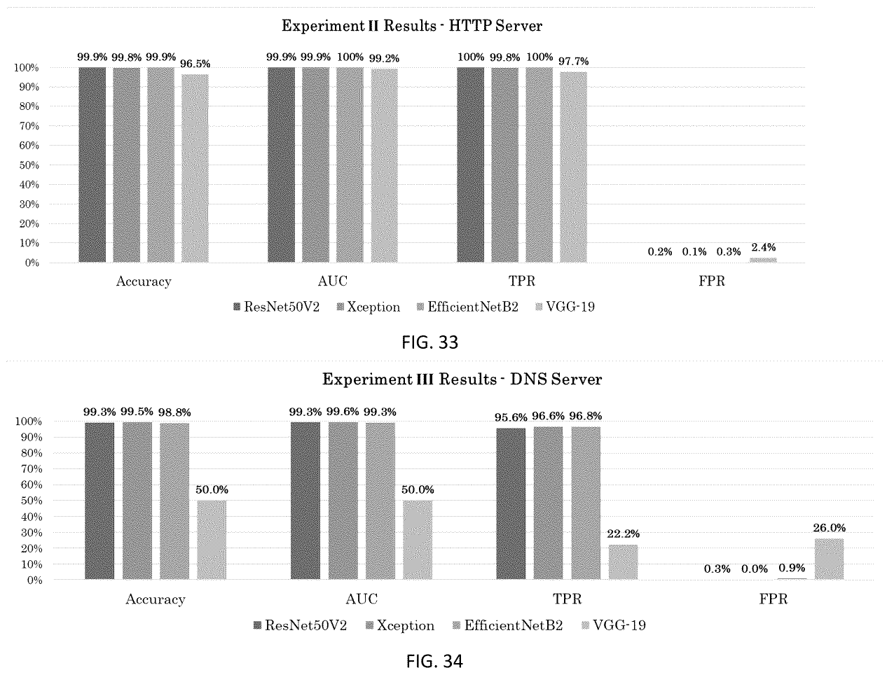

Reference is made to FIG. 33, which shows bar graphs of unknown malware detection on the HTTP server (the results of experiment II), in accordance with some embodiments of the present invention.

FIG. 33 below presents the results for the HTTP server which were almost perfect in the case of ResNet50V2, Xception, and EfficientNetB2. In terms of accuracy, both ResNet50V2 and EfficientNetB2 obtained a score of 99.9%. and Xception obtained a score of 99.8%. EfficientNetB2 also outperformed in both the AUC and TPR metrics (achieving 100% for each) but had a slightly higher FPR of 0.3% relative to ResNet50V2 and Xception, which obtained an FPR of 0.2% and 0.1%, respectively. Despite the fact that the Regarding the VGG-19 model again obtained the poorest results, it obtained much better results than it did on the DNS server, obtaining accuracy of 96.5%, an AUC of 99.2%, a TPR of 97.7%, and an FPR of 2.4%.

10. Experiment III—Unknown Linux Malware Family Detection Using CNN Architectures

Reference is made to FIG. 34, which shows bar graphs of unknown malware family in DNS server (the results of experiment III), in accordance with some embodiments of the present invention.

Experiment III, in which the task was the detection of images of unknown malware families, had an essential role in assessing the CNN architectures' ability to generalize to various unseen malicious mechanisms. In FIG. 34, the detection results in the context of the DNS server are presented. Note that each metric is calculated using a weighted average of the nine folds in this experiment, where the weights defined as the prior probabilities belong to each type of unseen malware family. As can be seen, the Xception model outperformed the rest of the models and provided the best results: accuracy=99.5%, AUC=99.6%, TPR=96.6%, and FPR=0%. The ResNet50V2 and EfficientNetB2 models obtained impressive results for all of the detection measurements.

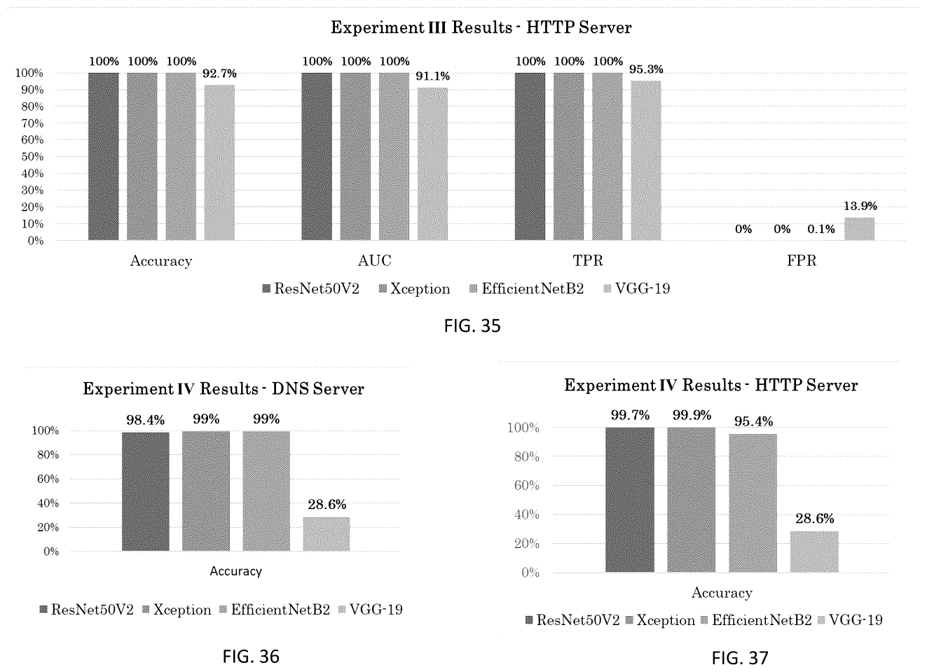

Reference is made to FIG. 35, which shows bar graphs of unknown malware family in HTTP server (the results of experiment III), in accordance with some embodiments of the present invention.

In the HTTP server case, as seen in FIG. 35 below, all of the CNN models performed well, with the ResNet50V2, Xception, and EfficienNetB2 models achieving perfect results of 100% for accuracy, AUC, and TPR. Both ResNet50V2 and Xception had the lowest FPR of 0%; EfficientNetB2 had a minor FPR of 0.1%. VGG-19 fell behind with the following scores: accuracy of 92.7%, AUC of 91.1%, TPR of 95.3%, and FPR of 13.9%.

11. Experiment IV—Classification of Linux Malware Families

Reference is made to FIG. 36, which shows bar graphs of malware classification on the DNS server (results of experiment IV), in accordance of some embodiments of the present invention, and to FIG. 37, which shows bar graphs of malware classification on the HTTP server (results of experiment IV), in accordance of some embodiments of the present invention.

In Experiment IV, a multiclass classification of nine different malicious families, was performed, unlike the binary case addressed in the rest of the experiments. The CNNs' classification results based on the images captured from a DNS server are shown in FIG. 36, both Xception and EfficientNetB2 outperformed and obtained 99% accuracy. ResNet50V2 and VGG-19, however, obtained accuracy of 98.4% and 28.6%, respectively. As shown in FIG. 37 below, in the HTTP server case, Xception outperformed and achieved nearly optimal results of 100% accuracy. Although lower, ResNet50V2 and EfficientNetB2 had accuracy scores of 99.7% and 95.4%, respectively. Unlike the other experiments where the VGG-19 performed adequately in the HTTP server setting, it had poor results (accuracy of 28.6%) in this scenario for this experiment.

12. Experiment V—Unknown Malware Detection as a Function of Image Characteristics

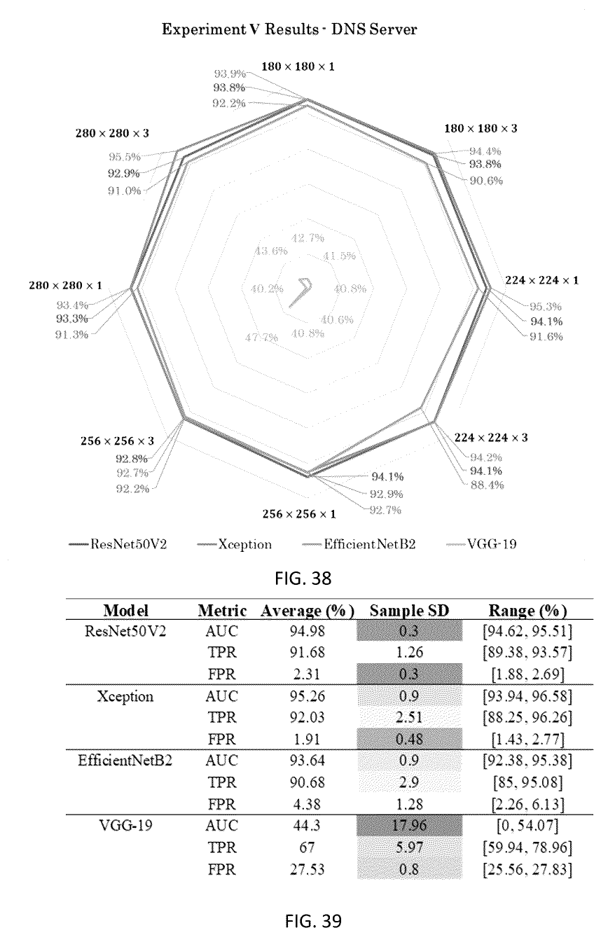

Reference is made to FIG. 38, which shows an octagonal spider chart of detection accuracy as a function of image resolution on the DNS server (results of experiment V), in accordance with some embodiments of the present invention, and to FIG. 39, which shows a table of the summary of the results obtained in experiment V on the DNS server, in accordance with some embodiments of the present invention.

In Experiment V, the detection rates as a function of the resolution of the images generated from the volatile memory dumps were examined. In FIG. 38, an octagonal spider chart of the accuracy scores achieved by the CNNs trained on the DNS server images are presented, where each vertex represents a particular resolution. Note that the resolution is increased clockwise, starting at the top middle vertex with a grayscale resolution of 180×180×1. As can be seen, 95.5% was the highest accuracy obtained; this was achieved by the Xception model trained on RGB images with an input resolution of 280×280×3. In fact, Xception outperformed the rest of the CNNs at the four lowest resolutions, but as the resolution reached 256×256×1, it was bypassed by the ResNet50V2, both in grayscale and RGB modes. However, for the two highest resolutions, Xception also outperformed the other models. By reviewing the trends in the results, it can be inferred that increasing the image resolution does not ensure improved detection results.

The scores achieved for each resolution examined were aggregated and descriptive statistics based on the other metrics were calculated: AUC, TPR, and FPR. In FIG. 39, the results on the DNS server across all resolutions are summarized, and the average, sample standard deviation (SD) and the range of result values achieved by each CNN for each metric. In the SD column, the colors green and red are used to indicate more extreme variance (the darker the green, the lower the variance; the darker the red the higher the variance (In FIG. 39, in the SD column, the number 17.96 is highlighted in dark red, the number 5.97 is highlighted in light red, and numbers 0.3, 1.26, 0.3, 0.9, 2.51, 0.48, 0.9, 2.9, 1.28, and 0.8 are in shades of green). As a result, when considering the standard deviation (SD) of the inter-resolution performance, it can be seen that the ResNet50V2 model is more robust and consistent across the different resolutions and metrics, which suggests its high performance.

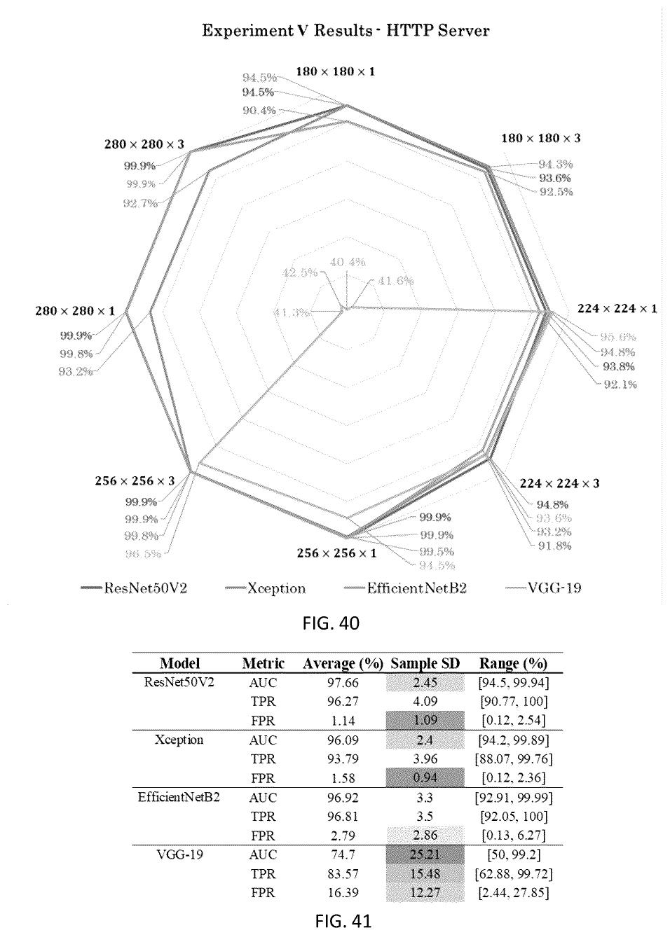

Reference is made to FIG. 40, which shows an octagonal spider chart of detection accuracy as a function of image resolution on the HTTP server (results of experiment V), in accordance with some embodiments of the present invention, and to FIG. 41, which shows a table of the summary of the results obtained in experiment V on the HTTP server, in accordance with some embodiments of the present invention. (In FIG. 41, in the SD column, the numbers 25.21, 15.48, 12.27 are shades of red, and numbers 2.45, 4.09, 1.09, 2.4, 3.96, 0.94, 3.3, 3.5, and 2.86 are in shades of green).

This experiment's results for the HTTP server configuration are presented in FIG. 40. As can be seen, by going from the lower middle vertex clockwise, both ResNet50V2 and EfficientNetB2 outperformed the rest of the models with an accuracy of 99.9% for the following resolutions: 256×256×1, 256×256×3, and 280×280×3, while Xception obtained the highest accuracy for the two lowest resolutions. VGG-19 was able to learn discriminative representations which led to higher detection rates for the range of resolutions between 224×224×1 and 256×256×3, however for half of the other resolutions examined, VGG-19 obtained significantly lower and poor detection rates.

As shown in the summary of results for the HTTP server setting presented in FIG. 41, when considering the standard deviation of the inter-resolution performance, the Xception model is more robust and stable than the other models. In contrast, VGG-19 has the most volatile scores; thus, its ability to learn representative features across the different resolutions and metrics is less stable, which suggests its inconsistent performance.

13. Experiment VI—Detection of Unknown Malware in Another Unseen Virtual Server

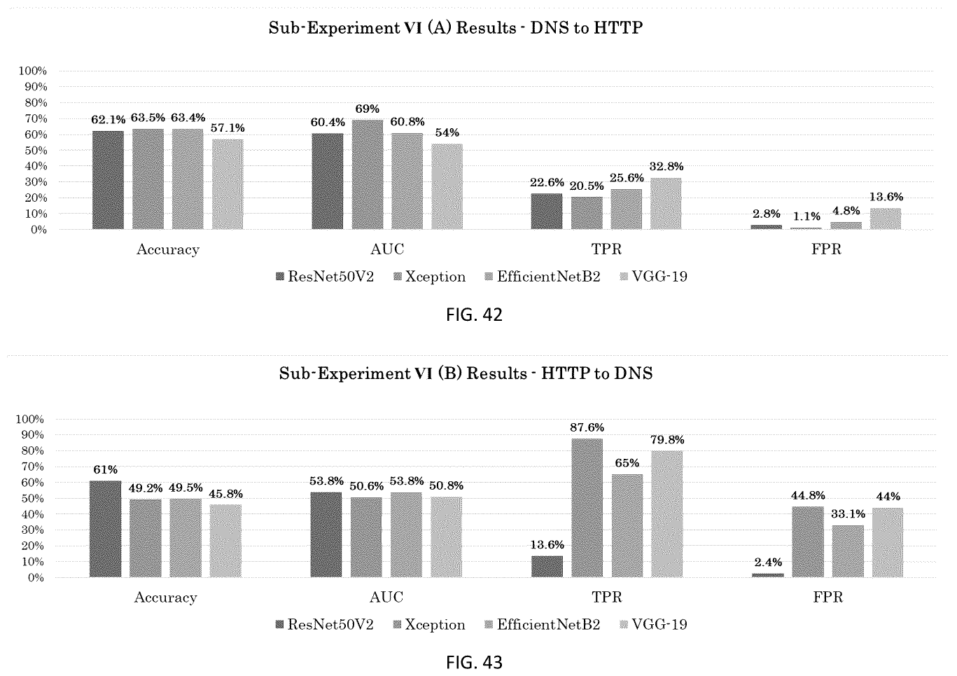

Reference is made to FIG. 42, which shows bar graphs of unseen malware detection by training on the DNS server and testing on the HTTP server (results of Sub-Experiment VI (A)), in accordance with some embodiments of the present invention.

In Experiment VI, the CNN models' ability to detect unknown malware by training on one type of server and testing on the other server was tested. In the first sub-experiment (A), Experiment II was repeated and each model trained on images captured from the DNS server and tested on images of unseen samples captured from the HTTP server. FIG. 42 below shows that after training on images from the DNS server, none of the CNN models could fully detect unseen malware captured from the HTTP server. The Xception model achieved the highest results with an accuracy of 63.5%, along with an AUC of 69%, and an FPR of 1.1%. However, its TPR (20.5%) was the lowest over the rest of the models.

Reference is made to FIG. 43, which shows bar graphs of unseen malware detection by training on the HTTP server and testing on the DNS server (results of Sub-Experiment VI (B)), in accordance with some embodiments of the present invention.

In the second sub-experiment (B), in which the CNNs were trained on images captured from the HTTP server and tested on images of unseen samples captured from the DNS server, the detection results were poorer than those in the abovementioned scenario. As shown in FIG. 43 below, most of the CNNs performed poorly, with accuracy below 50%; ResNet50V2 outperformed the rest, obtaining the following results: accuracy=61%, AUC=53.8%, TPR=13.6%, and FPR=2.4%. In the last sub-experiment (C), the CNN models were trained and tested on images captured from both servers, with the test set consisting of images from unseen samples.

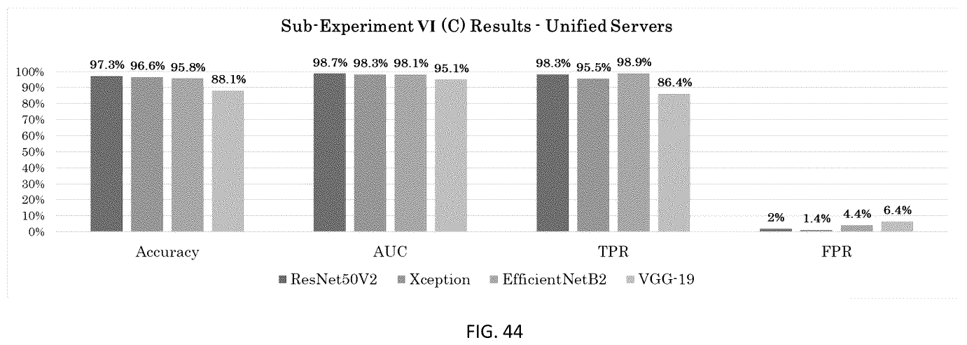

Reference is made to FIG. 44, which shows bar graphs of unseen malware detection by training and testing on both servers (results of Sub-Experiment VI (C)), in accordance with some embodiments of the present invention.

As seen in FIG. 44 below, the detection rates significantly improved compared to the results obtained in the previous two sub-experiments. All of the CNNs achieved high detection rates, except for the VGG-19, which had slightly lower rates. ResNet50V2 had the best results with an accuracy of 97.3%, along with an AUC of 98.7%, and a TPR of 98.3%. However, it had a slightly higher FPR of 2% compared to Xception model achieved an FPR of 1.4%. To examine the results more closely and compare them to the results obtained in Experiment II, the best detection rates obtained by ResNet50V2 in Experiment II was used and calculated the average across both servers (this allowed us to compare the results with the detection rates obtained in the third sub-experiment (C) of Experiment VI with unified servers), obtaining the following averaged scores: accuracy of 96.35%, AUC of 97.25%, TPR of 95.35%, and FPR of 1.45%. This detection rate comparison shows that for most metrics, the results obtained by the ResNet50V2 model in the third sub-experiment of Experiment VI are slightly higher than the average metrics calculated based on the results of Experiment II. However, in the case of the FPR, the FPR obtained in the unified server experiment was slightly higher than the averaged FPR obtained in Experiment II.

14. Experiment VII—Detection of Unknown Malware Using Transfer Learning

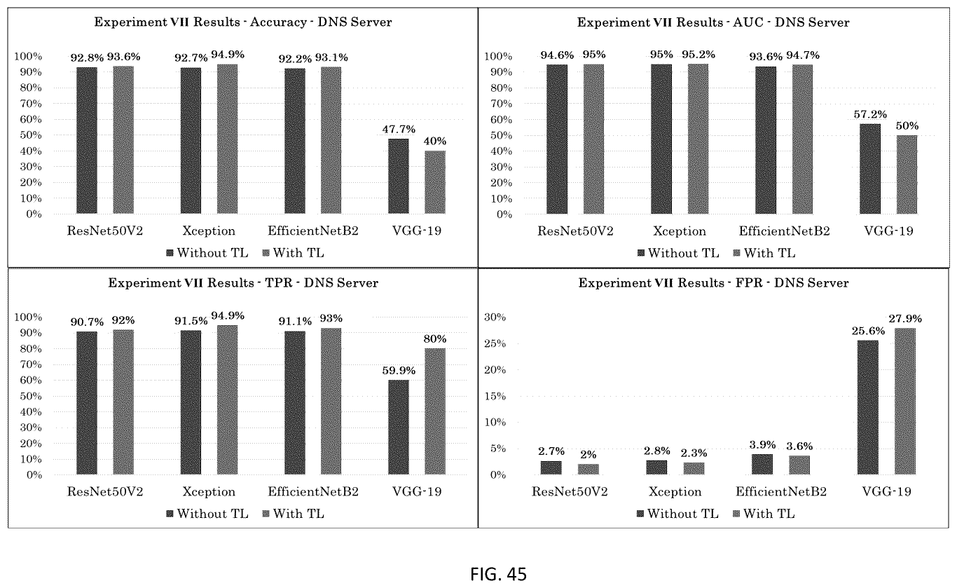

Reference is made to FIG. 45, which shows bar graphs of transfer learning on the DNS server (the results of experiment VII), in accordance with some embodiments of the present invention.

Experiment VII was performed to evaluate the detection rates of the CNN models when transferring knowledge from another domain. In addition to the results in the current experiment, the results were compared with those obtained in Experiment II to determine whether transfer learning improves the detection rate. FIG. 45 presents the results on the DNS server configuration; based on the results presented, it can be inferred that when using knowledge transfer the detection rates were slightly better for most CNN models, with the exception of the VGG-19 model. The Xception model achieved the highest results for the following metrics: accuracy=94.9%, AUC=95.2%, and TPR=94.9%. These scores were 0.2 to 3.4% better due to the use of transfer learning. However, after conducting a one-way ANOVA test followed by an independent t-test with significance level of 5%, the differences observed between the folds is not convincing enough to say that the average AUC of the Xception model trained both with or without TL differs significantly. It also noted that for most of the metrics, the VGG-19 model performed less effectively when TL was used (the exception to this are the TPR and FPR—the VGG-19 obtained a higher TPR score, followed by a higher FPR).

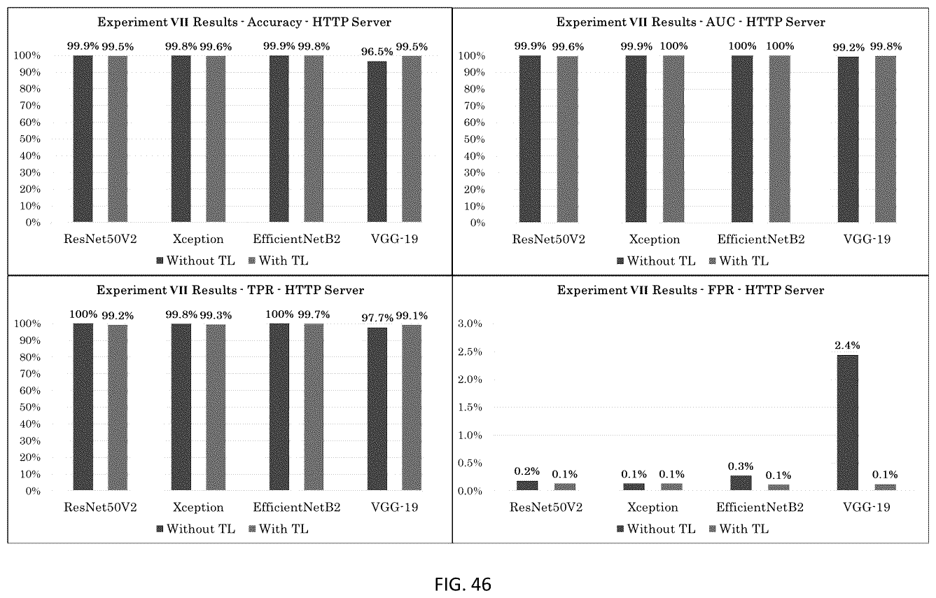

Reference is made to FIG. 46, which shows bar graphs of transfer learning on the HTTP server (the results of experiment VII), in accordance with some embodiments of the present invention.

The results of this experiment with the HTTP server configuration are presented in FIG. 46 below. The positive impact TL had in the DNS server case decreased slightly in terms of the accuracy and TPR for most of the models trained from scratch in the case of the HTTP server. However, in terms of the AUC and FPR scores, there was slight improvement due to the tradeoff in which by lowering the TPR, the FPR can be controlled and reduced simultaneously. Also, knowledge transfer slightly improved the VGG-19 detection scores on all four metrics compared to Experiment II, and EfficientNetB2 outperformed, with the following scores: accuracy of 99.8%, AUC of 100%, TPR of 99.7%, and FPR of 0.1%, although it had lower results compared to those achieved in Experiment II (i.e., without TL). However, after conducting a one-way ANOVA test followed by an independent t-test with significance level of 5%, the differences observed between the folds is not convincing enough to say that the average AUC of the EfficientNetB2 trained with or without TL differs significantly.

### V. Coping with Possible Attacks

Many software systems have vulnerabilities that can lead to zero-day attacks if they are not discovered during the system development or maintenance phases. These vulnerabilities open loopholes that make it easier for a hacker who is interested in harming and disrupting the system's detection mechanism to compromise its reliability and accuracy. In the case of intrusion detection systems, such loopholes can be exploited and affect individuals and organizations' computing systems, leading to information loss, financial risk, damaged reputation, etc. As discussed earlier, the proposed Deep-Hook framework consists of two main modules: trusted volatile memory acquisition and deep learning-based malware detection.

According to some embodiments, the disclosed framework is not active learning-based; therefore, a hacker will be unable to interfere with the data labeling or the detector's training process. Therefore, the framework's CNN detectors cannot be tuned, modified, or disabled by a malware under inspection. Also, since Deep-Hook is an hybrid analysis-based framework, sophisticated malware with obfuscation techniques based on manipulating binary code, does not affect Deep-Hook's detection capability, as once the malware is executed, its code is directly loaded to the volatile memory (unpacked, obfuscated, and unencrypted). However, as is known in the cyber-security domain, there is an infinite race between attackers and defenders, an attacker might find a vulnerability and employ an adversarial attack aimed at misleading the proposed detection mechanism, as an attacker could do in the case of other detection mechanisms as well.

As with the GIGO principle mentioned earlier, the framework can be mapped to a data analysis pipeline, in which a given stage's input directly affects the output obtained, which is then fed as the input of the next stage and so on. Therefore, a fault in the input of one of the stages will permeate throughout the whole pipeline, and will eventually lead to poor a detection capability. In the case of the proposed framework the sampled application is executed in the VM, affecting its volatile memory, which is then acquired by the hypervisor as an ELF and finally converted to a visual image. For the task of malware detection, the output visual image is used as an input for the pretrained CNN detector. Therefore, in the case of an adversarial attack, for a detection model to intentionally detect and classify malicious files as benign, the input image must be skewed, respectively. There are two ways for an image to be skewed: by masking the volatile memory in a way that affects the dump itself (by creating malware that does so), and thus, influence the converted image; or by manipulating the image after its conversion.

A black-box adversarial attack that does not require any knowledge regarding the DL-based model internals or its training data—in this attack, the attacker trains a local model to replace the target network, using adversarial inputs that are synthetically generated and labeled using the target DNN. Hence, it relies on the assumption that the attacker can retrieve the labels assigned by the target DNN based on his chosen input. In the context of the proposed framework, such trained local model can be used to generate adversarial examples and to replace the real image converted from the memory dump with the adversarial examples. Since Deep-Hook acquires volatile memory dumps sequentially over time, it is less likely that a hacker will be able to synchronize her actions with the phases of the framework in order to interfere with the dump's conversion to an image, prior to the detection phase in which the image is fed as input to the CNN detector.

Another black-box attack, in which adversarial malware examples were generated using a generative adversarial network (GAN) may be used to bypass black-box ML-based detection models. Similar to the abovementioned scenario, an attacker can generate adversarial examples by training a local GAN-based model on its computer. In contrast, this attack is no different from the attack mentioned earlier. Although it uses GAN to generate more robust adversarial examples, it does not affect its ability to interfere with or gain control over Deep-Hook's mechanism.

In a mimicry attack, another type of adversarial attack, an attacker codes a sophisticated malware that mimics a benign application's behavior without eliminating its malicious mechanism. For instance, a mimicry attack based on a benign system's call traces that could evade detection. Similar to the system's call traces, by mimicking knowledge-based features such as API calls, processes, and other features expressed in the volatile memory. Hence, in the case of Deep-Hook, the acquired dump's true nature can be masked and skew the resulting image. However, unlike the knowledge-based features which are easy to manipulate, Deep-Hook encapsulates the whole memory dump in a visual image without the need to extract features using memory forensic techniques. Due to the visual encoding procedure and the fact that DL suffers from the lack of explainability disadvantage, such disadvantage from a data scientist perspective can be leveraged as advantages from the defender's perspective, thus making it much harder for an attacker to mimic and affect Deep-Hook's detection mechanism.

### VI. Discussion And Conclusions

According to some embodiments, disclosed herein is Deep-Hook, a novel deep learning-based framework for trusted detection and classification of unknown malware in a Linux cloud environment. Deep-Hook simulates DNS or HTTP servers' activities by generating client-server requests between two Linux-based virtual machine instances. To perform trusted analysis, Deep-Hook runs the inspected application separately in the virtual environment of the virtual server, which is isolated from the host. Simultaneously executing the examined application, it leverages virtualization technology by dynamically capturing volatile memory dumps through time in a trusted manner using the hypervisor. Deep-Hook's methodology is considered trusted, since the malware running on the virtual machine is unaware of the inspection process and cannot evade, sabotage, or deactivate Deep-Hook.

After acquiring the volatile memory dumps from the inspected virtual machine and saving them as ELF files, Deep-Hook slices the ELF header from each memory dump. Then, Deep-Hook converts the sliced dump to an RGB image. Due to this visual transformation, the volatile memory dump's size is reduced drastically from 1 GB to 20 KB, a 99.99% size reduction that reduces the amount of both storage and memory used. The resulting images encapsulate the behavior of the inspected virtual servers and the examined application and contain footprints that can reveal their true nature, whether malicious or benign.

The task of unknown malware detection was addressed by training state-of-the-art convolutional neural networks from scratch on the image dataset. The CNN architectures examined were: ResNet50V2, Xception, EfficientNetB2, and VGG-19. These CNN architectures were modified for the task by slicing out their last fully connected layers and replacing them with a global average pooling layer, followed by a prediction layer. The prediction layer's activation function was set to sigmoid for binary classification and softmax in the case of multiclass classification. To enable the CNNs to learn useful representations, the best set of hyperparameters was searched by tuning and optimizing each architecture separately, using the cross-entropy or categorical cross-entropy loss functions, depending on the classification type. Also, approximating a function from sparse images is challenging, and a classical way to solve it is to use the regularization theory. Therefore, in most networks, regularization techniques were also applied such as L2 regularization and dropout to prevent overfitting. The hyperparameter configurations used are presented in Table 6 in the appendix.

According to some embodiments, Deep-Hook's snapshotting module is utilized in order to acquire volatile memory dumps from the virtual machine. After validating thousands of benign and malicious applications, 56 valid applications were selected from each class to produce a representative, heterogeneous, and balanced sample of 112 benign and malicious applications. These applications were executed on each virtual server and captured 100 volatile memory dumps at an interval of 10 seconds between each dump using the snapshotting module. As a result, a dataset including 11,200 images converted from the captured volatile memory dumps for each type of server: DNS and HTTP were created, resulting in a total of 22,400 images used to train and validate the CNNs during the evaluation process.

According to some embodiments, as detailed herein, the evaluation process included seven experiments of different difficulty levels. Experiments were conducted using the K-fold cross-validation procedure with minor modifications in the number of folds and data split function, depending on the nature of the experiment. In the first experiment on known malware detection, the highest accuracy achieved by both ResNet50V2 and Xception was 99.4% with the DNS server configuration. In contrast, in the HTTP setting, 100% accuracy was achieved by all CNNs except VGG-19. In the first experiment it was inferred that the CNNs examined could learn useful representations and distinguish between known benign and malicious applications. As a result, Experiment II, in which the task was to detect unknown benign and malicious applications was preformed.

According to some embodiments, Experiment II it represents a more realistic scenario where an intrusion detection system (IDS) encounters an application that it has never seen before. This experiment showed that the ResNet50V2 achieved the best accuracy of 92.8% with the DNS server configuration. Based on its AUC score of 94.6%, it was realized that the accuracy could be increased by tuning the detection threshold, although this was bound to affect the tradeoff between TPR and FPR. In the HTTP case, however, both ResNet50V2 and EfficientNetB2 resulted in a near-perfect accuracy of 99.9%. When reviewing these results, it was noticed that there was a gap of 7% in the servers' detection rates in favor of the HTTP. As a result, it was concluded that the HTTP server's networks were capable of learning more representative features that contributed to better generalization of unseen applications and led to more accurate detection than the DNS server. Moreover, the client-server requests generated from a DNS server have greater impact on masking the malicious activity in the volatile memory than the requests generated from an HTTP server. Despite the gap, this experiment showed that most of the CNNs could generalize and detect unseen malware for both servers successfully.

Experiment III was performed to challenge the CNNs' generalization capability, and it was focused on the models' ability to detect an unknown malware family. It is noted that malware families are distinguished by their goals, which are achieved through different mechanisms with corresponding actions; in light of this, a model's ability to generalize and detect malware families that have not been seen before based on other types of malware families is a more challenging task. Despite this challenge, the DNS server's results of most CNNs were almost perfect, with the Xception model obtaining in an accuracy score of 99.5%. Further, all of the networks, except the VGG-19, had a perfect 100% score in the HTTP settings. As a result, it was concluded that the features learned from different malware families were informative enough to enable perfect generalization of unknown malware families. This ability stems from the fact that malicious families share some similarities in their behavior, causing anomalies that are expressed differently in the virtual machine's volatile memory than those of benign applications. Thus, given a new malicious family, the models still successfully detect an anomaly in the volatile memory and are able to distinguish it from how an innocent application runs.

As discussed above, in addition to malware detection capabilities, an IDS may also have the ability to disable the malicious process, so as to minimize system damage as much as possible. To trigger this functionality in the IDS and enable it to perform the desirable set of mitigation operations, the type of malware injected must first be identified. As a result, in Experiment IV, the CNNs' ability to classify the type of malware family was tested. In the DNS server setting, both Xception and EfficientNetB2 outperformed the other models, with 99% accuracy. Xception also achieved 99.9% accuracy in the HTTP setting. Based on the results, it was inferred that the CNNs were fully capable of classifying the nine different types of malware families examined (Ransomware, APT, Cryptojacker, Worm, DDoS, Trojan, virus, Botnet, and Rootkit). Thus, in addition to demonstrating the models' detection capabilities, it was also shown that they can successfully identify the type of malicious family to which the app belongs in order to activate recovery mechanisms accordingly.

The additional three experiments were used to further evaluate Deep-Hook's capabilities further. Resulting from the fifth Experiment it can be concluded that: First, in the DNS server case, using an increased resolution of 280×280×3, Xception achieved higher accuracy of 95.5% compared to the 92.7% accuracy it obtained in Experiment II for the baseline resolution of 256×256×3. However, by using a lower resolution of 224×224×1, Xception's detection rates also improved as it obtained 95.3% accuracy. Second, in the HTTP setting, the highest results for all four CNNs were achieved using a resolution of 256×256×3. Based on the last findings, it is concluded that the detection rate does not necessarily improve when the image's resolution is increased. Third, for all eight resolutions, VGG-19 was not able to learn representative features for effective detection on the DNS server, unlike the HTTP server, where it was able to achieve good results given a resolution in the range between 224×224×1 and 256×256×1. Fourth, for both servers, ResNet50V2 and Xception were more robust to the input image resolution changes than the other two networks. In addition, by comparing the values of the sampled standard deviation presented in FIG. 39 and FIG. 41, it can be seen that all of the CNNs were more robust to the changes in image resolution in the DNS case. Hence, for each CNN, its standard deviation values for each metric in the DNS case were lower than those of the HTTP case.

The results of the first two sub-experiments of Experiment VI, i.e., (A) & (B), imply that CNNs find it challenging to detect unknown malware run on a server that is different from the server trained on it. Although the generalization capability between different servers was limited, in the case of sub-experiment (A), where the CNNs were trained on a DNS server's images and tested on those from an HTTP server, a slightly higher accuracy of 63.5% using the Xception model was obtained, compared to the opposite case in which the highest accuracy was 61%, achieved by the ResNet50V2 model. Based on this finding, despite the limited generalization, it may be concluded that the representations learned by the networks trained on the DNS server were slightly more representative and had a better capability to generalize than those learned by training on the HTTP server's images. In the last sub-experiment of Experiment VI, however, the networks were trained on both servers and tested on unknown malware captured from both. In this case, all of the models obtained better detection rates, with ResNet50V2 outperforming the others with the following scores: accuracy=97.3%, AUC=98.7%, TPR=98.3%, and FPR=2%; as expected, the TPR increased and the FPR decreased simultaneously.

In Experiment VII, it was examined whether using transfer learning improves the CNNs' detection rates. Networks trained from scratch on the dataset which included 11,200 images for each server with networks pretrained on over 14 million images taken from the ImageNet database. Despite the drastic differences in the amount of training data, results showed that transfer learning does not significantly improve detection. This implies that the use of the proposed method, without the use of TL, is more efficient than a method that combines the proposed method with TL. This may be due to the fact that the study's visual domain, in which the inspected virtual machine's volatile memory is represented in the form of images, has a significantly different nature than the nature of the domains of the images in the ImageNet dataset.

As shown in most of the experiments, ResNet50V2, Xception, and EfficientNetB2 had higher detection rates than those of the VGG-19. These results stem from the fact that the VGG-19 has many more trainable parameters than the other CNNs examined. In addition, the other networks use more advanced techniques to learn more complex features than the VGG-19. For instance, in the ResNet50V2, the residual blocks make it possible to increase the network's depth and thus learn more complex features. However, the Xception network learns better representations by using inception blocks, which enable the concatenation of several operations performed on a particular input. Also, Xception uses depthwise convolutions that convolve each channel separately and therefore, store information regarding each channel instead of convolving several channels together. The advantage of EfficientNet networks is primarily due to their use of a compound scaling technique in which width, depth, and resolution scaling are combined and modified as a function of the input resolution; note that the EfficientNetB2 learned satisfactory representations much faster than the other networks in which the number of epochs was doubled or tripled, as shown in Table 6 in the appendix.

The insights mentioned above shows how the proposed framework has many advantages and overcomes most of the limitations of traditional malware analysis methods and other modern approaches. Deep-Hook is a trusted and hybrid-based solution that can be used to detect malware that relies on obfuscation techniques to avoid detection, since the malicious code is loaded to the volatile memory directly and can then be detected by Deep-Hook. The experiments showed that Deep-Hook can inspect and detect malicious activities executed from different types of files such as ELF, SH, JPG, PDF, and XLSX files. Deep-Hook is fully capable of detecting known and unknown malware on both DNS and HTTP servers and can classify nine types of malware families and detect unseen applications belonging to an unseen malware family. It is important to emphasize that none of the framework's capabilities require feature engineering, and thus, it does not require domain experts' intervention. As a result, it saves time and costs.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

APPENDIX I - Benign Samples

| id | SHA 256/Name | Program Version |
|---|---|---|
| 1 | 5f7b518e2a86e49375d04af5f5e1d8a6fbf7bbe3923b1e459edbc409887dcf15 | acct 6.6.4 |
| 2 | all_files_backup | Built in Ubuntu 18.04.03 |
| 3 | fabfab8fda9175377b8ff068b0a3c415d1de3609e7167c5e7f2a9274fd8f56eb | atop 2.3.0 |
| 4 | badlock | Built in Ubuntu 18.04.03 |
| 5 | baseline | |
| 6 | e5ad9f6248842db9ece8f1a453522337bb6ff2a1c9cc8429b39ce3f9bc3ab9a0 | bmon 4.0 |
| 7 | clean_vm | |
| 8 | copy_delete_files | Built in Ubuntu 18.04.03 |
| 9 | defragr | Built in Ubuntu 18.04.03 |
| 10 | download_10 gb | Built in Ubuntu 18.04.03 |
| 11 | download_1 gb | Built in Ubuntu 18.04.03 |
| 12 | exel_download_and_open | Built in Ubuntu 18.04.03 |
| 13 | file_search | Built in Ubuntu 18.04.03 |
| 14 | c338e2e25d1b6f51d397af154a0124fc42eee6b7ff99a2d976777d6b2f97c096 | ftptop 1.3.6 |
| 15 | github_downloads | Built in Ubuntu 18.04.03 |
| 16 | 9a54db7f062a58d3fd5aa20b775d19c6fddc55ff950e7d2f4010970daa02f0cc | Gnome System Monitor |
| | | 3.8.2.1 |
| 17 | ee60657b044ece0df096c053060df7abf3cce3a568ab34d260049e6a37ccd8a1 | htop 1.0.2 |
| 18 | d032547c708307159ff5fd0df23ebd3cfa7799c31536fa0aea1820318a8e0eac | iftop 0.17 |
| 19 | install_java_jre_jdk | Built in Ubuntu 18.04.03 |
| 20 | install_python | Built in Ubuntu 18.04.03 |
| 21 | install_ruby | Built in Ubuntu 18.04.03 |
| 22 | 1a7c02fd3758bb048d8af861c5f8735eb3ee9abadeaa787f27b8af2b1eaee8ce | iotop 0.6 |
| 23 | e9daca4244d7c579db2b85ea523d287107eb8f1d3a9ad1dbc1d539e6643fa44b | jnettop 0.13 |
| 24 | jpg_download_and_open | Built in Ubuntu 18.04.03 |
| 25 | lshw | Built in Ubuntu 18.04.03 |
| 26 | lsof | Built in Ubuntu 18.04.03 |
| 27 | mp4_download_and_open | Built in Ubuntu 18.04.03 |
| 28 | 51a9ce2e4c6789582a0861818433788a65f2570de3ca1b1de32942c6726cd3ff | mpstat - tool inside sysstat |
| | | 11.6.1 |
| 29 | 129281e1120330df501e7d34f0cc52637fc0bfb933b1d1a844d2d1ddc8a192d4 | multitail 6.4.2.3 |
| 30 | 6232dd6a19bb3001016cb3f300f30f0833a76a312fea97a38467b2aa7e044666 | nethogs 0.8.5 |
| 31 | 1fbcc55ab416c9caa2584cba8862aa1fbf6b3d0675fcae7727abedd2131f128c | netstat 1.4.10 |
| 32 | 90ea3ffff052f5b75dc7f11741f20edc971dfda51d6dcc8e0d1132a3b330be32 | nload 0.7.4 |
| 33 | nslookup | Built in Ubuntu 18.04.03 |
| 34 | pdf_download_and_open | Built in Ubuntu 18.04.03 |
| 35 | 51a9ce2e4c6789582a0861818433788a65f2570de3ca1b1de32942c6726cd3ff | pidstat - tool inside tool |
| | | inside sysstat 11.6.1 |
| 36 | ping | Built in Ubuntu 18.04.03 |
| 37 | powerpoint_download_and_open | Built in Ubuntu 18.04.03 |
| 38 | 6974e34593eaca998746932eaec549a44aa21883962ebfefb29c283f1485d326 | powertop 2.9 |
| 39 | sar | Built in Ubuntu 18.04.03 |
| 40 | stackoverflow_surf | Built in Ubuntu 18.04.03 |
| 41 | sudo_badblocks | Built in Ubuntu 18.04.03 |
| 42 | sudo_copy_del_files | Built in Ubuntu 18.04.03 |
| 43 | sudo_file_search | Built in Ubuntu 18.04.03 |
| 44 | sudo_top command | Built in Ubuntu 18.04.03 |
| 45 | tar_gz_files | Built in Ubuntu 18.04.03 |
| 46 | tcpdump | Built in Ubuntu 18.04.03 |
| 47 | top_command | Built in Ubuntu 18.04.03 |
| 48 | update_all command | Built in Ubuntu 18.04.03 |
| 49 | vmstat | Built in Ubuntu 18.04.03 |
| 50 | 810f31c0c5b760c816a457fe81e23496761cee3e3024ad84b2443bc9d7681332 | Whowatch 1.8.5 |
| 51 | wireshark | wireshark 3.0.13 |
| 52 | word_download_and_open | Built in Ubuntu 18.04.03 |
| 53 | youtube_surf | Built in Ubuntu 18.04.03 |
| 54 | e2f27f96ee5c373647e758dce72985c225953ee49718c2161eebfcea2c634def | zblacklist - tool in zmap |
| | | 2.1.1 |
| 55 | zip_files | Built in Ubuntu 18.04.03 |
| 56 | e2f27f96ee5c373647e758dce72985c225953ee49718c2161eebfcea2c634def | zmap 2.1.1 |

APPENDIX II - Malware Samples

| id | SHA 256 | Sample Type | File Name | Category |
|---|---|---|---|---|
| 1 | d4077fa7078d8741acbe647cf35a7d7e1fc639ce44e2895478eb7114299c2446 | ELF | Lupper | Worm |
| 2 | 300070a21889d68ed380587d19f56b1e52c25fb55bb6d84131f4643b7e69d370 | ELF | Brundle 100 | Virus |
| 3 | 5685b086ce12ffede8814e303223a67eca476735dfe4e9e84b751354a5ea0232 | ELF | pnscan | Trojan |
| 4 | f2b073ca8cf6eeb98c013a3e54f004d7069628aa23382d8a2ddebd584d4422e3 | ELF | Ganiw | Trojan |
| 5 | 8856a68d95e4e79301779770a83e3fad8f122b849a9e9e31cfe06bf3418fa667 | ELF | Turla | APT |
| 6 | 0b7996bca486575be15e68dba7cbd802b1e5f90436ba23f802da66292c8a055f | ELF | Erbus | Ransomware |
| 7 | 847411ce2be6311d47888dd420cc859a9b46de45ebc1b62e48c74575e6c621fc | ELF | Millen | Worm |
| 8 | c3d70fb8f469bcc633d11576f8da8f23f764d56c8db700929a10f3f91ad2c97c | ELF | Binom | Virus |
| 9 | 9ad4559180670c8d60d4036a865a30b41b5d81b51c4df281168cb6af69618405 | ELF | Linux.lady | CryptoMiner |
| 10 | 7bbf4661b0a1e17080ad9b73b1756d5c761e478751834ba62127197e5ab0ca47 | ELF | Gafgyt | DDOS-Trojan |
| 11 | 0159c232e9bdd983f8280211c6a4b23a83d735dabc768022876b44dbbf17c482 | ELF | Worm | Worm |
| 12 | 62bd9fc8faeda5e30210b36bb83641dd044c4f2c88729f10d4cfaa88591efe7c | ELF | Lupper | Worm |
| 13 | eedc925e917a814aa51544be881427be5a374f7c06ed60e88a60c776504374cf | ELF | brundle | Virus |
| 14 | 94b59b4761147519fecf662cecba7219ac2f70682ae02685081a181758cb705f | ELF | xarcen | DDOS-Trojan |
| 15 | 7a46287caf9a877ceab3728eee3e1f8410bb8e5869496e07a833cfa3e80b4be1 | ELF | b.binom | Virus |
| 16 | 50e3c0c9f6827aa3b6a8922e7b5d892fe69cb542af4d5c0f745f6ea92afe3f02 | ELF | gates | Trojan |
| 17 | 082c1eb6e9d0a12779f7474a328aa80dd2ae51634a892a1a9be4dab538ec775b | ELF | Xorddos | DDOS-Trojan |
| 18 | 710d21e97acb9ce048313445779327483096a8da928b46b5f806f250ad68182b | ELF | Gafgit | Trojan |
| 19 | 48b6a2d3be67cd4ad7964bfe426906ed65c989154397c0103a12578855a57778 | ELF | Corne | Trojan |
| 20 | bcaa006c5d87e387d3e2821c384afb0f11ca4817f56ba5835d8b0b4ea7681e9c | ELF | DDOSZanich | DDOS-Trojan |
| 21 | c8d19e28e93cc5f8eb3bfe15312d49f3e5c606d1e93c37c978fca7affe7b6a8a | ELF | Chinaz | Trojan |
| 22 | 22d31e88d6cd68db06ad2e97f5237a490be52212922341939ffdaabeab146b7c | ELF | DDOSFLood | DDOS-Trojan |
| 23 | 3407647f7df3d0a436e335833e258c74a7bd19bdb416b4e0dcb844c8429cb0ad | ELF | Mr.black | Trojan |
| 24 | 25d0ce215296bf3bba955263e30a53fd8f5ff91964ac9b731c3356ebd80732a8 | ELF | Tsunami | DDOS-Trojan |
| 25 | 4a5d98f551781b4f3902e838998af3e641d54437a384381426ad9099f3348c97 | ELF | Trojan | Trojan |
| 26 | c3e1db9e9fac3f8b2b6a2f61dea9a52188859e0f38f7cfd8bfed1601387326af | ELF | Mayday | Trojan |
| 27 | 648d4873b56e45b558ebd6d70bc4a2989652ca1ad12d3de635caf0b1b524d243 | ELF | Bitcoinminer | CryptoMiner |
| 28 | 3aaddf223d226a658250df2b061400ab90ed258baf15c63aaca959a49d01bdd0 | ELF | coinminer | CryptoMiner |
| 29 | 0934e478b2b750604f04f009545345991a7b84226745bf827eefbadf4a3181ba | ELF | Mirai | Botnet |
| 30 | 2e01b43c99a7b2d7f80048ef15b5d8f69eab09efcddea83aed0989c911165f9d | ELF | DirtyCow | Trojan |
| 31 | d38b3f6d228638ad9046985d388b62066d2249397c4aa85f7cd12d929129d445 | ELF | BilGates | Botnet |
| 32 | d9ba655a98b2dafdfa6944cadbb7b43f38813efadf4922abe8df968b48664f81 | ELF | Gafgyt | DDOS-Trojan |
| 33 | e651a05c9cb0bde4e8efa635f699ba3e186afd4ae4c42760e3d97ffa01d8c8ca | ELF | miner | CryptoMiner |
| 34 | f069de0b199a5ad2f0ad8e073f673e8215a3f71f7bd0c46c7e5d2b16d9da240d | ELF | bitcoinminer | CryptoMiner |
| 35 | f0d74efc090a1edaf37d02070ad9dbacfc019a37bb7a7001f3452b926e72469f | ELF | ddos | DDOS-Trojan |
| 36 | f22ffc07e0cc907f00fd6a4ecee09fe8411225badb2289c1bffa867a2a3bd863 | ELF | Tsunami | Trojan |
| 37 | f6061366a07493b5a0dbeac5d7d519645e43449ebe6ff4e6a3ad49c4cada0020 | ELF | coinminer | CryptoMiner |
| 38 | f824ade2ac815649b8a8f9513750248901b3c04542a4d7fc36082bdac27703dd | ELF | mayday | Trojan |
| 39 | cb4ac652729f1a6c47773b74cb20cc0fd9ba311912f6d3082c7e12dfc0d99571 | ELF | CoinMiner | CryptoMiner |
| 40 | 19d689743cc8788e8f6ed41f591b4f27dab2d58faa90b99cdcf2a180ab876b77 | ELF | Linux OSF | Virus |
| 41 | 9d0bfa6a3c99f83bb6d9fb4822855c488dedd3a9a2fe19010e0e176437422b04 | pdf | CryptSky | Ransomware |
| 42 | 690aea53dae908c9afa933d60f467a17ec5f72463988eb5af5956c6cb301455b | ELF | Miner.W | CryptoMiner |
| 43 | ccfbb75b28f7758816994b63db4846e70187a25cb2cc5183f1000bbb7f7b496f | ELF | Agent.DJQ | CryptoMiner |
| 44 | d79ba019d128b30e7548402abcc5d6e5dd2a8a3be55a00dc4c635f8a798aebe2 | ELF | BitCoinMiner | CryptoMiner |
| 45 | 04c587db92e7dc20ee5b6203357909f0075e11aa1088cca98d24652b5cc8351a | ELF | Miner.DO | CryptoMiner |
| 46 | 1f2c76173c7a1fbb6b28c6b9e0b8bceccbbbf2bea07518f71eb8cf21d13c7ac7 | ELF | Miner.C | CryptoMiner |
| 47 | 0fc212c619ca96818cabd71e011dea965cdf401f20f948b7a3c1ffbd02473eb4 | jpg | JS.Iframe.AGG | Trojan |
| 48 | 4dcbda0f4630169f3b89c389415b5f2f32010e8fe039d3387dc0ac92dae1fc07 | xlsx | KD.43215812 | Trojan |
| 49 | c8feab3948a2bb5bca520f7f5423620974537e276f8418062933d743d160bf30 | pdf | Alien.A480!tr | Trojan |
| 50 | fbe267e0845f65a4f5831e7b668f06911d57ab604c013943563ce61d7ee9f922 | pdf | Arte m is | Trojan |
| 51 | DDoS | file-less | | file-less attack |
| 52 | DNS Spoffing | file-less | | file-less attack |
| 53 | 0b805e62934835946611f54ec8abf458303199a9e502ff03d21b49e1e090b766 | file-less | Js webcom | CryptoMiner |

APPENDIX III
The Feature Set

| ID | Potential Behaviors | Feature name | Description | Type | Data Source | Volatility Plugin |
|---|---|---|---|---|---|---|
| 1 | Generic Behavior | arp_amount | number of arps in arp table | int | network | linux_arp |
| 2 | Information Gathering | arp_mac_no_ip | percent of mac without ip in arp table | float | network | linux_arp |
| 3 | Persistence | crone_bash | number of crontab command in | int | processes | linux_bash |
| | | | bash history | | | |
| 4 | processes Interaction | sh_bash | number of sh command in memory | int | processes | linux_bash |
| 5 | processes Interaction | sed_bash | number of sed command in memory | int | processes | linux_bash |
| 6 | processes Interaction | cp_bash | number of cp command in memory | int | processes | linux_bash |
| 7 | processes Interaction | rm_bash | number of rm command in memory | int | processes | linux_bash |
| 8 | processes Interaction | grep_bash | number of grep command in memory | int | processes | linux_bash |
| 9 | processes Interaction | ps_bash | number of ps command in memory | int | processes | linux_bash |
| 10 | processes Interaction | insmod_bash | number of insmod command in memory | int | processes | linux_bash |
| 11 | processes Interaction | chmod_bash | number of chmod command in memory | int | processes | linux_bash |
| 12 | processes Interaction | cat_bash | number of cat command in memory | int | processes | linux_bash |
| 13 | processes Interaction | iptables_bash | number of iptables command in memory | int | processes | linux_bash |
| 14 | Generic Behavior | tcp_udp_change | number of TCP/UDP stuctures modified | int | network | linux_check_afinfo |
| 15 | Required Privileges | elevated_priviliges | number of processes with elevated | int | kernel | linux_check_creds |
| | | | privileges | | | |
| 16 | Generic Behavior | invalid_file_structure | number of invalide files | int | files | linux_check_fop |
| 17 | Generic Behavior | hidden_kernel_modules | mimber of hidden kernel modules | int | kernel | linux_check_modules |
| 18 | Generic Behavior | tty_buf_amount | number of not hooked tty_buf | int | kernel | linux_check_tty |
| 19 | Generic Behavior | tty_buf_hooked_amount | number of hooked tty_buf | int | kernel | linux_check_tty |
| 20 | Generic Behavior | elf_amount | number of ELF in memory | int | processes | linux_ELFs |
| 21 | Generic Behavior | elf_avg | average ELF per processes | float | processes | linux_ELFs |
| 22 | Generic Behavior | elf_max | maximum ELF per processes | int | processes | linux_ELFs |
| 23 | Generic Behavior | elf_median | median ELF per processes | float | processes | linux_ELFs |
| 24 | Generic Behavior | no_elf_percrnt | percent of processes without ELF | float | processes | linux_ELFs |
| 25 | Generic Behavior | usr_elf_amount | number of ELF from the /usr folder | int | processes | linux_ELFs |
| 26 | Generic Behavior | bin_elf_amount | number of ELF from the /bin folder | int | processes | linux_ELFs |
| 27 | Generic Behavior | lib_avg | average lib ELF per processes | float | processes | linux_ELFs |
| 28 | Generic Behavior | lib_max | maximum lib ELF per processes | int | processes | linux_ELFs |
| 29 | Generic Behavior | lib_median | median lib ELF per processes | float | processes | linux_ELFs |
| 30 | Generic Behavior | no_lib_percent | percent of processes without lib ELF | float | processes | linux_ELFs |
| 31 | Information Gathering | active_ARP_dentry | number of /proc/net/arp in the memory | int | network | linux_enumerate_files |
| 32 | Information Gathering | active_networks_dentry | number of /proc/net/route in the memory | int | network | linux_enumerate_files |
| 33 | Information Gathering | active_TCP_sockets_dentry | number of /proc/net/dev in the memory | int | network | linux_enumerate_files |
| 34 | Information Gathering | active_transmission_dentry | number of /sys/class/net/ in the memory | int | files | linux_enumerate_files |
| 35 | Generic Behavior | boot_inode | number of /boot inodes in the memory | int | files | linux_enumerate_files |
| 36 | Evasion | cpu_info_access | number of /proc/cpuinfo in the memory | int | kernel | linux_enumerate_files |
| 37 | Persistence | crone_access | number of crone files from /etc | int | files | linux_enumerate_files |
| | | | folder memory | | | |
| 38 | Required Privileges | cve_2015_1328 | number of files from /proc/sys/kernel | int | kernel | linux_enumerate_files |
| | | | folder in memory | | | |
| 39 | Required Privileges | cve_2016_5195 | number of files from /proc/sELF/mem | int | kernel | linux_emimerate_files |
| | | | folder in memory | | | |
| 40 | Generic Behavior | dev_inode | number of /dev inodes | int | files | linux_enumerate_files |
| 41 | Information Gathering | etc_total_dentry | number of files from /etc folder | int | files | linux_enumerate_files |
| | | | that are in memory | | | |
| 42 | Generic Behavior | home_inode | number of /home inodes | int | files | linux_enumerate_files |
| 43 | Information Gathering | host_conf_access | number of host conf files from /etc f | int | network | linux_enumerate_files |
| | | | older in memory | | | |
| 44 | Information Gathering | localtime_access | number of localtime files from /etc | int | files | linux_enumerate_files |
| | | | folder in memory | | | |
| 45 | Generic Behavior | meminfo_amount | number of /proc mem that are | int | kernel | linux_enumerate_files |
| | | | in the memory | | | |
| 46 | Information Gathering | nsswitch_conf_access | number of nsswitch.conf files from /etc | int | network | linux_enumerate_files |
| | | | folder in memory | | | |
| 47 | Information Gathering | online_CPU_dentry | number of /sys/devices/system/cpu/ | int | files | linux_enumerate_files |
| | | | online in memory | | | |
| 48 | Information Gathering | proc_amount | number of files from /proc folder | int | kernel | linux_enumerate_files |
| | | | in memory | | | |
| 49 | Generic Behavior | proc_inode | number of /proc inodes | int | kernel | linux_enumerate_files |
| 50 | Generic Behavior | proc_uid_amount | number of /proc/uid in the memory | int | kernel | linux_enumerate_files |
| 51 | Evasion | product_name_access | number of /sys/class/dmi/id/ | int | files | linux_enumerate_files |
| | | | product_name in the memory | | | |
| 52 | Persistence | rc_access | number of rc files from /etc folder | int | files | linux_enumerate_files |
| | | | in memory | | | |
| 53 | Information Gathering | resolf_conf_access | number of resolf.conf files from /etc | int | network | linux_enumerate_files |
| | | | folder in memory | | | |
| 54 | Generic Behavior | root_inode | number of /root inodes | int | files | linux_enumerate_files |
| 55 | Generic Behavior | run_inode | number of /run inodes | int | files | linux_enumerate_files |
| 56 | Evasion | scsi_access | number of /proc/scsi/scsi in the memory | int | kernel | linux_enumerate_files |
| 57 | Generic Behavior | sys_indoe | number of /sys inodes | int | files | linux_enumerate_files |
| 58 | Evasion | sys_info_access | number of /proc/sysinfo in the memory | int | kernel | linux_enumerate_files |
| 59 | Generic Behavior | sys_kernel_indoe | number of /sys/kernel inodes | int | kernel | linux_enumerate_files |
| 60 | Evasion | sys_vendor_access | number of /sys/class/dmi/id/sys | int | files | linux_enumerate_files |
| | | | vendor in memory | | | |
| 61 | Generic Behavior | tmp_inode | number of /var/tmp inodes | int | files | linux_enumerate_files |
| 62 | Generic Behavior | total_inode | total number of inodes | int | files | linux_enumerate_files |
| 63 | Information Gathering | interfaces_amount | number of active interfaces | int | network | linux_ifconfig |
| 64 | Information Gathering | promiscous_interfaces_amount | interface in promiscous mode number | int | network | linux_ifconfig |
| 65 | Generic Behavior | private_network_percent | percent of interfaces for private networks | float | network | linux_ifconfig |
| 66 | Generic Behavior | localhost_percent | percent of interfaces for localhost | float | network | linux_ifconfig |
| 67 | Generic Behavior | reserved_memory | number of reserved memory | Mbytes | kernel | linux_iomem |
| 68 | Generic Behavior | system_rom_amount | number of system rom memory | Mbytes | kernel | linux_iomem |
| 69 | Generic Behavior | system_ram_amount | number of system ram memory | Mbytes | kernel | linux_iomem |
| 70 | Generic Behavior | kernel_code_amount | number of kernel code memory | Mbytes | kernel | linux_iomem |
| 71 | Generic Behavior | kernel_data_amount | number kernel data memory | Mbytes | kernel | linux_iomem |
| 72 | Generic Behavior | kernel_bss_amount | number of kernel bss memory | Mbytes | kernel | linux_iomem |
| 73 | Required Privileges | kernel_module_amount | number of loaded kemel modules | int | kernel | linux_lsmod |
| 74 | Required Privileges | is_ip_tables | number of ip_tables module loaded | int | network | linux_lsmod |
| 75 | Generic Behavior | no_open_socket_percent | percent of processes without | float | network | linux_lsof |
| | | | open sockets | | | |
| 76 | Generic Behavior | open_file_amount | number of open files | int | files | linux_lsof |
| 77 | Generic Behavior | open_file_avg | average open files per processes | float | files | linux_lsof |
| 78 | Generic Behavior | open_file_max | maximum number of open files | int | files | linux_lsof |
| | | | per processes | | | |
| 79 | Generic Behavior | open_file_median | median number of open files | float | files | linux_lsof |
| | | | per processes | | | |
| 80 | Generic Behavior | open_socket_amount | number of sockets | int | network | linux_lsof |
| 81 | Generic Behavior | open_socket_avg | average open sockets per processes | float | network | linux_lsof |
| 82 | Generic Behavior | open_socket_max | maximum number of open sockets | int | network | linux_lsof |
| | | | per processes | | | |
| 83 | Generic Behavior | open_socket_median | median number of open sockets | float | network | linux_lsof |
| | | | per processes | | | |
| 84 | Evasion | mount_info_access | number of processes es | int | kernel | linux_mount |
| | | | access /mountinfo in | | | |
| | | | the /proc folder | | | |
| 85 | Generic Behavior | mount_amount | total number of files mounted | int | files | linux_mount |
| 86 | Generic Behavior | sys_mount | number of files from /sys mounted | int | files | linux_mount |
| 87 | Generic Behavior | proc_mount | number of files from /proc mounted | int | kernel | linux_mount |
| 88 | Generic Behavior | boot_mount | number of files from /boot mounted | int | files | linux_mount |
| 89 | Generic Behavior | tmpfs_mount | number of temp files mounted | int | files | linux_mount |
| 90 | Information Gathering | net_conn_amount | number of active network connections | int | network | linux_netstat |
| 91 | Information Gathering | tcp_conn_amount | number of active TCP | int | network | linux_netstat |
| 92 | Information Gathering | udp_conn_amount | number of active UDP | int | network | linux_netstat |
| 93 | Information Gathering | listen_amount | number of listen connections | int | network | linux_netstat |
| 94 | Information Gathering | tmp_conn_amount | number of /tmp connections | int | network | linux_netstat |
| 95 | Information Gathering | established_conn_amount | number of established connections | int | network | linux_netstat |
| 96 | Information Gathering | close_wait_amount | number of close wait status connections | int | network | linux_netstat |
| 97 | Information Gathering | close_amount | number of close status connections | int | network | linux_netstat |
| 98 | Generic Behavior | different_tcp_ports | number of different tcp ports | int | network | linux_netstat |
| 99 | Generic Behavior | different_udp_ports | number of different udp ports | int | network | linux_netstat |
| 100 | Generic Behavior | stack_map_amount | number of [stack] in proc_map | int | processes | linux_proc_maps |
| 101 | Generic Behavior | heap_map_amount | number of [heap] in proc map | int | processes | linux_proc_maps |
| 102 | Generic Behavior | avg_---_flag_per_proc | average --- flags per processes | float | files | linux_proc_maps |
| 103 | Generic Behavior | avg_t--_flag_per_proc | average r-- flags per processes | float | files | linux_proc_maps |
| 104 | Generic Behavior | avg_rw-_flag_per_proc | average rw-flags per processes | float | files | linux_proc_maps |
| 105 | Generic Behavior | avg_rwx_flag_per_proc | average rwx flags per processes | float | files | linux_proc_maps |
| 106 | Generic Behavior | avg_r-x_flag_per_proc | average r-x flags per processes | float | files | linux_proc_maps |
| 107 | Generic Behavior | usr_map_amount | number of /usr in proc_map | int | files | linux_proc_maps |
| 108 | Generic Behavior | lib_map_amount | number of /lib in proc_map | int | files | linux_proc_maps |
| 109 | Generic Behavior | max_____flag_per_proc | max --- flags per processes | float | files | linux_proc_maps |
| 110 | Generic Behavior | max_r___flag_per_proc | median r--flags per processes | float | files | linux_proc_maps |
| 111 | Generic Behavior | max_rx_flag_per_proc | median r-x flags per processes | float | files | linux_proc_maps |
| 112 | Generic Behavior | max_rw__flag_per_proc | max rw-flags per processes | float | files | linux_proc_maps |
| 113 | Generic Behavior | max_fwx_flag_per_proc | max rwx flags per processes | float | files | linux_proc_maps |
| 114 | Generic Behavior | median_flag_per_proc | median --- flags per processes | int | files | linux_proc_maps |
| 115 | Generic Behavior | median_r___flag_per_proc | max r--flags per processes | int | files | linux_proc_maps |
| 116 | Generic Behavior | median_r_x_flag_per_proc | max r-x flags per processes | int | files | linux_proc_maps |
| 117 | Generic Behavior | median_rw__flag_per_proc | median rw-flags per processes | int | files | linux_proc_maps |
| 118 | Generic Behavior | median_rwx_flag_per_proc | max rwx flags per processes | int | files | linux_proc_maps |
| 119 | Generic Behavior | vdso_map_amount | number of [vdso] in proc_map | | files | linux_proc_maps |
| 120 | Generic Behavior | procces_arguments_amount | number of processes with a | float | processes | linux_psaux |
| | | | command line arguments | | | |
| 121 | Generic Behavior | sudo_arguments_amount | number of processes with sudo command | float | processes | linux_psaux |
| 122 | Generic Behavior | usr_path_arguments_amount | number of processes with /usr | float | processes | linux_psaux |
| | | | path argument | | | |
| 123 | Generic Behavior | daemons_psaux | number of daemons in psaux | int | processes | linux_psaux |
| 124 | Generic Behavior | usr_lib_psaux | number of /usr /lib in psaux | int | processes | linux_psaux |
| 125 | Genenc Behavior | run_script_amount | number of run-script command | int | processes | linux_psaux |
| | | | in memory | | | |
| 126 | Generic Behavior | parameter_amount | number of parameters in psaux | int | processes | linux_psaux |
| 127 | Deception | empy_processes_name | number of processes with empty names | int | processes | linux_pslist |
| 128 | Deception | sshd_processes_name | number of processes named ‘sshd’ | int | processes | linux_pslist |
| 129 | Deception | telnetd_processes_name | number of processes named ‘telnetd’ | int | processes | linux_pslist |
| 130 | Deception | crone_processes_name | number of processes named ‘crone’ | int | processes | linux_pslist |
| 131 | Deception | sh_processes_name | number of processes named ‘sh’ | int | processes | linux_pslist |
| 132 | Deception | busybox_processes_name | number of processes named ‘busybox’ | int | processes | linux_pslist |
| 133 | Deception | hidden_processes_es | number of hidden processes | int | processes | linux_pslist |
| 134 | Deception | same_processes_name_amoun | number of processes es with | int | processes | linux_pslist |
| | | | the same name | | | |
| 135 | processes Interaction | processes_amount | number proces in tusk_struct | int | processes | linux_pslist |
| 136 | Persistence | init_child | number of init processes children | int | processes | linux_pstree |
| 137 | processes Interaction | avg_child_per_processes | the avarege number of child processes | float | processes | linux_pstree |
| | | | for every processes | | | |
| 138 | processes Interaction | max_child_per_processes | the maximun number of children | float | processes | linux_pstree |
| | | | per processes | | | |
| 139 | processes Interaction | median_child_per_processes | the median number of children | float | processes | linux_pstree |
| | | | per processes | | | |
| 140 | processes Interaction | threads_amount | number of threads in memory | int | processes | linux_threads |
| 141 | processes Interaction | threads_max | the maimum number of threads | int | processes | linux_threads |
| | | | per processes | | | |
| 142 | processes Interaction | threads_median | the median number of threads | float | processes | linux_threads |
| | | | per processes | | | |
| 143 | processes Interaction | threads_avg | the average number of threads | float | processes | linux_threads |
| | | | per processes | | | |
| 144 | processes Interaction | procces_with_no_ | percent of processes without threads | float | processes | linux_threads |
| | | threads_prece | (not include one main thread) | | | |
| 145 | Generic Behavior | tmp_file_amount | number of temp files | int | files | linux_tmpfs-L |
| 146 | Generic Behavior | tmp_sys | number of temp files from sys | int | files | linux_tmpfs-L |
| 147 | Deception | prctl_sys_call | number of prctl | int | system call | |
| 148 | Deception | arch_prctl_sys_call | number od arch_prctl | int | system call | |
| 149 | Evasion | nanosleep_sys_call | number of nanosleep | int | system call | |
| 150 | processes Interaction | ptrace_sys_call | number of ptrace | int | system call | |
| 151 | processes Interaction | processes_vm_writev_sys_call | number of processes_vm writev | int | system call | |
| 152 | Generic Behavior | open_sys_call | open_sys_call | int | system call | |
| 153 | Generic Behavior | close_sys_call | close_sys_call | int | system call | |
| 154 | Generic Behavior | read_sys_call | read_sys_call | int | system call | |
| 155 | Generic Behavior | futex_sys_call | futex_sys_call | int | system call | |
| 156 | Generic Behavior | mmap_sys_call | mmap_sys_call | int | system call | |
| 157 | Generic Behavior | clock_gettime_sys_call | clock_gettime_sys_call | int | system call | |
| 158 | Generic Behavior | croot_sys_call | croot_sys_call | int | system call | |
| 159 | Generic Behavior | reboot_sys_call | reboot_sys_call | int | system call | |
| 160 | Generic Behavior | sys_init_module | sys_init_module | int | system call | |
| 161 | Generic Behavior | sys_delete_module | sys_delete_module | int | system call | |
| 162 | Generic Behavior | sys_restart_syscall | sys_restart_syscall | int | system call | |
| 163 | Generic Behavior | sys_exit_group | sys_exit_group | int | system call | |
| 164 | Generic Behavior | sys_request_key | sys_request_key | int | system call | |
| 165 | Generic Behavior | sys_getcpu | sys_getcpu | int | system call | |
| 166 | Generic Behavior | etc_map_amount | number of /etc in proc_map | int | files | linux_proc_maps |
| 167 | Generic Behavior | map_amount | number of page in memory | int | files | linux_proc_maps |
| 168 | Generic Behavior | anon_inode_amount | number of anon inode | float | files | linux_lsof |
| 169 | processes Interaction | pipe_amount | number of pipe | float | files | linux_lsof |
| 170 | Generic Behavior | run_map_amount | number of /run in proc_map | int | files | linux_proc_maps |
| 171 | Generic Behavior | different_lib | different lib in memory | int | processes | linux_ELFs |

APPENDIX IV
Table 1
Hyperparameter configuration for each CNN architecture.

| | | Learning | Batch | Regularization | | Additional |
|---|---|---|---|---|---|---|
| Architecture | Optimizer | Rate | Size | (Penalty) | Epochs | Layers |
| ResNet 50 V2 | SGD | 0.0001 | 32 | L2 (0.2) | 150 | Batch |
| Xception | SGD | 0.001 | 32 | L2 (0.2) | 100 | Normalization & |
| EfficientNet B2 | SGD | 0.001 | 32 | L2 (0.2) | 40 | Dropout |
| VGG-19 | SGD | 0.001 | 32 | L2 (0.2) | 50 | (x2) |

1.-33. (canceled)

34. A method for detection of unknown malware in Linux cloud environment, the method comprising:
within a hypervisor, acquiring a raw data set comprising one or more volatile memory dumps of a Linux cloud server, wherein the volatile memory dumps are associated with a current state of the virtual machine's volatile memory;
extracting one or more features from the raw data set (either by utilizing knowledge based features or by utilizing Deep Learning CNN architectures); and
classifying, using at least one classifier, the one or more features, to determine if one or more of the features are associated with a malware, thereby detecting malware in a Linux cloud environment and distinguishing between a benign or malicious state of the server.

35. The method according to claim 1, further comprising (pre)processing at least a portion of the data, thereby generating a processed data set, and wherein the one or more features are extracted from the processed data set.

36. The method according to claim 34, wherein the hypervisor is configured to acquire the volatile memory dumps, thereby evading being detected by the malware.

37. The method according to claim 34, wherein the classifying of the one or more features is based, at least in part, on identified malicious behavioral traces.

38. The method according to claim 34, wherein the processed data comprises one or more matrices, and wherein the extracting of the one or more features comprises applying the one or more matrices to an algorithm trained using expert knowledge.

39. The method according to claim 34, wherein the processed data set comprises one or more image files, and wherein the extracting of the one or more features comprises applying the one or more image files to a plurality of neural networks.

40. The method according to claim 34, wherein acquiring data associated with volatile memory dumps comprises the entire memory dump or a single dump.

41. The method according to claim 34, wherein acquiring data associated with volatile memory dumps comprises acquiring data associated with time intervals between memory dumps.

42. The method according to claim 34, wherein the classifier is trained using a validation step, thereby ensuring that the malware is inspected as it performs its malicious activity.

43. The method according to claim 34, wherein the classifying of the one or more features comprises classifying known malware and/or unknown malware families into categories, wherein the unknown malware is a malware that the classifier did not encounter during a training process thereof.

44. The method according to claim 34, wherein the categories comprise malware families and/or attack type categories.

45. The method according to claim 34, wherein the server is an unknown/new virtual server.

46. The method according to claim 1, wherein the features are extracted from different parts of the volatile memory; and/or wherein the one or more features are knowledge-based features.

47. The method according to claim 34, wherein the malware is a foreground process, disguised as a background process, and/or a background process.

48. The method according to claim 34, further comprising analyzing potential malware behavior by applying one or more of a static analysis method and a dynamic analysis method to the data.

49. The method according to claim 34, wherein the one or more features extracted using at least one convoluted neural network (CNN), wherein the method is devoid of a pre-processing stage, thereby preventing lag time between a malware attack and the detection thereof.

50. The method according to claim 34, further comprising a virtual box snapshotter configured to control any one or more of the setting of the virtual environment, an application to be sampled, a server type, an amount of snapshots to be captured, a time interval between two or more consecutive snapshots, which server is executed, and which server is the one from which the volatile memory dumps are captured, or any combination thereof.

51. The method according to claim 34, wherein the acquiring of the data set from volatile memory dumps of a Linux cloud server further comprises capturing a snapshot of the volatile memory and saving the snapshot as an Executable and Linkable Format (ELF).

52. The method according to claim 51, further comprising slicing the snapshot and saving the sliced snapshot in a raw format thereof; and/or producing at least one jpg image from the snapshots and/or sliced snapshots, wherein each of the volatile memory dumps is represented as one or more RGB array.

53. A method for detection of malware in Linux cloud environments, comprising:
within a hypervisor, acquiring data from volatile memory dumps of a Linux cloud server;
(pre)processing at least a portion of the data, thereby generating a processed data set;
extracting one or more features from the processed data set; and
classifying, the one or more features to determine if one or more of the features are associated with a malware, thereby detecting malware in a Linux.
